(19) United States
(12) Patent Application Publication
(10) Pub. No.: US 2013/0204874 A1
(43) Pub. Date: Aug. 8, 2013

(54) Hyper Adapter and Method for Accessing Documents in a Document Base

(71) Applicant: Tim Frey, Hassmersheim (DE)

(72) Inventor: Tim Frey, Hassmersheim (DE)

(21) Appl. No.: 13/519,500

(22) PCT Filed: Dec. 30, 2010
(86) PCT No.: PCT/EP10/70935

§ 371 Date: Dec. 12, 2012

(30) Foreign Application Priority Data
Dec. 30, 2009 (EP) 09180953.3

(51) Int. Cl. G06F 17/30

(52) U.S. Cl. CPC G06F 17/30011
USPC 707/737

(57) ABSTRACT

The present invention relates to a hyper adapter (300) for accessing documents (400) and/or document portions (410) which are stored in a document base (305), wherein the hyper adapter (300) has: a. an access translator (303) which is designed to process at least one access document (302) received by the hyper adapter (300), wherein the access document (302) specifies one or more classes (402) of documents (400) and/or document portions (410); b. wherein the hyper adapter (300) is designed to associate the documents (400) and/or document portions (410) stored in the document base (305) with one or more classes (402) using classification means which are specified in the access document (302).

### 1. TECHNICAL DOMAIN

This invention is related to a hyper adapter and a procedure to access documents in a document database.

As demonstrated by studies, nowadays a developer spends significant amount of his work on inspecting the source code (i.e., source text or “source code” in English) to use, grasp and extend the functioning of existing software systems. The same applies to security analysis of source code, which currently requires considerable manual effort. However, significant security risks are associated with it since errors may be easily overlooked considering the high complexity of modern software program and the faulty software can thus lead to substantial damages. The faulty software can lead to disastrous damages especially in the context of embedded software, such as in automobile or aviation and space travel fields.

### 2. STATUS OF TECHNOLOGY

From the best available technology, it is noted that the analysis and evaluation of source is to be supported by various methods. At this juncture, today there are no adequate computer-based, systematic analysis techniques, in lieu of thereof typically the opinion of experts is trusted. Furthermore, it is not yet possible to analyze source code based on multi-dimensional structures. As a result, the programmer must inspect the source code completely manually. In the following pages, it is illustrated which manual techniques and concepts in this context are known from the best available technology.

Separation of concerns: The basic idea of “separation of concerns” is illustrated in “Selected Writings on Computing: A Personal Perspective. On the role of scientific thought” by E W Dijkstra (Springer Publishers, 1982, ISBN 0-387-90652-5, http://www.cs.utexas.edu/users/EWD/ewd04xx/EWD447.PDF) and is concerned with approach on how the software should be developed, which is very common nowadays. The ideas recommend programming of different concerns in different modules. Thus every perspective, angle or even requirements of a software system are included under concerns (“concerns” in English). Concerns/issues are also identified as dimensions in scope of the present invention. Due to splitting of a software system in module, each of the issue corresponds as the complexity is reduced during development.

Tangling and Scattering: Since object-oriented programming languages provide only partial splitting of concerns in each of the modules, it may lead to problem known as “tangling” and “scattering”. Tangling indicates that a module realizes multiple requests simultaneously without separating them, whereby a module is no longer assigned a unique primary task. Scattering means that a request is realized by code fragments, which are present in several different modules.

Aspect-Oriented Programming: The Aspect-Oriented Programming (AOP) is a programming schema, which should allow framing, developing and testing different logical aspects of an application program from another. In doing so, this schema draws up the object-oriented programming and allows issues belonging to several classes to be programmed into separate modules. Often a special aspect-compiler or a Weaver is used for the application of AOP.

Annotations: Meta language elements of a programming language are included under annotations. Such language elements enable integration of meta data in the source text. This meta data can be used only for description of elements and may also be evaluated by a compiler or runtime environment.

Coding Conventions: Coding conventions (German Coding Guidelines) are guidelines on how a specific software system should be programmed. For instance, how the special variables or classes should be named is defined. An example of application is data access classes which often contain DAO (data access object) in their real names. It is attempted to simplify the understanding of source code by means of coding guidelines.

Domain-specific languages: A new trend in software development is the use of domain-specific languages. A domain-specific language (“domain-specific language” in English, DSL) is a formal language that is specially designed for a particular problem area (domain) and is implemented. For instance, there are DSLs that assist in creating graphical user interfaces for electronic devices that can be operated via a touchpad. Domain-specific languages can be used for generating program source code or to execute an interpreter. In the process, this programming language can also be embedded. One example is Java annotations. At the same time, DSL is described by means of a programming language. An example of DSL beyond a programming language is, for instance the Bean XML language. The Java classes available as Beans during operating period are defined in it.

Application of frameworks and libraries in programming: Often ready components, for instance libraries and frameworks are used in programming a software system. Libraries provide completely programmed functions. Frameworks provide a runtime environment with predefined functions. For instance, predefined functions are typically used to control a network connection. Similarly, a framework is used in programming a mobile phone. If the programmer uses the framework, he can directly control the hardware via it using predefined functions. A solid application of this is the triggering of camera, or playing a song in the music player of mobile phone.

Unit tests: The module test (even test component test or often “unit test” from English are referred as Unit Tests) is a type of software test. It is used to verify the soundness of a software module, for instance of individual classes. In addition, each of these individual modules is examined by testing their expected function. They are used to confirm the existence of errors. They are often used in further development of software system to examine whether a module fulfils the same conditions as before after a modification.

Metrics: Often metrics are used as indices to measure the quality of software source code. The value of a metric can be interpreted as a degree of fulfilling of the quality attribute of software unit. One such metric is evaluated by a function that indicates a numerical value of software unit, for instance the number of source code lines.

Version management system: A version management system is a system used for versioning and updating source texts. In doing so, each of the source tests are transferred to the version management and a history is established there.

Issue Tracking: Issue tracking systems (case management systems) or bug tracking system with reduced functionality are used in software development to catch error or improvement suggestions for software system by tickets, for instance. Examples of such systems are Bugzilla, Trac, and JIRA. Often these systems are connected to a version management system and a continuous integration system to link improvement suggestions or errors with a specific version.

Data Warehouse: In terms of business, the Data Warehouse system can be used to analyze and plan business data. In doing so, the data is processed from external business systems and stored in a data warehouse in a multidimensional schema. Often Data Mining operations are used on this multidimensional schema for pattern recognition. In addition, the user can create multidimensional queries based on basic operations. Data warehouses have the disadvantage that they are only designed for business data and reporting purposes. Furthermore, a Data Warehouse is not intended to be used as a search engine, particularly on the Internet or in software development. In addition, a Data Warehouse is usually used within the company but not for the analysis of documents or software development artefacts.

Metrics Warehouse: The “Software metrics: A guide to planning, analysis and application” by C. Ravindranath Pandian (Auerbach Publications, 2003, 978-0849316616) describes a procedure how projects can be controlled on the basis of metrics. This deals with metrics of business systems but not directly to metrics that can be calculated by a function of source code. These metrics are loaded in a so-called Metrics Warehouse, which is identical to a Data Warehouse. The exact structure of the Metrics Warehouse, the structure of data and the content of the Warehouses is not described in detail. However, there is a disadvantage with Metrics Warehouse that the metrics must be calculated first. In the process, there lies no relationship between analysis of metrics and concerns in the source code. There is no option to embed further information via source code. The structure of source code, for instance such as inheritance and the effect on the metrics is not taken into consideration. Furthermore, it is not specified exactly which data is primarily managed in the Metrics Warehouse and how it is structured.

Source Code Mining: Source code Mining (refer, for instance “Concern Mapper Homepage,” http://www.st.cs.uni-saarland.de/softevo/) is the application of Data Mining Algorithms on source code, bug databases and version management systems. Here the main idea here is to link bugs, i.e. errors arising from Issue Tracking Systems with their solutions from version management systems based on corresponding source text and use Data Mining for analysis afterwards. The disadvantage with sourcecodemining is that only the relationships between errors and the source code can be detected. Thereby further data cannot be integrated into the knowledge base. For instance, the following relationships cannot be examined with this limited knowledge base: Relationships between metrics and errors, including DSLs in the analysis and their association with source code, analysis of DSLs and their models, as well as relationships between Concerns and errors.

A special form of Source Code Mining is the Aspect Mining (refer, for instance “Aspect Miner”, http://www.research.ibm.com/hyperspace/workshops/icse2001/Papers/hannemann.pdf). Based on the specified name and type-based analysis, the source text is examined on an aspect with this tool. Thus the type-based analysis examines the coupling between components and recommends aspect candidates as appropriate.

The DE 10 2006 046 203 A1 reveals a procedure for computer-assisted evaluation of source code. The source code is analyzed on the basis of coding rules and code metrics. A coding regulation is a clearly determined specification, whose non-fulfilment leads to violation of a rule. A metric is factor that can be defined from software source code or from the executable program, which is an indicator for specific error in the software. Thereby each of the errors detected in the software source code are classified on the basis of one or several error classes. This allocation is done by a configuration. Based on the error class, user receives a correction tip, a description of how the errors of each class can be detected and a description of the possible causes for occurrence of the error is displayed. The error classes may contain a quality assessment in a preferred style to indicate how serious the error is. In doing so, a total quality assessment is enabled for the complete software source code. However, in DE 10 2006 046 203 A1 it is not possible to classify errors on the basis of complex evaluation since only a simple mapping between error and its error class is provided. For instance, the rules that allocate a combination of two failures to a specific class of errors are not enabled.

The US 2008/0313175 A1 describes a task oriented method to enhance the experience of a user by recording his actions on a document or parts of documents and allocate a task. These data are designated as the task context. Afterwards, a user may define a query regarding which tasks shall be displayed by a report. Thereby while generating the report, an interest assessment is executed for the user pertaining to documents or parts of documents contained in the task. The report is generated on the basis of interest assessment. The implementation of the US 2008/0313175 A1 model meets programming tasks in Eclipse Plugin Mylyn (cf. “Mylyn homepage”, http://www.eclipse.org/mylyn/) and for general tasks in Tasktop (refer “Tasktop Homepage”, http://tasktop.com/). The US 2008/0313175 A1 and Mylyn have the following disadvantages: Only the simple combinations of task contexts may be executed. In combined display of contexts, all documents or parts of documents whose interest evaluation lies above a certain threshold are included in the report. The documents or parts of documents, whose interest evaluation exists in a task context, are not excluded from other tasks while generating a report. The interest assessments of a task context cannot be combined with other information of documents or parts of documents. Individual documents or parts of documents cannot be excluded from a report.

ConcernMapper: The ConcernMapper is a tool to facilitate the development of Java software (refer “ConcernMapper Homepage”, http://www.cs.mcgill.ca/~martin/cm/). A software developer can create new concerns with the ConcernMapper. Later, each of the Java elements or files can be assigned to a concern. The user has the option to view only the elements of a concern. The ConcernMapper has following disadvantages: It supports only Java elements and files, i.e. there is no support for the individual elements of DSL models, there are no queries to exclude Concerns instead only simple display is possible, Concerns cannot be automatically detected in the source code and there is no option to create queries in combination with one of the other techniques for instance, Mylyn.

JQuery: JQuery is a source code analyzer. The program enables creation of new perspectives for development environment of the programmer. Thus, queries can be defined for every new perspective. JQuery is designed to create highly flexible and customizable new perspectives. JQuery does not provide an option to integrate further information associated to Java source code. Moreover, it has following disadvantages: A technical examination to determine whether coding conventions were violated in the programming is not possible. Only Java code is analyzed. Version management systems cannot be included. JQuery is not suitable for other programming languages or DSLs. In queries, the relationships with external elements are not supported, for instance, the configuration files. No query can be executed for failed Test cases. It is not possible to assign sourcecode fragments to Concerns and use them in a query. It is not possible to use metrics in a query. The language to formulate queries is a logic programming language and not a query language. The result quantity of a query cannot be displayed outside IDE. The result quantity cannot contain any non-Java elements. The query language of JQuery is Tyruba which is a logic programming language. The multidimensionality of source code is explicitly assumed while creating queries with JQuery. It is similar to SQL and MDX queries. Every MDX query can be translated into an SQL query, but MDX is designed for multidimensional queries and calculations, in contrast SQL is only intended for simple queries. No information on aspects can be included in it. For instance, it is not possible to display all fragments used in an aspect in a query.

It is common amongst all known procedures and devices from the best available technology directed towards improving the software development that they consider only the source text but DSLs are ignored.

There are several problems in software development, for instance, if new features are added to a software system, for which the software system and its modules were not originally intended. Thus significant modifications would be required in design in such a way that the new functionality is installed in old modules. This amplifies the above mentioned problems like Scattering and Tangling, which already exist in the object-oriented programming. Even today there is no way to evaluate or analyze the modularity of a program. Such an assessment could be used for instance, to generate prognosis about the quality, security and reliability of the program or to estimate the training period of a new developer. Since typically the modern software systems are extremely complex and indicate a vast number of developing fragments (documents), there is a need to manage this complexity, i.e. enable a structured way to access the documents (for instance reading and/or writing).

The compliance of coding guidelines is another feature of source code. So far there is no technical procedure which systematically examines the compliance with coding guidelines. For instance, it is not possible to check whether a class accessed via a network also bears “NetworkAccessor” in its name. Today this problem is addressed by experts using manual code and is therefore very costly and vulnerable to errors.

Another problem particularly arising in technical fields of application is the temperature development of a program-controlled device under load. Another case in which development of temperature is desired as component of an analysis is, controlling a machine. In doing so, the machine may contain parts that develop heat while executing software triggering. For instance, a software command initiates the machine in motion. If a machine frequently executes a command consecutively without break then its temperature rises to a point that may lead to an emergency shutdown or even damage the machine. Up till now, this concern is not accurately investigated by analysis method. This is because it is difficult to determine which parts of a program are responsible for increase in temperature. The temperature poses challenge to reduce power consumption of software, since for instance the portable devices should be operated through charged cells as long as possible.

Another aspect is controlling actions of machines by a computer program product implemented in the machine or an external controller. It may be that a computer program product causes the machine to perform such steps that consume much energy, which are considered very expensive in times of rising energy prices and therefore is undesirable. Therefore, here it would also be of interest to analyze how high is the energy requirement of a computer program product and its interaction with a machine. Up till now, it is not possible to determine the apparent power consumption of a program.

An analysis that may answer questions on the content of a program is currently not possible. In particular, none of the following questions are answered: Does the program use network connections? Which part of a program is accessible via a Web Server? Which part of a program is accessible via a Web Server and would be written by a certain author? What parts of a program use obsolete libraries? How much code of a program depends on a certain library?

Modern code is typically programmed with the help of namely Dependency Injection and a variety of configuration files. Furthermore, nowadays several codes are generated that are integrated with handwritten source code. All available approaches to the analysis and evaluation of source code are not associated with these facts.

Up till now metrics have not prevailed in the software development. Primarily, the interpretation, evaluation and validity of metric are often not sufficient. In addition, it is not possible to calculate complex combinations of metrics. For instance, a metric is evaluated on how much a source code fragment is used by rest of the program. Another metric could evaluate the quality of fragment. By combining the two, it is possible to evaluate the effect of quality on the entire system. Today, there is no system to combine metrics easily and correctly. The following questions are not answered: How high is the quality of the classes that access camera of the mobile phone? Which author wrote source codes that are used in most of the other components? Which other source code fragments are indirectly affected by the error (i.e. request of faulty source code fragments)? Furthermore, no known tool can perform the following analyzes: Time series analysis of how often an error occurs in a source code fragment, metric comparison between the metrics and metrics tested codes as well as identification of the indirectly affected codes of aspects if this test fails.

Another field of application is quantities of documents that are distributed over the Internet via networks. Currently the popular search engines do not support any multi-dimensional queries in this context but it is at least possible to search by words in individual dimensions, for instance, words in text pages. The additional search criteria such as File type or the size of image for instance are specified only in some cases. Thus it is not possible to consider dimensions such as comment, in a website. Another major problem is that no sub-dimensions or quantity of links can be used in the search, i.e. only properties for a dimension are specified, but not what must exist in a subordinate dimension. These properties act like filters and are not separate dimensions, for instance, the size of an image in pixels. The dimension of size also applies to other media objects such as videos. In addition, the properties cannot be related to each other, for instance the characteristic that an author has a blog entry and this in turn has a location. The index of a currently used search engine typically specializes in words. Thus, for instance, no amount of quantity operations can be executed at websites based on “tags”, because the tags are not considered as dimensions. Here the tags are keywords or any other characters used for providing a data set with additional information, typically for classifications of the data. The consequence of this view is that a conventional search engine does not support any multidimensional operations. Due to this limitation, it is not possible to put following queries: Blog of an author, which is situated within 100 mm of Stuttgart. Product dealer within a circle of 10 km from Stuttgart, who sells product X, which is only 10% more expensive than the favourable web offer. News entries which contain more than 10 comments and the words “x y”. News entries of a domain containing more than 10 comments. Videos that have been linked from the page X. PDF documents that do not contain any hyperlinks. Images of person X and person Y. Blog posts that contain word X and has more than 5 comments. A class with the names X where a function exists with the name Y. Web pages that contain videos with positive reviews. All blog posts commented by Author X. All pages linked by two different sites. All Blog posts marked by day 1 and day 2. All videos of author X, containing comment Z. Images of person A and person B. Person X, whose neighbour is Person Y.

Often search features are provided within a website, but these are limited. The search engines in the website utilize a relational data model, which is not multidimensional. For instance, several properties for a target line can be specified and searched on access relevant websites of tour operators. In doing so, it is not possible to search a travel with hotel that was rated good by a certain author. Another problem of current websites is that often external applications are integrated, for instance, in “Social Networks” like MySpace or Facebook. The data embedded by external applications thereby cannot be directly searched. Furthermore, currently used search engines have the problem that a page rises to the first rank (i.e. the position in list of results), if they refer to several other or highly relevant pages. For instance, currently in search, the time factor is not taken into account—since when a page exists and the user therefore cannot consider these factors. In this context, DE 199 52 769 B4 reveals a search engine to search for queries in standard language based on vector comparisons of words.

“Google Goggles” (http://www.google.com/mobile/goggles/) is a search engine, which enables searching the Web (Internet) based on images from a mobile phone camera. Thus a mobile phone with Android operating system and a digital camera serves as the only possible input device for the search engine. Google Goggles compares parts of an image with the image component of Google and performs character recognition. Then a conventional search can be executed via a Google search engine on the basis of recognized text or photos (normal text search). As an addition to this result, the images recognized as similar are displayed and they serve as identification of the last performed search. Another function of Google Goggles is to show the names of stores on the display which is projected through the camera. Thus on one hand, Google Goggles is a combination of text-based search and image recognition and GPS direction detector on the other hand, which executes the search of a business entered in a directory based on GPS coordinates. Apart from limitation, Google Goggles can only be used on a mobile phone with a certain operating system and not on any other clients; the limitations existing with either conventional search engines are also present. For instance, Google Goggles is limited to a single object in the search. If a book and a CD are photographed at the same time, then further images are not searched which contain the same book and CD. Or if the image could not be obtained in search results associated with the place, for instance, events, popular historical events that took place or other images that were generated near the place. Also, it is not possible to search an image with year, wherein the number of results should be the images of place in this special year. In addition to this, the search function is currently limited to certain areas. Only the landmarks, books, art, wine and logos are recognized. These individual areas cannot be linked to each other in a search. For instance, an image of wine bottle linked with GPS coordinates cannot be used to display restaurants serving wine located within the proximity of GPS coordinates. Or two images with different objects, which shall lead to result set, on which both objects be displayed.

Generally there is one more limitation with Google Goggles and other search machines that, if major dimensions are found, then they are always assigned to only one dimension. For instance, Google Goggles recognizes phone numbers and then executes a text search. In doing so, it is not taken into consideration that a telephone number belongs to a person for instance and thus it must also exist in this dimension. In addition, no means of classification is determined that may be used to answer a query.

Fundamental is another problem of existing search engines is that they always have same, fixed, non-modifiable query. Similar queries: “Search text contained in a Web page” or “Search images containing text xy in text description” or “Search images similar to the transmitted image”. Thus, the classification means that should be used to answer a query is not flexibly specified because by which means the query should be answered is already determined by inflexible query. The selection of classification means by a currently used search engine for instance, Google may be incorrectly interpreted and image results or map results may also be displayed in a search process. This could signify that classification means by Google is selected in accordance with rigid, inflexible rules stored in the main search engine. However, this is not so, because, for instance, search for “Haβmersheim map” or “map”, will be the first result of Google map despite the exclusion of “—”. If the individual search engines are actually perceived as classification means, then it would also be possible to perform set operations based on the results of individual search engines. For instance, it is not possible to search a term and display only websites that also contain links to images which correspond to the same search term. Moreover, the queries of individual search engines are predefined and cannot be linked with the other search engines. Thus, the classification means is nor selected nor combined.

Another problem is that the World Wide Web is currently static. The user may modify the content only in exceptional cases, for instance in community based web applications such as Wikipedia specially provided for this purpose. Generally, it is not possible to add content to websites while surfing web or to modify the existing content if appropriate pages are not specifically provided. For instance, it is not possible to add annotations to sections within a Web page, not even selecting a section of a website and entering a description. In addition, it is possible to add tags in individual cases, if this is supported by the corresponding website. To add tags, the user must typically be a member of a community and could be distributed only within these tags. An exception to this is represented by “Bookmark Tagging Systems” such as Delicous and Digg it. This allows the user to add website to his bookmark and provide it with tags. A disadvantage here is that the user cannot tag any parts of web pages, but only the page as a whole. Another example is of tagging images. Generally, the user may tag only images while marking sections on images, provided he is member of a community. Furthermore, the tags are not sorted into multi-dimensional patterns.

“Collaborative OLAP with tag clouds” (http://arxiv.org/PS_cache/arxiv/pdf/0710/0710.2156v2.pdf) describes OLAP operations based on Tag Clouds. However none of the OLAP operations based on the Tag Cloud associated data is executed. Furthermore, search function based on OLAP operations is not possible and no other dimensions are considered except the Tag Cloud itself.

Therefore this invention is based on the technical problem, that a system and a procedure provide structured and systematic access to the documents, especially software source code to at least partly overcome the above-mentioned demerits.

### 3. SUMMARY OF INVENTION

This problem is solved according to the initial aspect of invention, by a Hyper adapter to access documents and/or parts of documents that are stored in a document database. In the format as per patent claim 1, the hyper adapter illustrates:
a. an access interpreter that is configured to process at least one of the access documents received by the hyper adapter, wherein the access document specifies one or several classes of documents and/or parts of document;
b. whereby the hyper adapter is configured to allocate the documents and/or parts of documents saved in document database in one or several classes on the basis of classification specified in access documents.

Accordingly, the present invention furnishes a hyper adapter with the help of which the software source code and their instructions can be accessed from one of the documents/and or parts of documents stored in the document database. Hereby an access may imply reading, writing, modifying and/or analyzing the documents/parts of documents. Due to the complexity of modern document databases, as mentioned above it is not possible to manually analyze each of the documents or review them at all (since this can be distributed via a network such as the Internet for instance) in the field of developing complex software systems for instance.

Therefore this invention is based on the concept of classifying the documents or their parts into classes so that the unmanageable number of documents in a document database can be managed by forming classes. Thus, a class hereinafter also referred as “dimension”, also represents a section, a projection, or a filtered view of a document database. It should be noted that a specified document may be simultaneously assigned to one or several classes/dimensions, i.e. a multidimensional access to the document database is possible.

In another facet of this invention, the hyper adapter may be configured to store classification means specified in the access document and use at least the one of the two received access documents in the processing. According to this, the classification means received via an access document may not only be used for current access to the document database, but instead the hyper-adapter can internally store such classification means and thus expand its functionality for processing future access documents. The classification means may at least feature a pattern, one or several assignment rules and/or one or more mappings. These and other options for the specification of classification means are explained in the detailed description.

According to another facet of the invention, the access interpreter may feature a multitude of predefined operations to access documents and/or parts of documents stored in the document database and the access document may at least refer to at least one of the predefined operations. Thus, it is possible to specify an arbitrarily complex sequence of operations to be performed in an access document that the hyper adapter should execute. For this purpose the access document preferably refers the predefined operations of hyper adapter. However, new operations, for instance, program code can be defined in the access document which links several operations predefined by the hyper adapter. Hereby it is possible to randomly extend the features of hyper adapter.

Furthermore, the classification means can be configured to allocate a document and/or a part of document to a known probability of one or several classes. Thus, the hyper adapter can be configured to support fuzzy access, for instance, by means of fuzzy logic, as described in the detailed description.

At least one access document may specify a query in accordance with at least one class and/or parts of documents, wherein the Hyper adapter is configured to generate at least one result, which features at least one requested class of documents and/or parts of documents. Accordingly, the complex queries of document database are enabled as explained in the detailed description. Hereby the query may feature at least one sample document and the hyper adapter can be configured to generate at least one result, which has at least one class of documents and/or parts of documents to which the sample document is assigned.

Furthermore, at least one written request may be specified for an access document which contains additional information on one or several documents and/or parts of documents in the document database, wherein the hyper adapter is configured to store additional information into the internal memory of the hyper adapter. This enables the hyper adapter to “virtually” edit documents and/or parts of documents in the document database, although they cannot be actually written.

In this case, the additional information which should be written is stored in an internal memory of the hyper adapter and is suitably linked with the “original” documents in the document database. The Hyper adapter can be hereby configured to generate at least a second query with processing, wherein the result contains the requested class of documents and/or parts of documents from the document database and the additional information from the internal memory of the hyper adapter. Hence, the requested documents or parts of documents are combined with the previously stored additional information with subsequent reading query to make the (unwritable) database effectively writable for a user.

The innovative hyper adapter may comprise of at least one detector that is configured to analyze the document database and to generate one or a several classification means from it. The innovative hyper adapter provides a multitude of specialized detectors in various styles to analyze document databases and classify the documents or parts of documents in it as shown in the detailed description.

A particularly expedient style contains the document source codes stored in the document database and at least one detector is configured to classify the source code in into classes/dimensions which indicate the energy consumption required by one or several machines to execute the instructions of source code.

Thus, the energy consumption of a specific software program can be analyzed, which is particularly significant for the software embedded in that area. Moreover, the hyper adapter provides more detectors to analyze other relevant physical quantities such as the temperature, pressure conditions or other dimensions explained in detailed description. Other expedient styles of the innovative procedure can be found in other independent standards.

This invention further relates to a procedure for accessing documents and/or parts of documents stored in a document database whereupon the procedure features following steps: processing at least one access document whereupon the access document specifies one or several classes of documents and/or parts of documents, wherein the previous step indicates the allocation of documents and/or parts of documents stored in document database to one or several classes based on classification means specified in the access document. Further advantageous embodiments of the inventive method can be found in the further dependent claims.

Finally, this invention provides a computer program which contains instructions to execute any procedure described in it.

### 4. BRIEF DESCRIPTION OF DRAWINGS

The preferred styles of this invention are explained below with reference to the accompanying figures:

FIG. 1-6: Schematic representation of a software system;

FIG. 7a: An example of a blog entry;

FIG. 7b: A pseudo-code example of a robot controller;

FIG. 7c: An example of a software development Fragment (SDF);

FIG. 8a: An example on dimensions of a blog;

FIG. 8b-c: Example of dimensions;

FIG. 8d: An exemplary scheme;

FIG. 9: A Hyper adapter according to style of this invention;

FIG. 10: A Hyper adapter with one or several detectors according to style of this invention;

FIG. 11-14: interaction of a hyper adapter with one or more clients in accordance with styles of this invention;

FIG. 15: Detectors and dimension patterns according to the style of this invention;

FIG. 16: An access interpreter with document interpreter according to a pattern of this invention;

FIG. 17: An access interpreter with interface according to a style of this invention;

FIG. 18: A Library detector according to a style of this invention;

FIG. 19: An execution time detector according to a style of this invention;

FIG. 20: A detector for modifying the temperature of a machine according to a style of this invention;

FIG. 21: An example of implementing pattern with index for hyper adapter according to a style of this invention;

FIG. 22: An example on fusion of hyper adapter and document database adapter in accordance with style of this invention;

FIG. 23: An example of news routing according to a style of this invention;

FIG. 24: An exemplary method for new routing news application according to a style of this invention;

FIG. 25: An example of “Slicing” according to a style of this invention;

FIG. 26: An example of “Slicing” with AND according to a style of this invention;

FIG. 27: An example of a “Dice” according to a style of this invention;

FIG. 28: An example of a “Hypercut” according to a style of this invention;

FIG. 29: An example of a “Hypercut” in a system with “Service Layer” according to a style of this invention;

FIG. 30: An example of a “Hyper Cascade” according to a style of this invention;

FIG. 31-43: Exemplary screen masks of a hyper adapter embedded in an integrated development environment according to a style of this invention.

### 5. DETAILED DESCRIPTION OF PREFERRED STYLES

The invention is generally associated to a model of software development and especially to analysis and evaluation of software development fragments. All elements/artefacts generated and/or used in software development are considered as software development fragments (SDF), for instance, source text documents, program code, compiled components, configuration files, DSLs, models, bugs/errors, versions or any part thereof or associated systems, i.e. all elements and systems related to software development.

This invention may also be used in a multitude of fields, especially in the field of Internet due to its characteristics. For instance, this invention may also be used in some models such as search engine or search system. Furthermore, it can be used to provide a system or device for the Internet, which allows the user to “write, modify and personalize” the network.

Another field for application of this invention is that it can also be used to classify or route/forward the information. In doing so, it is possible to execute operations in external systems on the basis of classifications.

Primarily, this invention can also be used as a multidimensional adapter system. This enables dimension-oriented working with data sources.

This invention preferably operates on a document database in which SDF is stored. Here the SDF assumes the status of documents in the document database, which is why the term “software development fragment (“SDF” and “Document” are used synonymously in the following text). A file system is an example of document database. However, a document database may also be active, for instance, the database/document database can be a Webserver or several Web servers such as the Internet. In doing so, the term database may also refer to several systems or to systems connected via computer networks. According to this, the term document is a collective term for all possible outputs of a database. A document can be generated from a database for instance, which is why a database is viewed as source or combination of sources or source systems within the scope of this invention from which the data may be requested, written and/or modified. Thus, document is a logical unit, a partition, component and/or subdivision and therefore also refers to parts of documents. In context of this invention, such parts of documents are also called as document fragments, which mean that such a document fragment is a part of a larger logical unit. Thus models of this invention may use the structure information of database to improve and/or boost the access and analysis of database. Following data and associated systems or systems alone may be used as database for instance, hypertext documents, word documents, E-mails, web server, program code, version control systems, subversion, CVS, application server, SAP systems, Data Warehouses, text documents, images, location data, component models, virtual machines.

Issue Tracking Systems, test cases, models, domain-specific languages, Openoffice documents, blogs, Twitter, social networks, portable devices such as mobile phones, Peer-to-Peer networks, input devices, file systems, databases, search engines, servers, router, machines, sensors, test systems, debugger, people and/or automobiles. If this invention is used in a computer network, then this network and its subscribers may assume the role of database in the Internet, for instance the internet network itself, Peer-to-Peer networks, web server, web sites, clients, mobile clients (such as mobile phones, Notebooks, PDAs, etc.) and other subscribers. Thus a website signifies a document that can be accessed via the Internet and may contain different contents that appear on the website, for instance, hypertext documents, videos, pictures and other documents may contain hyperlinks. The term Website may also denote multiple documents, for instance all or part of the page under a specific domain. Thus, the term Internet Site may also be a collective term for what is commonly known as website or web page, i.e. a collective term for an entire internet presence, for instance appearance of a company, organization, a private individual, an association, an interest group or for a specific purpose, such as Sale, trade, information, discussion, exchange, entertainment, search, procuration and the like. Such a website can be transmitted via various protocols, TCP/IP, HTTP, HTTPS, FTP, POP3, SMTP for instance and other protocols used for communication in computer networks.

### Basic Structure of Complex Software Systems

Software Development Fragments (SDF) are typically distributed over a wide range of systems that are accessible via networks. Thereby all information is typically stored in files and directories. Often a number of concerns/dimensions are jumbled in a file for instance, comments and operating code.

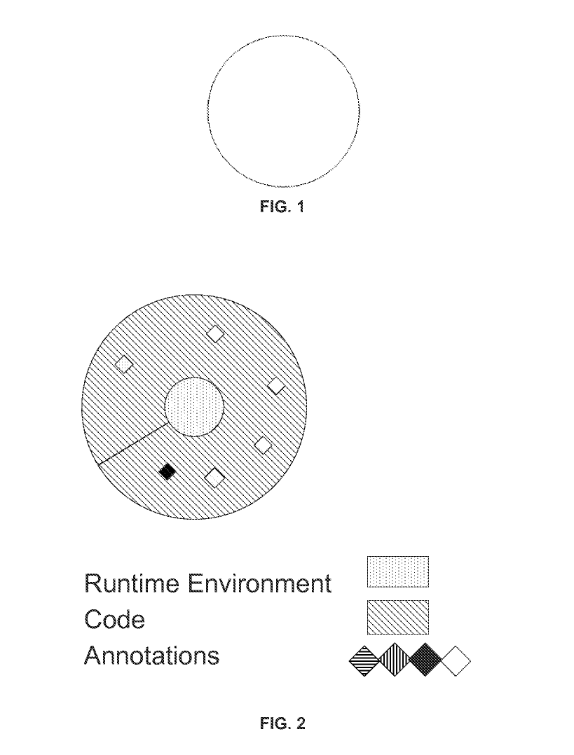

In this context, FIGS. 1-6 schematically illustrate a software system with a multitude of concerns/dimensions. In FIG. 1, the circle signifies the entirety of all fragments (SDF) and the dimensions of software systems used in software development occurring therein. FIG. 2 indicates a software system with annotations. Annotations can appear anywhere in the source code and are available for runtime and/or for compiling period. This function is usually provided by the platform (Runtime Environment) on which the software is executed. Thus, FIG. 2 illustrates one such platform on which the software system is executed and/or compiled. The various annotations in FIG. 2 are illustrated by different shades of gray, whereby it should be clarified that annotations may be arbitrarily distributed at the source code.

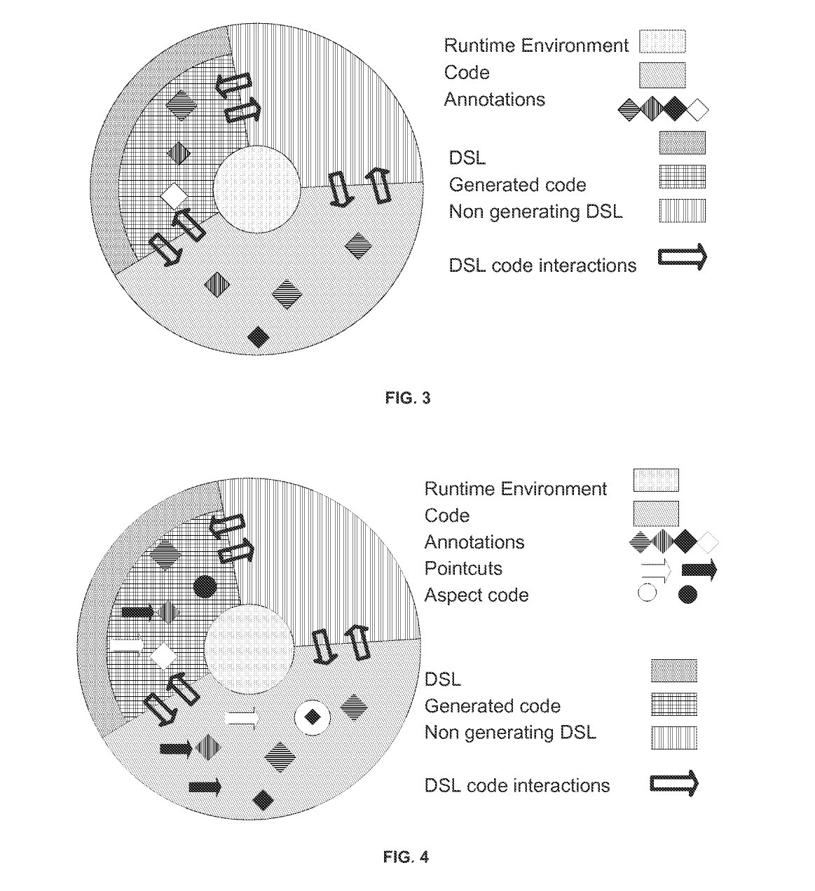

FIG. 3 illustrates an updated software system with annotations and DSLs, since in several cases, the domain-specific languages (DSLs) and associated models are part of a software system. DSLs appear in two different forms; for generation of code and as DSLs, which are interpreted. Interpreted DSLs require an interpreter, which allows the execution and is usually realised through a library (not shown in FIG. 3). Interpreted DSLs may interact with code and/or code can interact with them (see arrows in FIG. 3). Code-generated DSLs interact with conventional source code through the code generated by them. In practical model of generating a DSL, it is possible that this may refer to code fragments and vice versa. The white annotation in the left section of FIG. 3 appears only in the generated code and is intended to represent that the generated code may be identified by special annotations.

The next extension to illustration of software system are Aspects depicted in FIG. 4. Aspects consist of code (“Advices”) and/or “Pointcuts”, which mark places where an Advice is executed. The same colours of issue and Pointcut in FIG. 4 highlight the affiliation. Thus annotations are also used to specify Pointcuts (see gray annotation in FIG. 4). In contrast, it is also possible that the code of an issue contains an annotation. Pointcuts may be appear in both, handwritten code as well as in generated code. The definition of an aspect code and a Pointcut may also appear in generated and hand-written code.

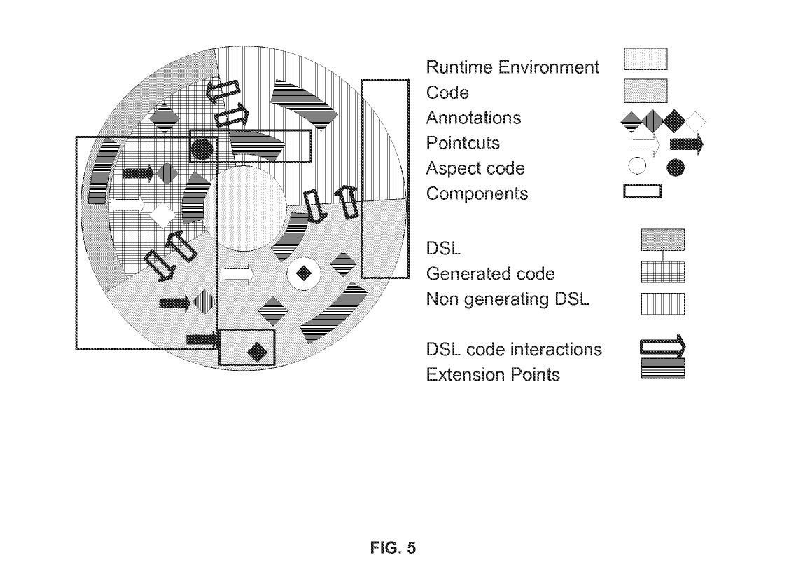

FIG. 5 illustrates the next upgrading of software system visualization. “Extension Points” and components are added here. The Extension Points indicates areas of the software system, where the application can be updated. Such upgradations may be done by Frameworks, for instance. Even both the above mentioned types of DSL may specify the Extension Points. Extension points may also be defined for Aspects. This would allow enhancement of the Aspect code through upgradation. A sample breakdown of the individual parts of the system illustrated in FIG. 5 depicts where the border should be which belongs to a special component. A component may consist of various parts of the system. The dependence of a component on the parts of another is illustrated by overlapping.

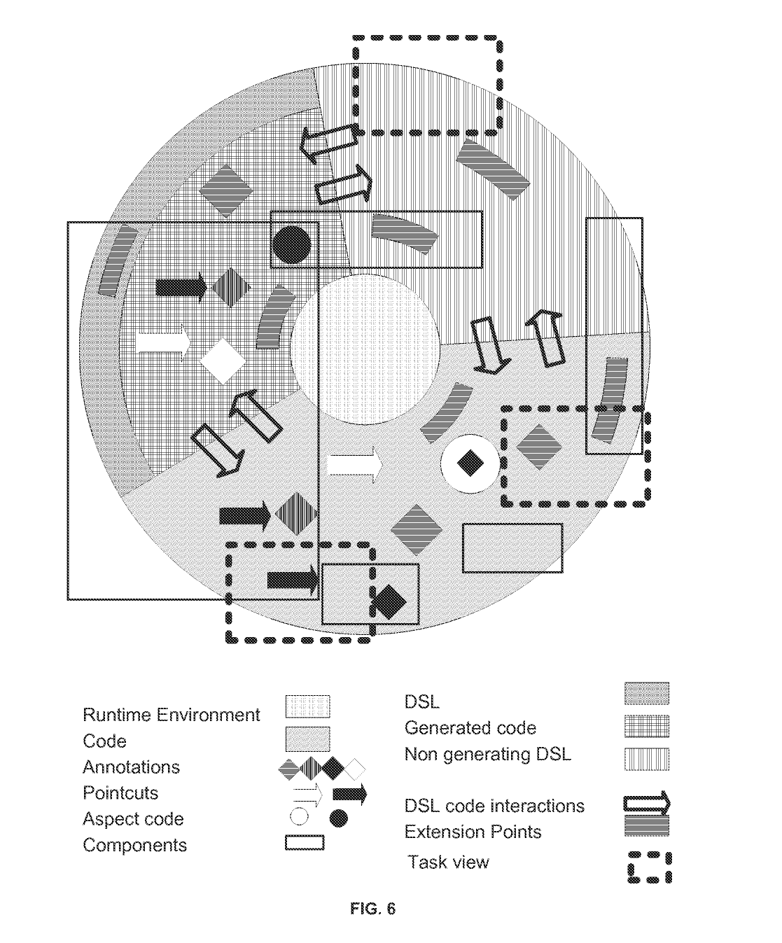

Like before, the software system is checked by the developer, which is why the developer views an unstructured chaos. Through tools such as Mylyn, for instance he has an option to at least partially disentangle the chaos in perspective of a task. This is illustrated in FIG. 6. The additional Task views (represented by perspective borders) indicate that the developer spots only one part with modification of a task.

The developer may use fragments that are scattered over the entire system for modification or upgradation task. In doing so, the developer notices only the relevant details of his task, which are associated with it.

Based on the step-wise configuration of the software system illustrated in FIG. 1-6, it is clear that a variety of different fragments (SDFs) of a software system interact with each other in complex ways. Thus in FIG. 1-6, the interaction of parts in source text is not shown up till now. The source of this invention is that the approach to a software system must be changed.

The perspective of this invention is that SDF and software systems represent a multidimensional structure. Here, a dimension (also known as “Concern” or “Issue”) represents a section, a projection or a filter of the subject matter (SDF, in this case), which contains only the relevant subset of the subject. In doing so, the programming language in which the software is created is not important. The SDF of a software system is usually not located only in one dimension, but they are simultaneously present in several dimensions, which leads to the above mentioned problems like tangling and scattering from object-oriented programming.

### Basic Functions of the Invention

A fundamental aspect of this invention is that one always attempts to structure information and correlate them. Here the information is stored in various systems and files with respect to complex software systems. Therefore, the objective of this invention is to enable a technical access option and identification of the individual dimensions and/or their relationships.

Hence this invention enables technical detection of dimensions of one or several software systems and their SDF in some models and to classify them into multi-dimensional schemes. However, even without multi-dimensional schemes it is of great use to execute multidimensional operations on the basis of SDF dimensions. This is divided in various aspects that may be separated or used together as illustrated in the following displayed invention: The multidimensional access denotes an access based on multidimensional operations that can be executed on the basis of dimensions. The technical detection of dimensions. Analysis on the basis of dimensions. The sequence of the dimensions based on multi-dimensional patterns.

It should be noted that based on the fact that SDF is fundamentally different from business data, the concept of conventional Data Warehouse is not suitable for this invention. For instance, often SDF are present which can be assigned in parallel to multiple dimensions. This gives rise to another challenge to follow this factor with respect to SDF.

The invention relates in a few models of other fields of application. It is already explained above that contain any type of document; especially the hypertext documents on Internet may contain various dimensions. If for instance, an Internet blog is considered, then an entry (“post”) on this blog has several dimensions such as date, comments, author and/or tags. Thus the instrument revealed under this invention and associated methods have advantages in this field of application even beyond software systems. If the above data is considered as one dimensional, then it is possible to perform multidimensional operations on them. Even if the data in hypertext documents, for instance in the Internet is structured according to dimensions, then still today there is no search engine that allows multidimensional operations search.

On closer inspection, the example of a blog indicates that the data partially available as document on the Internet are already made partly available in the database. If there is a direct access to this database(s), then this simplifies the identification of dimensions. Even in the other case, the concept of multi-dimensional search operations as well as the classification of dimensions into patterns is advantageous. This clarifies the other defect in state of art technology that today there is no search engine that allows search according to single dimension, links or hierarchy search.

Thus an essential aspect of this invention is to provide a multidimensional adapter, which enables detection of dimensions and/or execution of multidimensional access. On the basis of various dimensions considered, the innovative adapter is also called hyper adapter. If the hyper adapter is used to develop software systems that allow combination of process through hyper adapter under the collective term hyper modelling. The concept of modelling features that usually in software development, work is performed with models, i.e. abstractions of reality and often formal models and/or DSLs are used.

### Examples of Dimensions

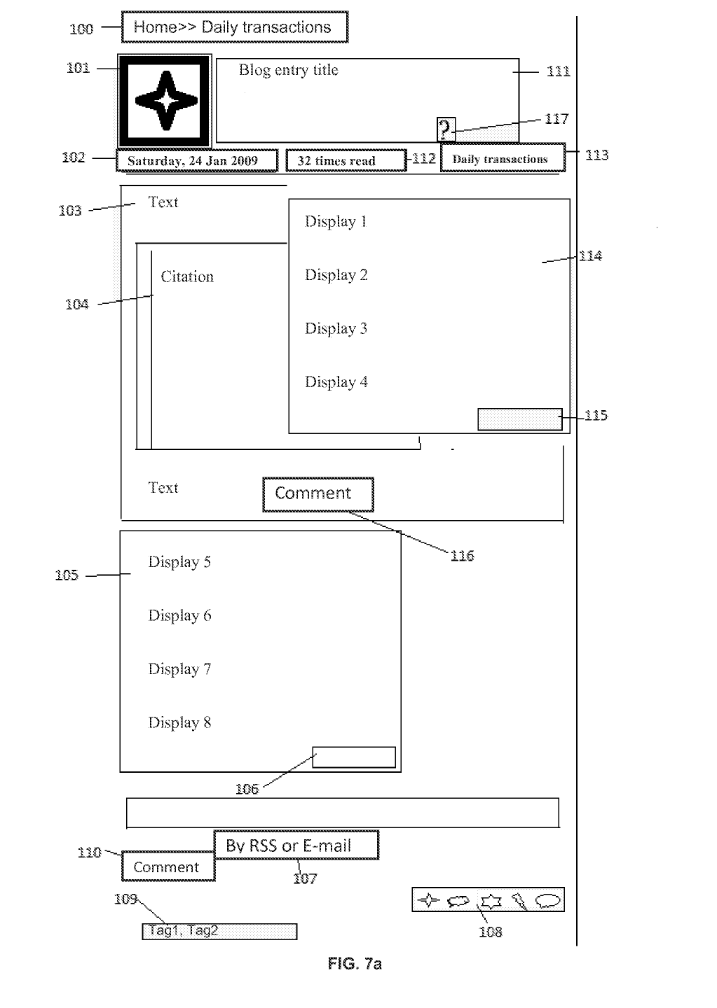

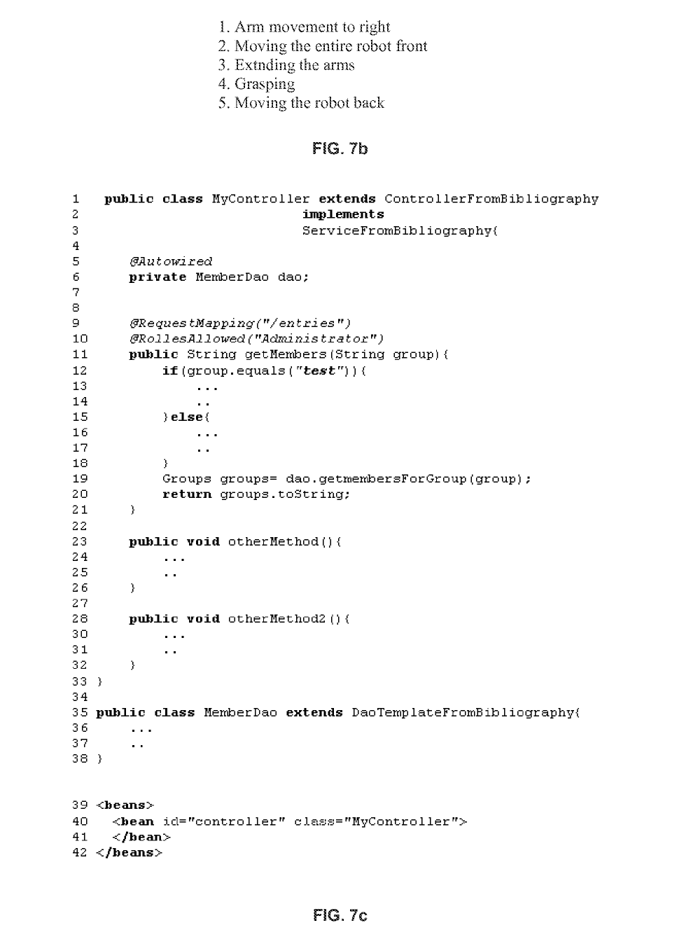

The concept of dimensions using the above example of an Internet blog is depicted below. FIG. 7a illustrates an excerpt from an Internet blog, in which the framed markings indicate the different dimensions of a blog entry (blog post). FIG. 7a illustrates mapping 100 to the blog post, which is situated under command structure Home→“Daily order”. Moreover, you can view image 101 associated with the blog post, which can either have the blog post as a dimension of such image or an image can be used as dimension of a blog post. With 102, the dimension of time is specified at which the blog post was composed. In addition to this, the blog post contain written content 103 with a citation 104 (i.e., the citation 104 is a sub-dimension of the content 103). There is one more sub-dimension to written dimension called the blog posts in 116, namely the dimension of reference to another dimension. In this example, the post contains reference to creating comment. 105 and 114 include the dimension of advertising the blog posts. Here, this dimension can be further specified. With appropriate labels 106 and 115, in this example the vendor of advertisement will be known. This may also be considered as a hierarchy. The “advertising” dimension contains “Show advertiser” dimension which in turn contains the actual advertisement. One more reference to another dimension is the dimension of subscription 107. The link 107 leads to a page on which it is possible to receive more blog posts of the blog through various technical channels such as via E-mail. This dimension is not associated to the actual blog post, but to the blog as a whole. Moreover, it is possible to add the blog to Favourites or to other social networks via the control element 108, which represents the dimension of operation. The dimension of tags 109 of blog posts is also determined in the dimension of links, because they are subject to a hyperlink. 110 indicates another reference to the comment dimension 116. In 111, the dimension of blog post title indicates that the dimension may be further specified in the dimension of query 117. Finally, 112 indicates the number of readers up till this visit who read the blog post.

In addition to the dimensions shown in FIG. 7a, such a blog post may have more dimensions. For instance, it is situated under a URL 118 (not shown in FIG. 7a) which reports domain 119. Furthermore, the blog belongs to an author 120, which he manages and is named as 125. The author 120 may be determined via the surrounding elements not illustrated in FIG. 7a. In addition to this, more dimensions may be indirectly determined. For instance, the post/entry language 128 or the citation language 129 or the advertisement dimension. The number of displays 121 is eight in the example of FIG. 7a. Even the length of posts and citations may be measured, i.e. the length of citation 124, length of post 126 and/or the length of post without citation 127. Same is possible for citation 123 or the number of tags 124.

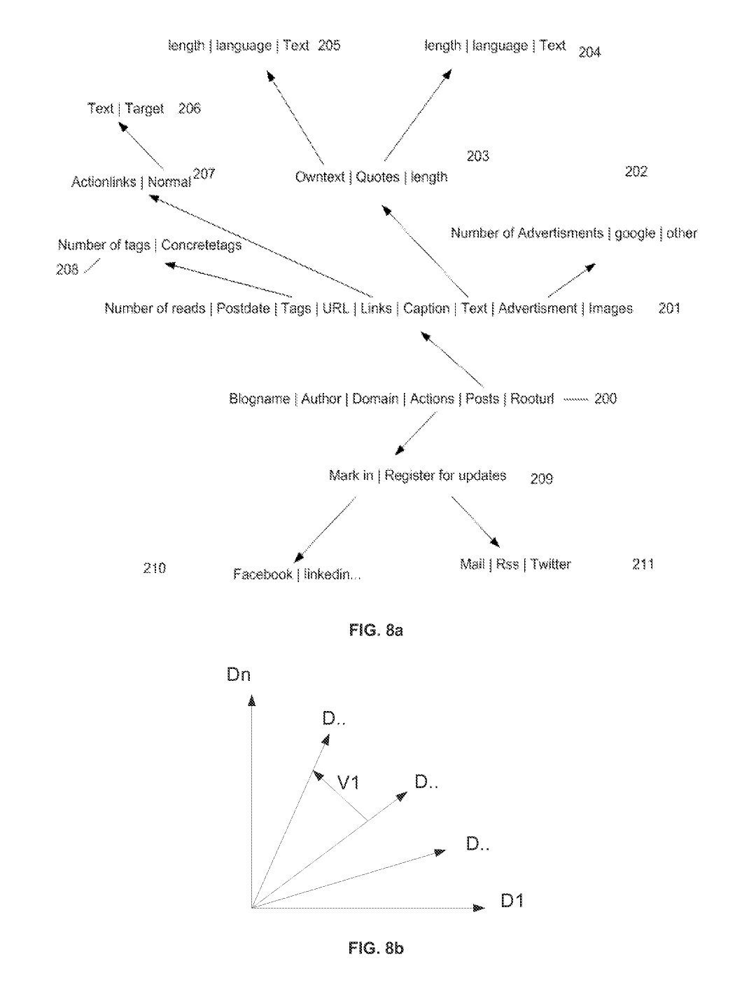

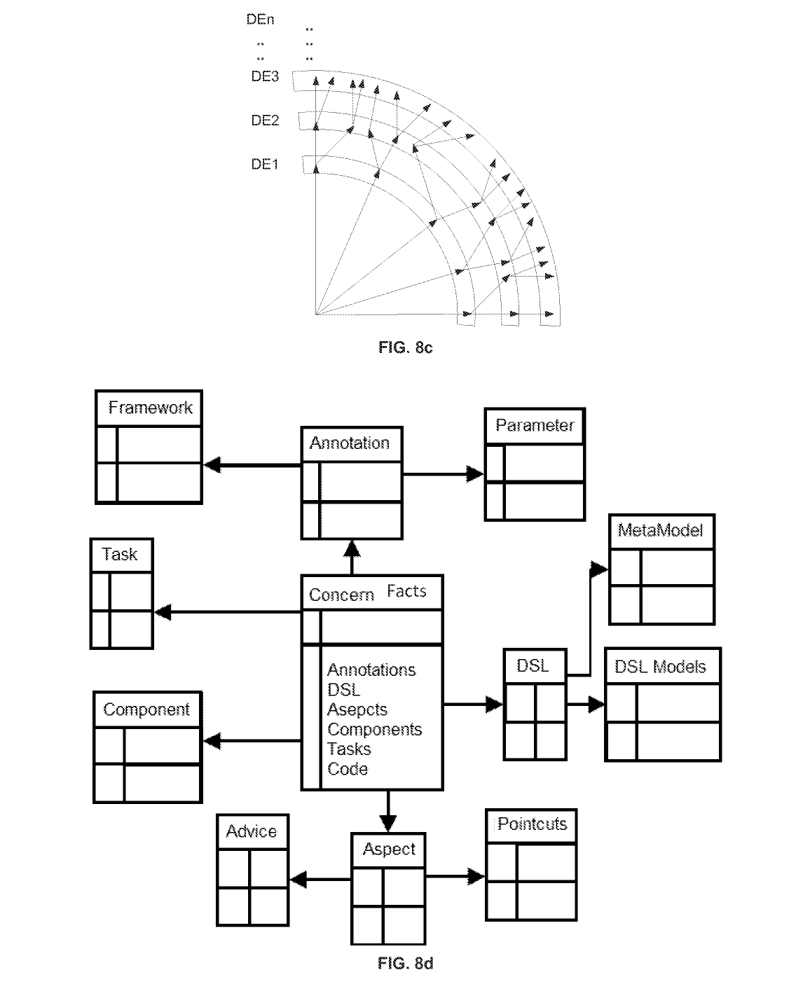

An example of a multi-dimensional scheme based on a blog: the blog may be sorted to a schema by individual dimensions. An example of a schema is shown FIG. 8a. It is followed by an explanation with partial classification of dimensions mentioned in example FIG. 7a on the basis of dimensions described in a blog. Here, 200 represents the dimension of a blog. Such a blog has an Author 120, a Rooturl, which may be a domain for instance, as well as operations that can be performed. These actions can be again divided as depicted by 209. Finally, 210 is assigned to 108 and 211 to 107. Furthermore, such a blog also has a name 125 which may be assigned to the blog names. Such kind of blog has the dimension of Posts 201. The further allocation is done on the basis of fact that it is analogous to the dimension and the approach is clear through pervious execution, only a brief outline is given below: The content of each post is assigned to 201. Number of reads (201) can be assigned to the 112. Post Date (201) 102. Url (201) 108. Caption (201) 111. Images (201) 101. Concrete tags (208) 109. Number of tags (208) 124. Action links (207) 116. Normal (207) For example, 109 and the corresponding link targets (not shown) in 206. 205 may remove the citation 104 and the resulting calculations 124, 129, 124, 129. Likewise, 204 from 127, 128, 127, 130. 203 (length) can be described by 126. 202 may be determined by 121, 105, 106, 114, 115.

FIG. 7b illustrates another example of dimensions based on sequenced instructions, for example, the function request of a robot is controlled by an arm. The associated implementation of functions may be available by a program library for instance. All commands requested in pseudocode are situated in the dimension of the robot. Here, all instructions may lie in each other dimensions. For instance, how much current is consumed by a function Or how intense is the heat generated by movement of Robot developed in it or the environment. Another dimension could also be pressure modification within the components of robot for instance. Thus the dimensions must not be directly based on a line, but on several lines. For instance, the power consumption by the full pseudo-code through robotic movements.

FIG. 7c illustrates a section of pseudo source code, which is based on the Java programming language and represents another example of dimensions.

This example is also possible in other programming languages, such as C, C ++, Prolog, ABAP, C#, Visual Basic, functional languages, DSLs, or in combination with these. The source code in this example has several dimensions. The source code often include points, as in line 13 and 14 which indicate that any content may exist in their place. The MemberDao class in source code line 35 to 38 is succeeded by a class of a framework that facilitates establishing access to a database. Based on this succession, it may be determined that this MemberDao class is located in the dimension of the Data Access Objects (DAO).

Line 1 to 33 represents the MyController class. The class can be recognized in the dimension of the controller on the basis of inheritance in line 1 of ControllerFromBibliography. At the same time, the class is in the dimension of services and the dimension of the beans. Therefore the class is in the dimension of service, therefore since it is used for in line 1, 2, 3 to implement the ServiceFromBibliography. The Beans is a class in dimension since it represents a configuration file from line 39-42 specified as Bean. The participation in the Dimension Beans is a good example of how different languages can also be analyzed together. In this example, the declarative domain-specific language is used for defining Bean, along with source code.

The other parts of the class are methods and fields. These are sub-dimensions and part of a class. The field dao is in line 6 and thus a part of the class, is transferred through @Autowired Annnotation in line 5 which has the additional dimension of automatic addition. Dimension of the associated fields automatically added. Based on line 9, the getMembers method is available in line 11 in the dimension of Methods under a URL. To be more specific, there is one more method available under URL/entries. This method is simultaneously protected by line 10. Thus it is also considered in the dimension of secured methods. To be more specific, in the dimension of the secured methods to which only the administrators have access. The method may also have other dimensions. For instance, a processing time or the power consumption. In method, line 19 it is observed that the dao dimension may be accessed from another dimension and thus there exists a link to dao dimension. To put into different words, the request for method or field 6 is located in dao dimension. From this point of view, it can be concluded that to a certain percentage, the function lies in another dimension.

From previous description of the source code, the explanation has further clarified on what is a Software fragment (SDF). For instance, each line of source code or several lines of a function or a class is a SDF. Such a SDF may be situated in different dimensions, as described earlier. The abstract of dimensions is illustrated in FIG. 8b. Thus D1, D . . . Dn indicate that there may be infinite dimensions. V1 is one such example of how elements of a dimension may refer to elements in another dimension.

This could be, for instance, the request from MyController at line 19 of DAO dimension. Additionally you can hierarchically allocate dimension. For instance, the dao dimension can be a sub-dimension of the larger Stability dimension. This is illustrated as an example in FIG. 8c. Thus the dimensions are classified in levels (DE1 to DEn) each. The levels are charted as helping aid. It clarifies that every dimension may have further sub-dimensions and this may extend to infinite depth, his means that sub-dimensions may in turn have sub-dimensions. FIGS. 8b and 8c are not only software but also refer to other application areas of this innovative hyper adapter and represent a conceptional example for this.

Based on the dimensions of SDF, this may be illustrated as an example as shown in FIG. 8d. This diagram illustrates an example of a multidimensional schema for SDF to visualize better on the basis of an example as explained earlier. Here the centre of diagram is known as facts. The associations between various dimensions are present under these facts. For instance, an SDF in this figure is known as Code. The dimensions are linked by this code. For instance, there is an SDF annotation with parameters which may come from different libraries. Likewise, from the standard Java Library or the Spring Framework. The SDF can also be a part of tasks or of components (component). Furthermore, it may be affected by issues. Another option is DSLs, which for example, access code or were generated from the source text.

It is understood that code may also be a model of a DSL. It may also be the case that this schema is further hierarchically structured. This is rudimentarily illustrated in the diagram. A DSL may be referred on the source code by a model and DSL itself has a meta model.

It would be possible to form hierarchies with DSLs. For instance, a DSL bean may be specified in the source code. Another could specify processes by which Beans may be accessed. Thus, a hierarchy exists in relation to models: source code—Beans—processes.

This could also be illustrated in one such pattern. In the real world it is possible to consider this in an example by Java and the Spring Beans DSL and Spring Webflow DSL of Spring Framework from a model hierarchy.

The application of mathematical methods: abstract may summarize a document, or a document database could be considered as multi-dimensional space with dimensions. These dimensions may also be reserved with other concepts of dimension of mathematics (such as Schauder dimension, manifolds, Hausdorff dimension, Topological dimension and/or Hamel dimension).

This allows application of mathematical rules and calculations used in this context. In addition, the multi-dimensional pattern should not be considered absolute. There may be several patterns according to which the dimensions may be assigned. Thus the view of the hierarchy is relative to the position of the viewer. Also, the calculations may be dependent on the viewing angle of dimensions. For instance, the distance between two points on the earth is viewed in 2D, other than the distance viewed in 3D. Similarly, this may be the case of dimensions considered in this document. For instance, a document or a document database may represent a manifold, comparable with the surface of the earth. Each dimension can be classified in various patterns. Similar to a map in atlas. Such dimensions and patterns can also be regarded as multi-dimensional bodies.

### Structural Composition of Hyper Adapter

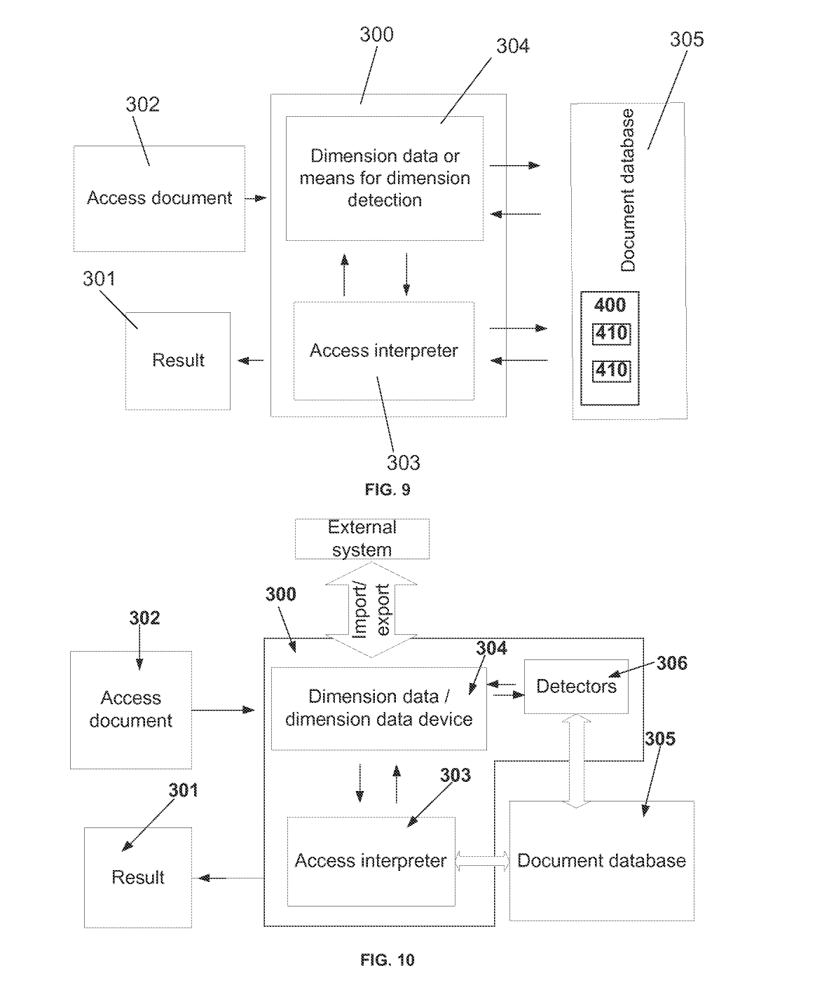

Hyper adapter: FIG. 9 illustrates a hyper adapter 300 in accordance with the present invention. The Hyper Adapter 300, accepts an access document 302 from an input unit which is not depicted. The access document 302 may be generated by both a human user as well as by a machine. The hyper adapter 300 exhibits means by which it can evaluate the access document 302, such as access interpreter 303 (also called as access evaluator in the following text). This uses the contents of access document 302 to perform necessary operations and produce a result 301. Operations may be for instance, the compilation of result 301, or writing in a database 305 with a writing process. Thereby, the Hyper adapter 300 contains means to detect dimensions in the data base 305. Such means 305 are, for instance, dimension data 304 (also known as patterns). Dimension data 304 may also be already present in the database 305. The access interpreter 303 may use this means 304 to produce the result 301.

Basic functionality: The hyper adapter basically provides the features for analysis along with calculations, use as search engine, dimension generation and/or dimension planning, filter, writing and/or reading in dimensions or parts of dimension and/or dimensioning and dimension analysis of a document. Here, dimensioning, and dimensional analysis in this context imply that a document is explored in accordance with the dimensions. It may additionally perform set operations on the basis of dimensions. Furthermore, it can also be used as a virtual adapter. Virtual adapter implies that a multidimensional access is permitted inexplicit multidimensional resources. The individual capabilities of the hyper adapter can thus be implemented as an autonomous technical apparatus or combined in a device.

access document: In this respect, access document 302 does not positively mean documents in classical sense. A document 302 may also access the call API functions. The access document 302 may also be request of API functions. The access document 302 may also be other techniques that are used in accessing computer-implemented inventions. As a result, an access document 302 represents any information for controlling the hyper adapter 300.

Example on the content of access document 302: The content of access document 302 may be used to approach the basic functions of the hyper adapter 300. For instance, it may consist of a request to restore a dimension of the documents from database 305, i.e. all parts of documents that are located or assigned in the requested dimension. Thereby dimensions for instance the dimensions of advertisement at a blog post (see the above example) wherein the advertisement dimension if required for a certain blog post may also be specified by logical links in such an access document 302.

Another access document 302 could be the request of documents or its references that belong to dimensions specified in access document 302.

If an access document 302 has a result 301 as the consequence which is that a subset or references or link to subset of the underlying information portfolio, then the access document 302 is also called as request or query.

Another example is write data from access document 302 in a special dimension. It is noted that even internal parts such as data, functions or devices of the hyper adapter may be addressed via the access document 302. Moreover, as database 305 it is also possible to examine the contents of an access document 302.

It is observed that dimension data may be transferred to access document 302 which is included in the evaluation of access. In a simple case, individual parts of database 305 may be allocated to a certain dimension, for instance.

Such means of classification may be configured to specify by which means a query should be answered. For instance, due to this flexible adjustment, it is possible to elegantly handle the problems of conventional search engines. This it allows answering more than one fixed query, in which the means to answer the query may be specified. Furthermore, the means are also used to describe the association between individual dimensions.

In addition, classification means may be indirectly specified. Indirectly means that the hyper adapter automatically determines which classification means will be used based on the content of access document.

Result: Like access document 302, result 301 is not positively a document in classical sense. Therefore, the same options as for the access document 302 may be used.

Example of the result: for instance, result 301 may be a positive feedback for writing operation. The Result 301 may also be references or links to the dimensions requested by access document 302. The result 301 may also deliver the contents of the required dimensions. Another option could be to execute callback operations.

Procedure: This invention can also be used in a procedure comprising following steps: (1) Identifying dimensions of a database, (2) Interpreting a dimensional access with the help of identified dimensions and/or (3) compiling and/or interpreting the result of dimensional query. It should be observed that the sequence of the steps in this procedure may be exchanged, particularly Step 1 and 2. Here it should be mentioned that step 1 may be executed by dimension data 304, or by other means and methods, such as dimension identification rules which enable identification of dimensions.

Access options at hyper adapter 300: The hyper adapter 300 may be accessed as an autonomous machine via a computer network, preferably a TCP or UDP/IP network. It may also be possible to establish access via the HTTP protocol. Furthermore, it may also be made available via a REST interface (refer “Representational State Transfer”, http://de.wikipedia.org/wiki/Representational_State_Transfer), via a web service/SOAP interface or via a Remote Procedure Call interface. The hyper adapter 300 may also be accessed via web interface or a hardware-based interface.

Distribution of components: The Hyper adapter 300 may also be distributed via several machines/computers and/or implemented as a distribution system. For instance, the dimension data 304 may be allocated to another device such as the access evaluator/interpreter 303. The various components of this invention can communicate to each other via a computer network. Another option is use the hyper adapter 300 in a Peer-To-Peer Network.

Expansion: According to a model, the access interpreter 303 is also capable of incorporating specific logic in access document 302. For instance, this could be identification rules for other dimensions. Or it is possible to specify data on dimensions. This enables handling Dimension A as part of Dimension B for the duration of access and/or via a multiple accesses. Such logic may be stored permanently in the hyper adapter 300 and addressed by other access documents. Furthermore, this logic also enables integration of additional, external data into the data base 305 for the duration of access, or even permanently if required.

Output Channel: The upgradation of the hyper adapter 300 allows you to select different output channels. For instance, result 301 of access 302 may be directly disbursed to a printer. Furthermore, it is possible to select other technical devices, systems and/or network such as mobile phone networks, SMS, cell phone, PDA, fax, E-mail, Internet, wireless connections, PDF, circulating systems, monitors, web server and many more as output channel. It is observed that it is also possible to select output channels on the basis of rules, for instance, the dimensions contained in result 301. Such rules can be stored in hyper adapter 300 and/or specified and/or referenced in the access document 302. While comparing hyper adapter 300 with a search engine, the output channel may not be specified.

Interface: The hyper adapter 300 optionally contains a dimension-oriented interface. This interface can be implemented for an access interpreter 303, for instance.

Pre-defined operations: In a specially preferred model, the hyper adapter 300 indicates predefined operations, which are useful for all types of access. These operations are used to specify via access document 302 which actions of hyper adapter 300 should be executed. Example of such operations includes reading and writing dimensions, analysis, locating dimension junctions, dimensioning of an access document 302, or even the integration of rules specified in the access document 302. Furthermore, such operations may also be for instance, the request of a dimension list for a certain document from the database 305. It is also possible that operations such as a certain document may be integrated in the database 305 through such operations. Another possible operation is incorporating information from a document to the dimension data 304. These operations are also known as logical interface. In order to provide such features, this may be implemented in access interpreter 303 for instance. Even multidimensional operations which optionally consider the hierarchies with respect to dimensions are also available in specially preferred way.

Dimension Data and Alternatives: As explained earlier, the hyper adapter 300 indicates means to identify dimensions.

Such means may be dimension data 304 which contains the information on the dimensions existing in database 305. Another option is that these means are provided via a separate device. This device is called dimensional data device. Another possibility is to use other external programs or equipments which generate dimension data such as the detectors described below.

Dimension Data: A simple example of dimension data 304 is a list of dimensions and specifications, where fragments of the dimension can be found. Dimension data 304 may also be rules on how the dimensions shall be identified in the database 305 or in an access document 302. Furthermore, it is possible to define rules in a computer-enabled form. For instance, the rules may be specified in a logical language (such as Prolog, Tyruba etc.) or it is possible that the rules may be executed on a virtual machine, an interpreter, or a microprocessor (Java, C#, Python, C++, C, Visual Basic, PHP and the like). Furthermore, here it is possible to compile the rules before they are executed (for example, source code).

The Mappings may also be an alternative to rules in the dimension data 304. Mappings specify which parts of documents from database 305 belong to which dimensions. For instance, such a Mapping contains links or references to dimension-related parts. A Map Set combination is an example of a data structure on how such mapping could be applied. Here, the dimensions would be stored in the map and the associated links or references in the set. Links or references for instance, hard links, soft links, pointers, links or references to rules, or rules themselves.

Dimension Data Structures: dimension data 304 may be implemented by various data structures. For instance, by multidimensional patterns similar to the pattern described above, represent extension to these or are based on the same or similar thoughts. Furthermore, it is possible to weave such data structures implicitly into a computer program. Implicitly, here implies that a multi-dimensional pattern may not be directly used in program code but instead its logic is implemented through program code. The same is true for program code with several patterns. Another option for dimension data 304 is to use other devices such as a dimension data device or detectors.

Detectors: The particularly recommended extension to a hyper adapter 300 is dimension detector 306 (see FIG. 10). Detectors 306 may be used to disclose dimensions or their fragments and data via this in the database 305. Furthermore, detectors 306 may also disclose associations between dimensions. However, they are recommended to be used in combination with dimension data 304. Often detectors 306 are implemented as an autonomous technical device. In addition, it is also possible that detector 306 is composed of several individual detectors 306. For instance, detectors 306 are found in the applications below. Detectors 306 may also be used to replace dimension data and used directly in access evaluator 303. Here, for instance, the combination of an implicit data structure with detectors 306 existing in program code is possible.

Detectors and Dimension Data: The dimension data may also contain links to detectors 306 in a particularly preferred model. Another option is that Detectors 306 write data in the dimensions data via disclosed dimensions. The detectors may also use dimension data to identify other dimensions. FIG. 10 illustrates a hyper adapter 300 with dimension data 304 and detectors 306. In doing so, it is to be noted that the dimension data 304 may be exported or imported to external system.

Dimension Data: An extended version of the hyper adapter 300 allows requests to assign dimensions through which access documents 302 were created. Such requests are stored here. This could be used to assign other or existing dimensions.

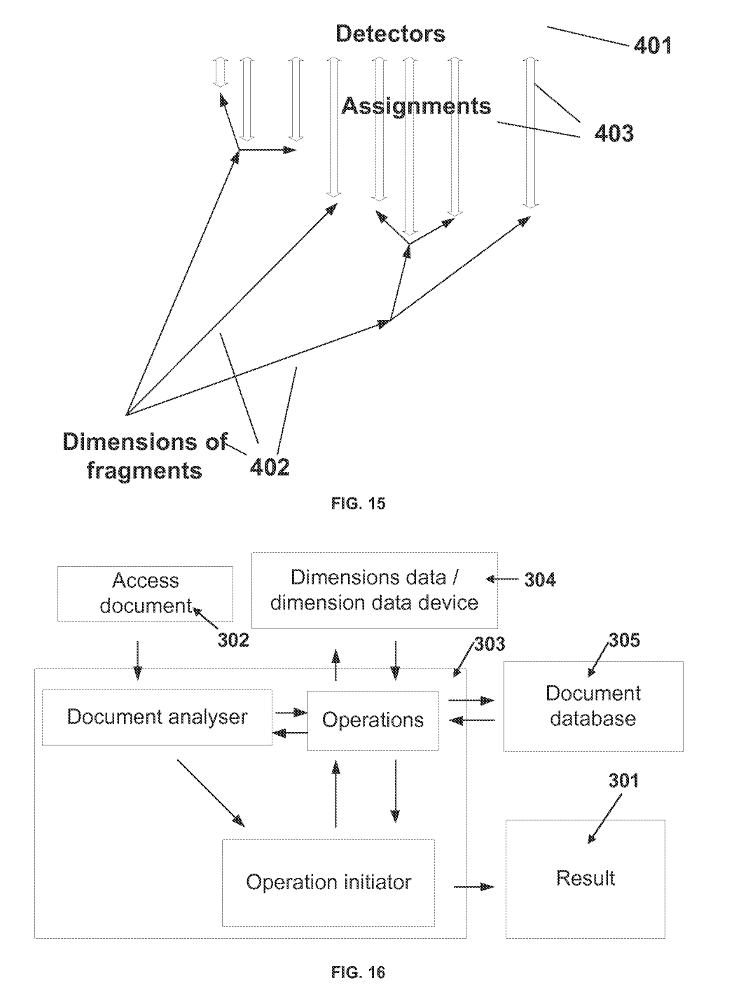

Dimension Data Detectors pattern: As illustrated in the initial example, the multidimensional pattern may be used as an alternative to simple mappings. FIG. 15 illustrates the sample interaction of detectors 401 and a multi-dimensional pattern 402. Here, the detectors 401 assign individual dimensions in pattern 402. The assignments 403 illustrate that the detectors 401 may be accessed on pattern 402. It is also possible that pattern 402 may contain links to the detectors 401.

Fuzzy Logic: Another extension of the hyper adapter 300 can use Fuzzy Logic. Fuzzy logic can be used at various points in the hyper adapter 300:

Another preferred model may contain fuzzy specifications on dimension data 304. For instance, a fuzzy specification may be of percentage to what extent a document fragment or document is associated to one or several dimensions. Another possibility is that the rules and/or detectors 306, 401 provide vague information for identification of dimensions. In such a case, the rules may themselves provide a fuzzy result or a rule or detector and their result may not be specific. Even here a combination is possible.
The last finite number of association may be determined via simple or complex calculations. Autonomous machines or computer program products may be provided over complex computations.

Example of fuzzy information: For instance, a rule R or a detector D provides result that there are z % chances fragment F is in one dimension. The rule R or D themselves may be accurately classified as y %. Then last association may be possible complex computations by z*=y dimension association in %.

Technical use of dimension data: Basically the data 304 may be saved on a few systems, devices or various data storage devices such as hard disk drives, flash cards, tape drives, RAM or similar storage technologies. The relational or multidimensional databases may be used as other special storage for Dimension Data 304. Here it is also possible to use Data Warehouse Systems or associated technologies. Furthermore, it is possible to store dimension data 304 in a XML Document or in a file system. Another option would be to the store data 304 in documents or in data base 305. In addition to this, hybrid forms may also be implemented.

Technical execution with IDs: For multi-dimensional patterns of dimension data, it is particularly recommended to assign an identity/identifier (ID) to fragments of the database 305, since a fragment may appear in several patterns. For instance, such an ID may be generated by a counter. But it is also possible to use hashing. At this point, hashing has the advantage that the UD may be directly calculated from a fragment, without requesting any system, such as the counter. If fragments of the document database 305 are stored in version management system, then IDs are generated with respect to this system.

Basic dimensions: a hyper adapter 300 may also include one or several basic dimensions. The basic dimensions are elementary dimensions which consist of several other dimensions. Such basic dimensions may be reading, writing, modifying and/or generation. In this context, it is important to note than only the existing content may not be regarded as dimensions but also the forms for instance which enable addition of contents. For instance, comment is a sub-dimension of writing. Apart from this, the basic dimensions may be used to associate with access types, for example a comment may be written through a written access to comment dimension. This may also be done by a REST POST access to the Hyper Adapter 300.

Dimension Meta data: The hyper adapter 300 optionally indicates dimension meta data. These include data/information on each dimension. It may be keywords that describe dimensions in detail, for instance. Thus, there is an option to statically apply it. Another option is to disclose dimension meta data through detectors and/or dimension identification rules. For instance, comments may be identified in source text of dimensions as dimension meta data with analysis of computer programs. Thus an annotation may have a comment that describes the application of associated source text, for instance Javadoc in case of Java. These descriptions may be added, referenced and/or used as link in the dimension metadata.

Access interpreter: This invention may also feature an access interpreter 303, which is responsible for analysis of one or more access document (s) 302 and execute the operations resulting from it. Such access interpreter 303 may be used by an interpreter, bytecode interpreter, a compiler a JIT compiler for instance. During implementation of access interpreter 303, findings from database technology, Data Warehousing and compilers/interpreters may be preferably used.

The multi-stage methods may also be used. Multi-stage means that the access interpreter 303 is analyzed first and an interpretable or compilable document is generated from it. In addition to this, it is also possible to use hybrid methods.

Such an access translator 303 may also function as an emulator. For instance, in which it provides access to dimensions via a streaming API. Thus a client may access dimension as in a normal file.

The operations executed by the access translator 303 may be implicitly or explicitly triggered. For instance, the automatic execution of write operation is implicit if a streaming API is provided and a writing method is executed by the client. In this context, explicit implies the operation or operations that shall be executed are directly specified in access document 302.

In particularly recommended model, the access interpreter 303 uses other components of invention to execute the operations requested through the access document 302. The access interpreter 303 alternatively supports other functions and data described in the logical interface and other parts of the invention.

Identifying dimension in access document: The specification of a dimension may be made in an access format 302 via one or several identifiers, for instance. One such identifier for a dimension, may be a unique identifier. Furthermore, the identification of requested documents is done on the basis of dimensional metadata. For instance, by which the dimensions are described in the access document 302 through keywords/tags and this is compared with the keywords in dimension metadata. The popular means or methods from the best available technology may be used for such comparison. An alternative is to specify the dimensions in access document 302 based on an example. Thus for instance, the caption dimension of a document may be requested. Thus, as mentioned in the example, document containing captions may be available in access document 302. Then access evaluator 303 may determine dimensions in sample document by other means of hyper adapter 300, for instance detectors 306.

Storage unit: It is to be observed that, while writing data in dimensions, modifying contents of dimensions and/or generating new dimensions, the hyper adapter may be available via means to directly write the data in database 305, for instance via the access evaluator 303. Furthermore, it is possible that the hyper adapter may be available via a separate storage unit in which the data is stored. This is required because often there is no write access to all documents from the database, such as from several websites. This storage may also be linked to dimension data or integrated in it. The reason for this is that with an access, the data from original database may be combined with the data in storage unit of the hyper adapter 300.

Other operations may be enabled on the basis of such storage. For instance, the part of database may be provided from external devices, including devices, such as a Web server where this memory is accessible. This can serve to integrate the contents completely or partially.

Local memory for dimension planning: In addition, the described memory may be used to plan new dimension or content of dimensions. Here, the planned data is written in the memory. The data from memory as well as from database 305 may be used for access. Like before, external devices may access this data, for instance, to write it in the database. Furthermore, the hyper adapter 300 has a means such as rules which determine when and whether and how the data shall be written from memory into the database 305.

The addition and/or modification of dimensions and/or data in these dimensions can be done on the basis of predefined pattern. In addition, which data may be modified or dimensions may be created is determined by other technical devices or computer program products. It is also possible to write data in database 305 on the basis of same means.

The planned vs. actual comparison with planned data: It is crucial to know that if the data may be stored as dimension plan data, panned vs. actual comparison is possible with database 305.

Fuzzy detectors: In another particularly preferred model, the detectors 306, 401 deliver unspecific Fuzzy logic results. Thus it is not clearly specified how many parts of a document or document fragments are in one dimension. For instance, a class is derived from a framework class so that it is strong in the dimension of framework. But if only one function of framework is used, then the consuming class is not as strong in the dimension of the framework.

Crawler: It is particularly preferred that a hyper adapter 300 also have one or several crawlers. Thus, periodic detectors 306, 401 may be executed and their results are evaluated using hyper adapter 300.

Stored Queries: Special preference will enable the Hyper Adapter 300 to store queries (save). Thus, it may be possible to specify the output channel for query on the basis of another due to another model (output channel). Furthermore, such queries can also specify that if documents were found that match the query, the relevant document must be automatically submitted via the output channel.

Operations based on queries: Other operations can be triggered in hyper adapter 300 on the basis of stored queries which may be “triggered” by rules.

Automatic pattern recognition: In another model, this invention also contains the means for technical identification of the pattern. This identification of patterns may be done for instance, on the basis of detectors 306, 401.

Generating detectors: A specially preferred model of hyper adapter 300 can generate detectors 306, 401. For instance, often a new dimension is detected by a human detector. This information and the associated document may be used to train a neural network that can be used as a detector.

Extending the Hyper Adapter by detectors of users: A specially preferred extension of Hyper adapter 300 allows users to add more detectors.

Darwin: The Darwinian methods may also be used in hyper adapter 300. An example of their application are detectors added by users. Thus, Darwinian methods may be used for advance development. The detectors developed by a user may be further developed by another user. Every new version of such a detector will be tested. Once a version delivers higher performance than pervious performance, it is automatically replaced.

Furthermore, in this case yet more factors play a role in the replacement of a detector. For instance, the results of a new detector may be displayed to other users. Their operations based on the results of detector may be used to assess whether the detector is actually more accurate than their previous detector.

Even human detectors can be used in this context. Based on the results of the human detectors, like before the detectors may be determined which deliver better results. Thereby the detector and a human may be replaced by another.

Neural networks: Neural networks may be used in Hyper adapter 300. Thus, such a neural network may be used either through a technical device or an artificial neural network.

Application of inference engine and/or inference rules: The inference rules may also be used in a hyper adapter 300. This enables conclusions of type that if a fragment lies in dimension then it must be a part of another dimension. Or if a dimension is requested during access, then this could have the logical consequence that even other dimensions may be required. Such rules of inference may implement popular inference engines from the state of art technology.

Inference rules may also use information from dimension data, for instance from multi-dimensional patterns to form conclusions. Furthermore, it is also possible to use inference rules on the basis of unclear specifications. Here it is also possible to use additional inference rule data in multi-dimensional patterns, such as probability values.

Bayesian networks: Other Bayesian networks may be used in Hyper adapter 300. For instance, these can be used to determine which dimensions were most likely to be correctly ascertained on the basis of results of various detectors.

Security features: The hyper adapter alternatively contains means to protect individual dimension contents, pattern and/or means/techniques made available by hyper adapter 300. In order to implement security functions or a security system, other means of the hyper adapter 300 may be used.

Enhancing data/documents/parts of document: The hyper adapter 300 may be used by various means to enhance documents and/or modify them. For instance, the data from internal memory may be combined with the data from database 305. Thus, such a combination of may be requested via an access 302. The Hyper adapter 300 would combine internal data from the memory with data from the data base 305 and thus a new combined document may be generated as result 301.

Another example for enhancement of data would be that the hyper adapter 300 enhances a document from the database 305 through dimension data. For instance, dimensions may be marked in edited document by tags or annotations.

Options to communicate with clients: The Hyper adapter 300 can be implemented via various alternatives. Here, the main difference is that various parts of the hyper adapter may also be implemented on one or multiple clients.

FIG. 11 illustrates an exemplary client 307 who communicates with the hyper adapter 300. Here, the client 307 may directly access database 305. The client 307 may thus access hyper adapter 300 to write, read, execute modification and or perform other data or functions of hyper adapter 300. The hyper adapter 300 can itself access data base 305 to analyze, read, and/or write data on it. The client 307 has the option to modify the data from database 305 or execute this operation through the hyper adapter 300. The client 307 may notify the hyper adapter 300 or the modifications may be automatically detected through detectors.

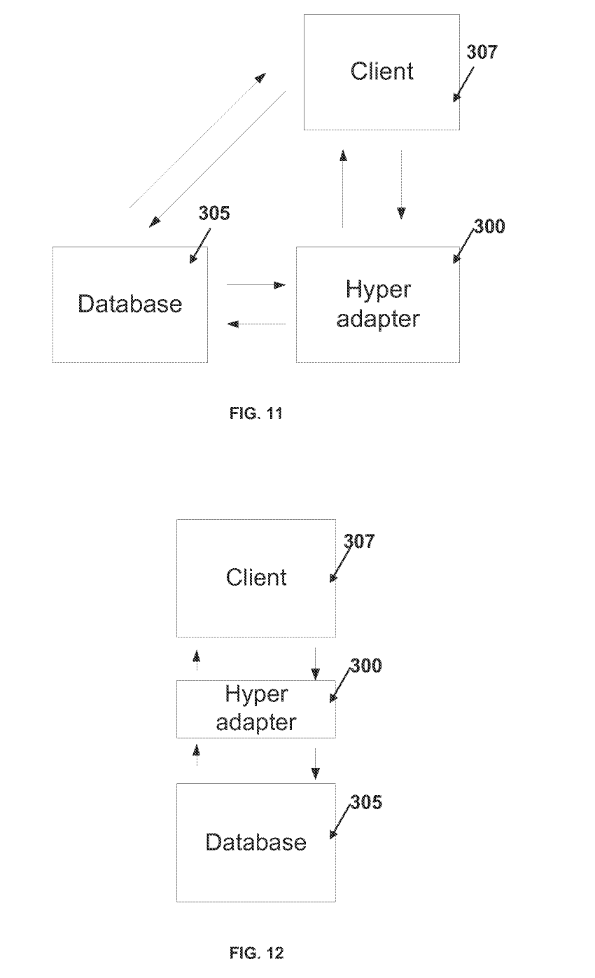

FIG. 12 illustrates the hyper adapter 300 as coupling link to the data base 305. Here the access to database 305 is executed through the hyper adapter 300. The client 307 communicates only with the Hyper adapter 300, and this serves as a converter for access 302 to database 305.

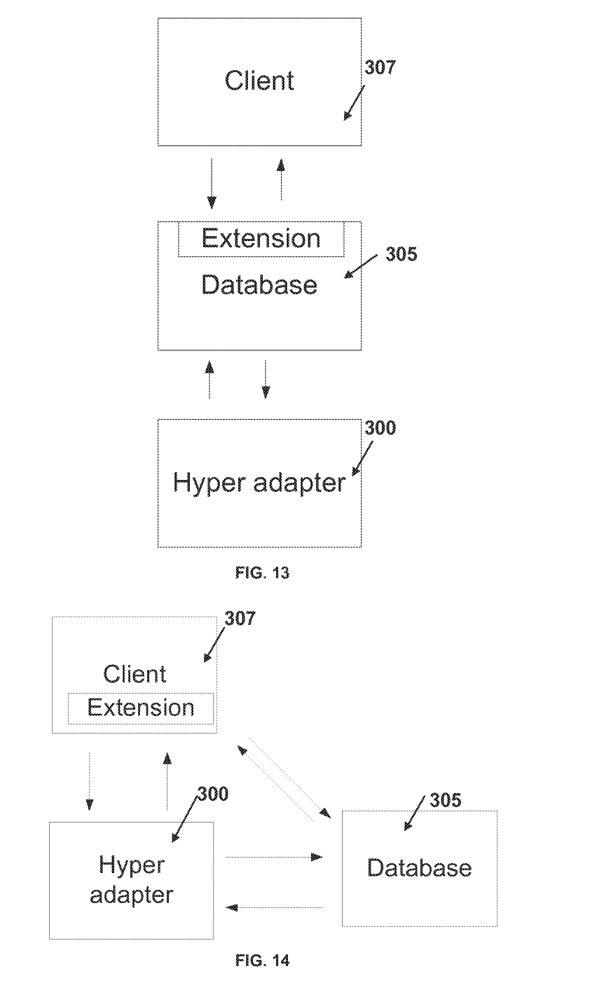

FIG. 13, “Configuring a Hyper adapter and interaction with clients 3” illustrates a data base on which a technical device is applied. Such a database may also be a web server. It contains an upgrdation which enables application of a hyper adapter or implementation of the hyper adapter. Thus the client may use functions of the hyper adapter through this upgradation. Furthermore, such an arrangement allows client to implicitly use the functions of hyper adapter. For example, the client may receive enhanced data through the hyper adapter in advance. Or the data is sent from the database in such a way that the client has the option to execute all modifications. This possibility is not provided by the database but by the hyper adapter and upgradation.

FIG. 14 illustrates upgradation in client 307. This upgradation helps in utilizing the functions of hyper adapter 300 or may demonstrate implementation of the functions belonging to hyper adapter 300. For instance, multidimensional operations can be applied in upgradation. This could be used on a document in client 307, enhanced by dimension data.

Cryptographic techniques: A Hyper adapter 300 may also use cryptographic techniques and/or algorithms. For instance, the links between the hyper adapter 300 and a client 307 may be encrypted or the data written by a user in the dimension will be stored.

Filter: The hyper adapter 300 as well as a filter is particularly preferred for functioning of a database 305. Thereby such a filter can be configured by multidimensional concepts. For instance, the content of a part of database 305 may be determined by an access document 302. Then result 301 may be used as the reason for deciding which elements shall be displayed. Alternatively, the hyper adapter 300 has a filter mode, which allows access to a database 305 through hyper adapter 300 and filter it on the basis of configuration.

Parser: Alternatively, this invention has one or several Parsers. Depending on the application, this may be specially customized and used in various areas such as “Abstract Syntax tree” Parser. For instance, such a parser may also be used in detectors. This would facilitate the analysis and discovering the dimensions in source code.

GPU: Since Hyper adapter 300 supports multi-dimensional operations, it may be used in implementing a GPU (Graphics Processing Unit) and/or a graphics card for part of adapter 300. This may have a strong effect on the acceleration of adapter part 300 due to the parallelism of GPU. For instance, this may lead to faster transformations or calculations.

Physics Processing Unit: if analysis is done, it may be advantageous to use the physics processing unit or a physics engine. Thus, the help may be accepted which is mounted on hyper dimensional body on the basis of dimensions. For instance, the collisions between individual bodies are calculated thereby. Or the hyper dimensional body may be considered as “flexible” body by Fuzzy Logic.

Fuzzy Logic chips: Based on unspecific dimensions, it may be beneficial to use chips specially optimized for it, for instance DSPs during implementation. The fuzzy operations may be conducted with increased speed through special customized chips.

Import/Export of dimension data: A specially recommended upgradation of the hyper adapter 300 enables import or export of data dimension.

Access document generator: Alternatively, the Hyper adapter 300 has a tool that enables easy and convenient compilation of queries. Such a tool allows you to add elements to a query 302 in a graphical user interface through Drag and Drop (DND). Thus, pre-defined dimensions may be added by DND and/or it is easily possible to implicate elements whose dimensions are identified, whereby the dimension is added to access. An example of such elements from software development may be annotations. The access document generator identifies the dimension of annotations and adds them. This is preferably done via a graphic user interface of the hyper adapter 300.

External system integration/bridge: It is specially recommended, that hyper adapter 300 has a bridge (Bridge), on which the external systems and/or their information can be integrated. Thus for instance, links or references to data from external system may exist in the dimension data. Especially, Data warehouses and/or Issue Tracking Systems for version management systems

Another function may be enabling automatic access to external system by access to hyper adapter 300. For instance, such bridge enables realization of links to personal system based on “Author” dimension. Thus, it would be possible to provide queries of following type: All articles of blog Z written by specific authors, who are the team members of Team X. The Hyper Adapter 300 could determine the member of team through the external system and then generate the required article as result.

Data Warehouse: In one model, the findings of this invention may be used in a Data Warehouse. Here, a Data Warehouse serves to ensure that it is used as a basis and implement the functions of hyper adapter 300. Furthermore, the invention and procedure of generating dimension data may also serve to export this to a Data Warehouse.

Often data is also present in a Data Warehouse via a document database. Therefore, operations are provided which enable a hyper adapter 300 to be used together with a Data Warehouse. For instance, a hyper adapter 300 may provide a virtual Data Mart Interface. Or the hyper adapter 300 may use a Data Warehouse through these operations.

### Predefined Operations

In a special recommended model, the hyper adapter 300 illustrates one or several of the following predefined operations that may be operated by the clients 307 via access document 302. In this case, such operations can also be accessed by speech. For this reason, the note of speech is same for further course of operations.

Operation for upgradation: A special recommended operation enables specification of other operations. For instance, internal operations may be combined and provided as new operation. Another example would be to define the operations in access document 302 which may then be added to the hyper adapter 300. Other programs or operations executed on other systems may also be added as operations.

Direct access to internal components: One more operation provides access to all components of the hyper adapter 300, so that these internal functions may also be used by external devices or programs. Here, it should be noted that by this type of interface, particularly recommended components may be used which were not best available technology previously.

In this model, it is also possible that the hyper adapter 300 may only have components that can be used by external equipment or systems. For instance, the hyper adapter 300 may only have detectors 306, 401 which provide new technique, rules and methods.

Logical operations: The logical, mathematical functions and/or conditions are supported as operations. Thus, operations imply functions such as +, −, AND, OR, WHERE or mathematical functions. Such operations may be used for calculations and/or comparisons, for instance.

Calculations: Moreover, the operations are provided for mathematical calculations. Such operations make it possible to use complex and simple mathematical functions. In this context, it is particularly recommended to use hardware optimized for mathematical functions. For example, optimized chips such as Graphic Chips (GPUs) are used for parallel calculations.

Logical operations and dimension links: The logical operations introduced earlier may be used to specify dimensions in a query 302, such as “Dimension 1 AND Dimension 2”. This implies that those fragments may be selected that are in Dimension 1 and Dimension 2. Or “Dimension 1 AND Dimension 2 WHERE sizeoflines Dimension 2>50 lines”. WHERE specifies another condition. For instance, sizeoflines may be a computation, which calculates the number of lines of a fragment. Therefore, result would be all fragments, situated in Dimension 1 and 2, and whose lines are greater than 50. Here it is to be noted that operations may also be considered as dimensions.

Recursive requests: A special model allows you to use recursive expressions. Recursive signifies that operations are performed and the same operation is used on their results. Thus it is also possible to determine the depth of recursion through parameters or stop functions. Following must be answered in case of source code: Which action in the user interface is finally responsible for indirect request of Function F: Recursive determination identifies the F requester by stop function whether a requester is in the user interface.

Accessible requests: Another type of model provides operations that enable results 301 to be further processed as separate dimensions. And thus can be applied to these advanced operations. For instance, the dimension of users may be determined by the functions of persistence dimension. First of all, detectors, fragments for example, are identified in the persistence dimension based on the means of hyper adapter 300. Then it can be determined which functions may have access to it. Based on the above blog example, the function request may be considered as a hyperlink. All blog posts from the blog linked to blog posts with Tags “XV”. Then result 301 consists of all the blog posts that refer a hyperlink on the result “Blog posts with Tag XY”.

The hyper adapter 300 may be provided for such cases to accelerate this operation via optimized implementations. For example, aggregate may be formed on the basis of such “intermediate results” or the internal precomputation of often required “intermediate results”.

Multidimensional expressions: A particularly recommended specialization provides operations which enable processing of multidimensional expressions. Thus it is possible to allocate upgraded option such as expressions with variables. An example of this is issuing the caption from a specific document. Thus a dimension crossover is described in this expression. A specific document must be selected once from the dimension and the caption in it.

Formatting of results: Other operations may be used to format the result 301. Thus formatting may also be a conversion, for example in a diagram.

Multidimensional Schema Selection: If several patterns are used, then operations serve the purpose of selecting a specific pattern or several on the basis of which these operations will be executed. In above example, the blog post was allocated in only one pattern. However, it is possible that the dimensions may be sorted into different patterns. Thus it may be necessary to select a solid pattern for processing an access 302

Type Casts: It is specially recommended to provide operations for converting type. For instance, often there are dimensions, such as lengths which can be expressed as numbers. If such dimensions are present, then it is sensible to convert these also in number. These operations assist in executing explicit and/or implicit conversions. Here explicit means a required cast, whereas implicit means indirectly required conversion, though they may be derived from required operations or the access document 302. In this context, it is also supposable to execute conversions by operator overloading, similar to C++ operator overloading.

Transformations: It is specially recommended to provide transformation operations. These operations assist in transforming the contents of the document access 302. For instance, a conversion is necessary with a write access in a certain dimension so that the content of access document 302 is also present in suitable format for database 305. Another example is to display an unstructured document as XML document in the database 305. Thus transformations may be done by separate technical devices, rules, or computer program products. Furthermore, there is an option to specify such operations in access document 302. It is specially recommended that the hyper adapter 300 feature a transformation engine which provides optimized methods for transformation.

Fuzzy logic: A specially recommended upgradation supports fuzzy logic operations, such as those known from the best available technology. Thus additional fuzzy set operations are used. These fuzzy operations make it possible to “fuzzy-fy” all other operations described herein.

For example, the query “Dimension 1 AND Dimension 2” may also be executed on the basis of Fuzzy Logic. This may include elements which are situated in different dimensions and the percentage illustrates how strongly they lie in individual dimension. Or it could be possible that one dimension may have several strong characteristics. The above example of blog depicts posts have with a lot of advertisements as well as posts with few advertisements.

Threshold: Another model of the innovative Hyper adapter 300 enables specification of threshold or threshold functions. Thereby threshold is a value that enables specifying a value for vague specifications from when these belong for to a certain dimension. Thus, threshold may be specified with respect to several dimensions. For example, “70% Dimension A and 50% Dimension B” are evaluated as “Dimension A. Threshold functions allow such assignments on the basis of rules or separate technical specifications. An example of such technical device could be a neural network. Such thresholds assist in “de-fuzzify”. The purpose of these thresholds is to use them in queries or define results in accordance with detection of dimensions. In doing so, the thresholds or threshold functions can be specified in the can query itself 302. It is also possible to store this in hyper adapter 300 and use the threshold at results of detectors or detection of dimension.

Threshold for Fuzzyfication: Another application of such functions/operations is the inverse of the concepts introduced earlier in same areas. For instance, dimensions may be established via fragment only with exact specifications. Dimension 1, 2 and 3 is the example of Fragment A. This could now by fuzzified by rules or a device, for instance with following rules:
Dimension 1 is always 100% accurate
Dimension 2 is up to 40$ accurate, if it occurs together with dimension 3,
Dimension 3 is up to 70%, if it occurs together with dimension 1.

In the above example, this would assign the fragment to dimension 1 to 100%, dimension 2 to 40% and dimension 3 to 70%. However her it is observed that this is an extremely simple example. In reality, complex computations or internally stored statistics may be applied via dimensions. Thus, other parameters incorporate for instance, which detector has yielded this result.

Affiliation functions/Fuzzy functions: affiliation functions and fuzzy functions are established from the best available technology and may be applied as threshold functions in hyper adapter 300.

Intensifier—Amplifier: If fuzzy information is used, it is possible to use one or several intensifiers. Intensifier can assist in amplifying or reducing information on the basis rules. Thus amplifier such as a filter may be used.

This implies that it may also be arranged in a sequence. For instance, a simple implementation is a list of associations consisting of dimensions and an amplification factor. Another option is a trainable amplifier that may be implemented through neural networks. Amplifier can be used at various places in the hyper adapter 300. For instance, in detectors to identify dimensions. Here they can be used to directly amplify the identified dimensions.

Operations in fields: Often a dimension has various characteristics. These characteristics may be a measurable quantity, such as the length of text in the blog example. Other areas may be, association percentages for instance in fuzzy dimensions. Another example may be the evaluation of a document by a numerical value. Thus it sensible to provide operations to work in fields for instance that enable from and to value. The queries of following type may be put with such operations: All documents that are at least assessed as useful and are reckoned between 50 and 70 percent for Biology dimension and belong to Mammal dimension with more than 80% and are written by Author XY. for the dimension and the dimension biology include mammals with more than 80% and include the author XY are written.

Version-oriented/time-oriented operations: Please note that documents often exist in different versions. Version is another example of areas/dimensions. Here various versions or even time are considered as dimensions. Thus operations are provided to work with them in these fields.

OLAP operations. In a specialized model of invention, the invention hyper adapter 300 features one or several Olap operations. These operations may have the same functions as of the popular OLAP operations, for example:
Slice: Segregation of fragments those are associated to a dimension. A slice of reality is selected or computed.
Dice: Several Slice operations are combined. In doing so a smaller multidimensional section is generated from the database.
Pivot (Rotate): “Rotating” the current result in the direction of another dimension.
Drill down: “Zoom in”, that means a dimension is split into sub-dimensions.
Roll-Up: counter operation to drill down, consolidating to higher level(s) of hierarchy.
Drill-Across: Viewing and comparing various elements of dimension that may occur from another database.
Drill-Through: Improving the level of details.

Specific OLAP extensions: It is particularly recommended that the Hyper adapter 300 support at least one part of the following additional operations, since only one dimension may be found at data in contrast to Olap, which may be simultaneously found in several dimensions within the context of hyper adapter 300:
Hypercut: A Hypercut is the operation to deliberately exclude a dimension. In this context, exclusion means that fragments which are actually the content of the result 301 are excluded if they lie in dimension specified through hypercut. The dimension excluded from Hypercut,can be defined by all other operations.
Hype edge: A hyper edge is the operation that generates a slice on the basis of an AND operator. Thereby AND is the logical AND operator. The artefacts that must be situated in two dimensions are determined here.
Computing Operations: computations that should be performed while executing the query 302 and their result matter 301, other operations or by conditions.

Complex analysis operations: It is specially recommended to provide operations that enable complex analysis. Such complex analysis indicate modifications in a period, for instance. An Example: There may be an operation within the scope of this invention which enables identification of dimension modifications. The easiest way to explain this is on the basis of source code.

A module F is introduced to which various dimensions 1, 2 and 3 are assigned. After executing refactorings and/or further development, a dimension 1 is outsourced in another module G. Due to detectors, now it may be determined that F is only found in Dimension 2 and 3. Thus, a fragment is routed out from Dimension 1. These modifications in dimensions may now be viewed by History. Such an analysis allows “moving” a fragment to identify the dimensions. Furthermore, it may also be identified which fragments were excluded. For instance, fragment G is very similar to the previous code of F, or data on the executed splitting exists in an issue tracking system. Thus it can be determined where the Dimension 1 has “migrated”.

Complex operations for identifying dimension collision: It is specially recommended to provide at least one complex operation to identify collisions. The theory given below may be used: Documents from data base 305 represent hyper-dimensional figure. These figures are moved in a multidimensional zone by modifications in documents. The development of such a figure may also be considered as shifting. For instance, a fragment in advance development may also contain other dimensions. In the example of blog posts (see above), this could be a change in one of the blog posts, so this contains a citation in new version. The area containing hyper-dimensional figures may be clamped through pattern, for instance. Multidimensional layers may be installed in this area. Then it may be investigated whether a hyper-dimensional has a collision with any such layer. For instance, a class is to be assigned while programming the dimension of service layer. The layer specified now is the layer of database access. Thus all dimensions which enable execution of database access are used for spanning the layer. Once the class is developed further and database access is executed, the class removes the layer of database access. There will be a collision.

Identifying fuzzy dimension collision: As described earlier, the collisions can be identified. Even fuzzy bodies and layers may be used in doing so. The collisions may be computed depending on the stridence of a dimension.

Identifying collision through computer game technology: If multi-dimensional body view is applied, then it appears similar to a computer game. For instance, the characteristic of fuzzy dimensions may be viewed as elasticity. Or dimensions may be defined with different strength in different dimensions. This could affect the size of such a body. The elastic layer is considered similar to a rubber sheet that can be stretched by puncturing and it eventually breaks. Thus, knowledge and technology used there can also be used in hyper adapter 300. For instance, the identification of collision may be executed by a physics accelerator or a physics engine (see above).

Writing operations: It is preferred that the hyper adapter 300 provides operations specifically for writing operations in dimensions or parts of dimension. These operations may use all operations introduced earlier to write in individual dimensions. For instance, dimensions may be specified for a writing procedure via OLAP operations. In this context, it is particularly preferred to use transformations and type transformations to bring data in a suitable form for writing. These may be used implicitly or explicitly as with other operations. The writing operations are particularly preferred which allow you to specify through access document 302 how a dimension is written. Even data as written in a dimension may be an alternative extension for direct forwarding to the clients so that he may directly write in a dimension.

Transaction operations: The hyper adapter 300 provides operations for transactions which address several dimensions. Often the consistency of data must be protected in the database. It is useful to fulfil several dimensions during writing, for instance. Transactions may be used for this. These primarily allow filling several dimensions and executing writing operation as transaction. For instance, a Catching Layer may be used for implementation. The transaction can be explicitly managed by access document 302 or by implicitly triggered transactions.[

Operations for generating diagram: It is particularly preferred that hyper-adapter 300 provides operations that allow generation of diagram. For instance, network diagrams could display the extent of difference in dimensions or exist in database. It is particularly preferred that these operations be combined with other operations. For instance, OLAP operations may be executed and a diagram can be generated based on these results 301. However such operations may also be swapped out from the hyper adapter 300. For instance, on clients 307 itself. It may also be used to generate diagrams of a specific hardware. The transformation of a result 301 in a diagram may be accelerated by a graphics card/GPU.

Periodic Analysis: It is often useful to conduct time-controlled analysis or generation of results 301. Therefore, such operations are provided that enable execution of periodic analysis. Thus, for example, reports on data base 305 are automatically generated.

Alert operations: The Alert operations (alerts) can also be used in terms of periodic analysis. Such operations allow execution of actions on the basis of rules. For instance, an E-mail, SMS or similar of unexpected results are automatically sent in a periodic analysis.

MDX operations: The hyper adapter 300 supports all or at least one part of MDX-expressions (refer “Wikedpia Article MDX” http://de.wikipedia.org/wiki/MDX.).

MDX Extensions: It is specially recommended that the other operations introduced here should also be at least partially supported by the hyper adapter 300. This means that new concepts such as a Hypercut may be applied while using MDX in the hyper-adapter 300.

Operations to store access and/or repeating execution of stored access: It is specially recommended that such operations that enable storing access exist. Thus the data written and/or read in an access is not stored, but the specification of access itself. For example, an access whose all fragments are in dimension 1 and dimension 2 is generates as result 301 are stored. Subsequently this access is again addressed through special operations and is executed.

Operations for Training Impulse: Techniques from the field of artificial intelligence or other intelligences such as neural networks are applied at various areas in hyper adapter 300 which provides the operations for training impulse to Hyper adapter 300. Such training impulses can be used to train these mechanisms. For instance, they can be trained by neural networks or fuzzy dimension data or dimension allocations can be amplified and/or reduced through Feedback Impulse.

Data mining operations: It is specially recommended that the hyper adapter 300 provides operations that execute Data Mining Algorithms (such as A* and others) on the basis of dimensions and patterns. In doing so, it is also possible that Data mining is not executed in the hyper adapter 300 but in a similar device. It is possible that the algorithms directly work on the findings of this invention, for example on the dimension data.

### Access Evaluator/Access Interpreter

The preferred example of executing the innovative access interpreter 303 (also known as access evaluator) is explained below.

Procedure of access evaluator: In order to process the queries requested in access document 302, the access evaluator performs following steps, at least in part by:
1. Analysis of the access document 302 for identifying at least an implicitly and/or explicitly requested operation.
2. Executing at least one requested operation.
3. Returning the result 301.

It is to be noted that the steps in the procedure may be also swapped during implementation or may be partially realized through combinations. For instance, it may be useful to first determine the basic dimensions that must be processed in the request 302 and compile the sample space on which only other operations are applied. [0204] Optimized implementation for different applications: It is to be noted that in several cases it is useful to use other optimized methods for certain applications for instance, while streaming access to a dimension. In doing so, it is useful to use ready components, whose operations are determined. Thus the above mentioned step 1 may be omitted in many types of models. Furthermore, it is also possible that a result 301 may not be always redelivered. Here, it is also possible that access documents 302 that do not require any result 301, omit step 3.

Access interpreter 303: A sample access interpreter 303 is illustrated in FIG. 16. This has at least one document analyzer (document evaluator) which provides means to analyze and execute operations based on access document 302. The specified operations are then executed by operation initiator. Thereby, the operation initiator may also use predefined operations. The operation initiator generates result 301 based on executed operations. Thus, through predefined operations, dimension data 304, database 305, detectors and/or other means of hyper adapter 300 may be used to generate results. Ideally, the access interpreter generates an implementation programme. In such case, the access interpreter 303 has means such as an implementation programming unit to optimize this programme.

At this point, it should be mentioned that if the contents of access document 302 may be directly conceptional, then they may be executed on the basis of its operations and the document analyzer is not required.

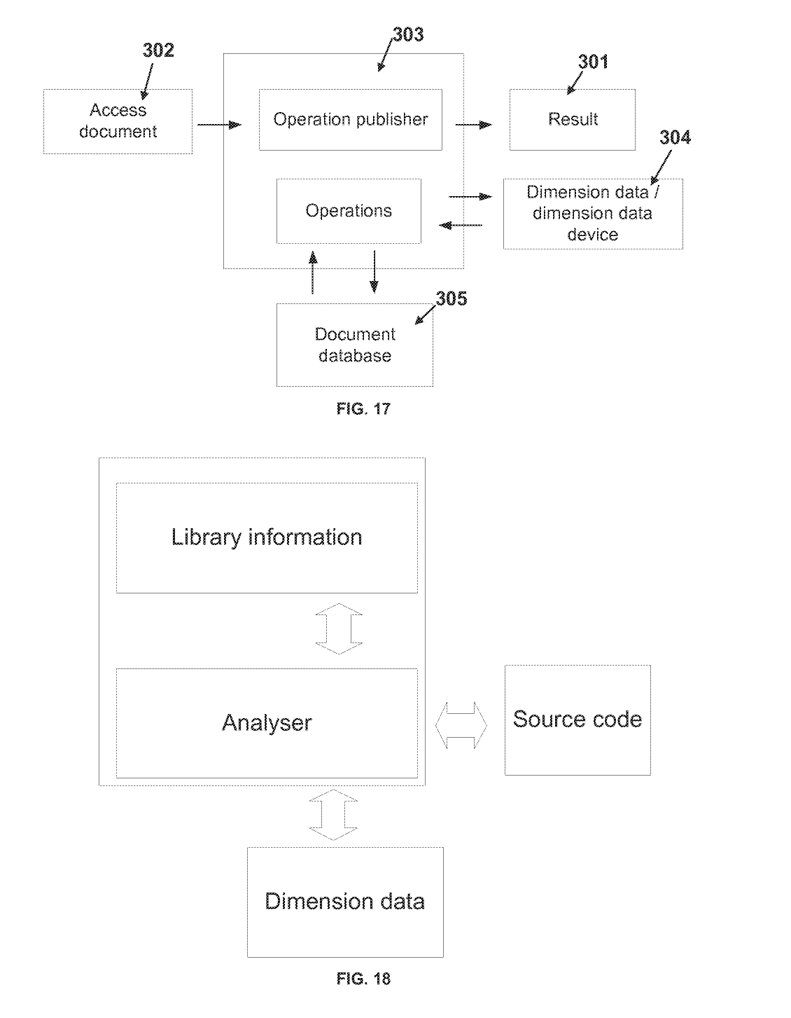

An alternative access interpreter 303 is illustrated in FIG. 17. This access translator 303 has at least one operation publisher which enables publishing operations or combinations of these. Furthermore, it can also publish saved requests. Publishing means that these operations can be directly addressed by clients. For instance, the operation for writing and/or reading in a certain dimension is published as virtual file. Thus it is possible to write and/or read it with a normal file stream in this dimension.

Combination of various access interpreters 303: It is particularly recommended that the above described model of access interpreter 303 be used in combination. Thus, operations and/or stored requests that should be published are determined through the first model (access interpreter with operations and/or stored requests). For instance, in access document 302, this access interpreter 303 may require access to a certain dimension 1 in a file. Thereby, it can be specified that this access should be provided as file stream. Thus for instance, publication of this dimension is arranged as file stream. The way to access this stream may be available in result 301.

Access interpreter for writing and/or modification of Dimension Data: An alternative access interpreter 303 also allow modification and/or generation of data in dimension data.

Document analyzer: The Document analyzer (refer FIG. 16) may also be implemented by one or several methods and/or devices used in compiling and/ or interpretation. Therefore, It is possible to use all techniques such as AST (abstract syntax tree), bytecode interpreter, Lexer, Parser, Jitter, incremental compilation, tokens and other known techniques. It is also possible to use the findings from development of search engines. The findings from field of linguistics and expert systems may also be used to convert access document 302 in an “executable” form. Furthermore, the findings from development of SQL compilers may also be used. The task of the document analyzer is parse the access document 302 in accordance with the yet to be executed actions and generate a list of operations. It is particularly recommended to use a hybrid method within the scope of this invention by which the executed operations are made available in complied form.

If new operations are added, it is also possible that these are compiled within the scope of this invention to enable increase in execution period with further requests. Furthermore, the document analyzer may also contain a Cross Compiler and/or transformer to translate other constructs existing in the access document 302 to a language understood by the Hyper adapter 300.

Query by example: The specialization of document analyzer may also be assessed in access documents 302, for instance. The dimension of citation should be delivered back as a result. An example of citation is given in the access document 302. Such a document analyzer may determine which dimensions were required in the example by means of detectors. Another example of one such “Query by example would” could be images, videos, language, melodies and/or music. They can also be linked. For instance, the first image may illustrate an object, the second image a hand which signifies the hyper adapter that the dimensions of the next image must be excluded and another image with excluded dimensions. Consequently, the search is executed through graphical example and/or logic. As an alternative to the logic, the image of a hand as well as image of objects such as scissors may be used. A number of other examples are possible in this context. Therefore, the hyper adapter has specialized means for such cases of application. These special means may also be used for specially optimized techniques, chips, for example, use GPUs and/or methods. Such a visual language may also be defined by the user and/or can be trained. The visual language may also be created or generated by the user himself. It is also possible to practice the interpretation of such visual language by one or several users by using means specialized for this application, such as artificial intelligence. Likewise, such examples may be converted with music, language and/or videos.

Document analyzer for MDX: Another model of document analyzer supports MDX. In doing so, the known findings from an implementation are ideally used to create such an interpreter or compiler.

Document analyzer for language: A special type of document analyzer which is preferably used for search engines is an analyzer that understands human speech. The dimension metadata may be used to determine which dimensions are required in the access document 302.

Operation initiator: The operation initiator is responsible to execute requested operations and generate result 301. It is specially recommended that operation initiator support all operations or expressions in each combinations described therein.

An upgraded version of the operation initiator may execute existing operations in access document 302. This may be present in all possible programming languages. Operation initiator run in Access document 302 existing operations. Another specialization of operation initiator may save an interim copy of the results of individual operations. This may assist in boosting other operations.

### Detectors

The following text explains recommended detectors that may be a part of hyper adapter 300 or are alternatively provided as external detectors whose outputs is used by the hyper adapter 300.

Adaptive detector: An adaptive detector is thereby identified as those may adapt their dimension identification via assessment. For instance, such detector may convert a neural network.

External information detector: Such a detector enables disclosing dimensions using external data. For instance, a website may use Google Page rank through such detector.

Task Detector: The function affiliation may be determined by this detector for documents or fragments. For instance, how high is the “degree of interest” of a document for different functions, if Mylyn Tasks were used as database for documents. Or different contents of a function may be apprehended as description, time frame and/or other meta-information.

XML detector: An XML detector identifies dimensions in XML document. For instance, various namespaces (namespaces) may be usually present in a XML document. Due to this, the elements from different namespaces can be assigned dimensions. Furthermore, XML documents usually have XML schemas, whose importance is known in normal cases. Thus more dimensions can be detected. Furthermore, such a detector enables determining dimensions through XPATH concepts.

Human detector: An alternative to detectors which identify the dimensions on the basis of machines or computer program products are detectors executed by humans. For instance, a human may identify a region in document and assign a dimension to it. Thereby, these detectors may be operated by several people. Thus, for instance, how many people have assigned a certain dimension to a region can be determined. This detector may also be implemented at client's end and it will report the dimensions detected by people to hyper adapter 300. The Plugin Technology, Javascript, Silverlight, Flash and/or other technologies may assist in implementation.

Regexp detector: A Regexp detector can detect dimensions on the basis of regular expressions (“regular expressions”). Thus, this detector allows regular expressions to be saved with a dimension assignment in it. This enables a quick and easy adjustment by the user.

Property File Detector: Files usually contain meta information such as size, name, type, version, directory, rating, tags, etc. Furthermore, these may also contain images, such as Exif data, which include Geopositions. This detector realizes different data or parts thereof as dimensions.

The following detectors are particularly beneficial in the field of software development. Due to varied contents, all detectors introduced in this document may be used for software development.

Concernmapper dimension detector: Through Concernmapper Tool it is possible to assign Concerns to separate fragments during Software Development (see above). A detector can identify this information so that these dimensions may be processed together with the dimensions that have been identified by other detectors.

Hardware command access identification based on compiled code: hardware access detectors are used to determine at which points a program accesses the special functions of hardware. For instance, this may be the execution of one or several functions of a microchip. Such as executing MMX commands as PMADDWD. Thereby this will search the compiled code by parsing in accordance with a specific command. Then it is determined which source code files will generate this command at which points. This allocation is performed by allocation rules. A simple mapping of complied file name to the name of source code file may also be considered as an allocation rule for instance. Another option is using compiler features.

Access detectors based on library use: Another option to reveal information via source code is utilizing knowledge from libraries. Thereby the detector uses library information to disclose fragments that use library. The classes or names of interfaces and associated dimensions may be determined in the library information. Thereby, the dimensions of derived classes or interfaces can be determined. Or it is possible to view how often a fragment accesses a fragment from library or elements derived thereof.

Due to the fact that derived classes also inherit the dimension of parent class which may be added by the analyzer while detecting library details. For instance, by adding a class implemented by an interface. This is because, the users of the library are indirectly using the class. One such library information detector is illustrated in FIG. 18. Thereby the analyzer is a part of the detector which utilizes the library information and/or adds and executes the identification algorithm.

Alternatively, the library identifies may also write in dimension data and/or use information thereof via derived classes. For example, another detector may have been assigned a class of a dimension which is derived from a library. In this case, the detector may use this information.

Even the utilization of external hardware can be determined with such detectors. For instance, network access is not usually programmed manually, but libraries are used for it. For instance, WinPcap library in case of Windows operating system. Thus it would be possible to technically detect at which places a program access the network. These places would then be located in the Network dimension. Another example would be to access the camera of a mobile phone or a webcam of a computer. Since these functions are provided through a library, it would also be possible to determine which software fragments access the camera. Another example would be the access to Print function. Usually this is also programmed through libraries.

Often the access a sensor is programmed via using library. For instance, Win32_TemperatureProbe (sensor) class is provided with Windows which enables reading the temperature of processor with regards to other functions. It is possible to determine where a sensor may be accessed by storing the command sequence in library data.

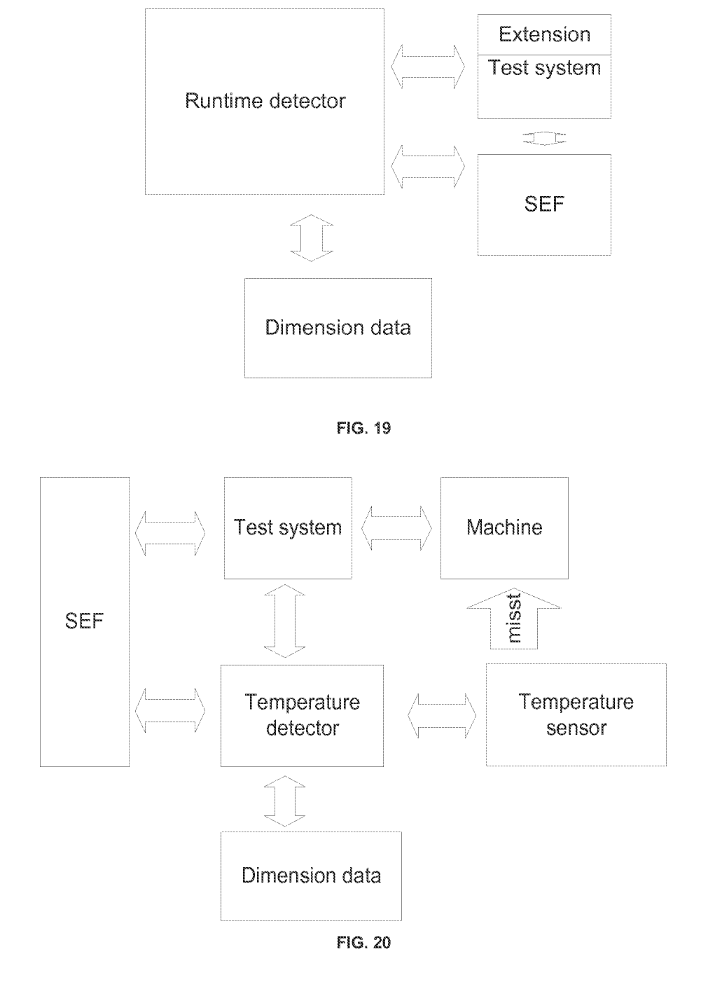

fragment execution period detector: This detector identifies the execution period dimension of software development fragments. FIG. 19 shows an example of this detector. It uses a test system to determine the execution period of software development fragments (SDF). Often the execution periods of individual functions, which fragments were executed in which period are not measured or stored in trial systems. In this case, the detector consists of the detector itself along with an upgradation of the trial system. This upgradation measures the execution period of individual features belonging to the trial system software. The detector may also be used with multiple trial systems. The reason behind this is that different trial systems may deliver different execution periods. For instance, a trial system may have a multi-core processor and only one single core processor. In this context, the data in this context could activate trial system, SDF, trial case and execution period. Thereby different trial systems could be considered as different dimensions.

Temperature detector: The temperature detector is similar to the execution period detector. It may also partially assist as extension to a trial system. The temperature detector examines the temperature of a system before executing a SDF, for instance in a trial. The temperature is measured again after execution. These data and associated modifications may also be considered as dimensions. In doing so, the associated modifications are computed as given below:

|(Temperature before−Temperature after)|/Basic temperature of the system=change delta

In another case, the temperature detector is the gauge of temperature modification in a machine or a technical device. Often machines are controlled by software and actions are performed there, such as moving a robot arm or controlling a memory system. The temperature change in a machine is measured by this detector when software fragments are executed.

FIG. 20 illustrates a diagram of how such a detector may be implemented. Here, a temperature detector is connected to a temperature sensor. The temperature detector measures the temperature of machine by this. Moreover, the temperature detector has a connection to the trial system that executes the software artefacts. Thereby, the temperature detector may determine which software fragments can be executed on the trial system. In this way, the difference in temperature before and after the execution of software artefacts is measured. This may then be assigned to the corresponding software artefacts. As before, the detector may also be implemented through an upgradation in trial system. A detector for measuring volume can also function in the same way as of the temperature detector describes above. Here, a sensor is used that measures the volume.

Power consumption Detector: A power consumption detector can also be provided like a temperature detector (see above). The current consumption and/or other power consumptions while executing SDF may be determined by a sensor on the trial system. Like earlier, the power of a machine may also be measured.

Another option would be to measure power before and after the execution of software fragments if the trial system has a battery. Then the power consumed by a function may be computed via

Current consumed−average current consumption=Energy of the function

As with execution period detector, the parameter of trial system serves as other dimensions with temperature and power detectors.

Repeated execution of temperature and/or power measurements: Often the power consumption or the course of temperature of software fragments is very less. Therefore, it may be useful in this context for repeated execution of such tests and obtain average.

Thus this power detector can also be used for other forms of energy for each type. For instance, this power detector can also measure fuel consumption. This could be executed and measured on microchips for code fragments such as control programs. Here the measurements can also be performed in combination with simulations. The vehicle is considered as an example of application which is controlled by numerous microchips, whose functions affect fuel consumption.

Other detectors may be imagined similar to energy, temperature, or runtime detector which use other physical parameters, for instance pressure and/or power.

Aspect detector: The aspect detector reveals which classes, functions or other SDF are affected. For this purpose, it analyzes source code, compiled code, uses another program and/or a hybrid method. For instance, in case of Aspect) may use XREF Tool as program.

Hardware exposed functions detector: Often in a program, input interfaces are also provided for a user or another machine. The detector can detect which parts could be directly addressed. For instance, a detector discloses which SDF is made available as web service over computer network through a WSDL file. Thus, these WSDL files may be examined and the associated functions are determined from the source code. Another example would be of functions that may be executed by a touchpad after pressing a virtual button. For instance, the surface for touchpad may be described by MS XAML. In this XAML file, it is determined which functions shall be triggered from the source code on the basis of pressing a button.

DSL detector: Often domain-specific languages shall be used in software development. Thereby, these languages represent aspects of a system. Since the importance of DSL is usually known, a detector may be provider which enables identification of dimensions in a model of a DSL. DSLs often interact with source code. For instance, they may be interpreted or source code is generated from them which interacts with the manually written source code (see above). The source code interacts with which DSLs can thus be determined. Thereby, a DSL can also be used as dimension, or may be considered as several dimensions depending on its content. Therefore, the interactions of source code with this DSL are interactions with this dimension. Often there are DSLs which interact with other DSLs. In such case, a DSL may take the position of source code.

Bean Detector: An example of a broadband detector is a Bean detector. There is an option in Spring Framework to provide classes as Beans. The specification of which class is available as Bean may be obtained from one or several XML files. Then the associated detector can evaluate details from this and identify which classes are available as a bean.

Spring Webflow Detector: Spring Webflow is another example of a DSL. This language allows specifying the flow of actions. In doing so, it refers Beans and functions performed by it. The associated detector can identify which classes, functions, and beans belong to this dimension. Here, the interaction between different detectors is to be observed. For instance, in this case it may be beneficial to use the results of Bean detectors to identify the relevant classes.

Annotation detector: Annotation is a special type of DSL. Annotations are identified as an internal DSL. Often structured meta-information from it is stored in the source code, for instance, the author of a software fragment. Or beans may also be defined. Various dimensions, spanned by annotations may also be determined by an annotation detector.

Persistency Detector: An example of additional detector is determining fragments belonging to persistence dimension of a software system. For instance, the fragments associated with persistence of a system are Persistence system related, are thereby determines as those derived from classes of a particular framework library or have certain annotations. Furthermore, it is also possible to specify the persistence classes through an XML file.

Author Detector: This detector identifies the author of a SDF, by an Author annotation, for instance. Ideally, this detector can identify the author in other systems on the basis of such information and thus generate links or disclose further details of the author. For example, the Personal Identification Number and/or corresponding cube in a Data Warehouse. Then this information may also be stored in the dimension data as link or reference to Data Warehouse, Cubes, and/or Personal Identification Number. If they are to be used during access, the Bridge of the Hyper adapter 300 may also use Cubes in Data Warehouse based on the stored information.

For example, if the information on which members belong to a team is present in an external system, then computations or requests may be executed on the basis of team. For instance, the number of errors from different teams may be compared. Here it should be noted that this function may also be transferred to other information.

Security Detector: Determining secured functions of a software system is another example. Which classes or functions are secured by definable parameters may often be determined by configuration files or annotations. In this way, the secured fragments and their parameters can be determined. A great advantage of this detector during interaction with other detectors is it determines which functions of a system can be accessed from outside. In doing so, it can be determined with a query which fragments are not secured and accessible from outside, for instance unsecured web services.

Transaction detector: Another detector is responsible to disclose transactions in the source code. Transactions are often defined by DSLs. The configuration files and/or annotations are often used. The detector identifies which SDF is a part of transaction.

Deprecated Consumer detector: The obsolete functions/classes are often characterized in an API or a Framework through annotations. This detector uses this information/annotations to disclose the dimension of use by deprecated functions.

Metric detector: The metrics are often used in software development. A metric detector assigns metrics to software fragments. Thereby, this detector may either compute the metrics itself or uses in which metrics are calculated and then allocates this as dimension of SDF.

Issue Tracking and Version Control Detector: The Issue Tracking and Version management systems is often used in the software development. This detector may use the information from such systems to determine the version of SDF, for instance. In addition to this, Issues are often linked with versions or concrete SDF. This may be disclosed and allocated by the detector. It is particularly recommended that this detector may also be used as a detector if a bridge is used on these systems to provide a consistent powerful functioning.

Error classes detector: The error classes may also be identified as dimension within the context of metrics. These error classes can thus be combined with other dimensions.

Test Case and Test Result Detector: This detector can identify the test cases are available for which SDF and finds their test results. In addition to this, it may execute tests or use a test framework or system. Another option is to use the results of a test system or framework. It is to be observed that Data Mining can be executed by combination of metrics and test cases in the dimension data, for instance in a multidimensional schema. Thereby the relationship between metrics and test results may be revealed. For instance, which metrics often lead to failed test cases.

Comment and comment content Detector: This detector can reveal which comments belong to a SDF. Thus for example, a request may be made to display all SDF whose comments contain specific words. Furthermore, this detector could be used to describe the dimensions of comments for adding to the dimension metadata.

Design Pattern Detector: The design patterns (Design Patterns) can be revealed. Through this knowledge, the query can be executed at which place in source code a certain design pattern, for instance.

Coding Conventions Detector: Often project guidelines are given with software development which determines how certain fragments are to be named. For instance, a Data Access Object must also contain the string “DAO” in its name. Such conventions make it possible to provide a detector that may disclose the dimensions of SDF on the basis of Coding conventions. It is to be noted that this detector is extremely useful in interaction with other detectors and queries. The libraries often used for programming. Thereby, new classes can be derived from libraries while programming classes. Thus, the Spring Framework provides classes that facilitate in programming DAOs. If derived from such a class, then the derived class is a DAO. In combination with a detector for Coding Conventions, the DAOs are identified and now a query may be created which examines where DAOs are available, but do not bear the Coding Convention sequence and contains the name DAO.

Bundle/components detector: A software system is often created by components, such as OSGi with bundles in case of Java. This detector identifies the information provided via the bundle information. Thereby it can be identified, which SDF belong to the individual components.

Platform Detector: This detector identifies the platform on which software is executable, for instance, through information in bundles. A bundle is executable under which Java version is determined in case of OSGI. Another approach to identify a platform can be made by analyzing the source code. For example, different platforms provide different APIs. Thus, based on the API functions used, the various parts of source code executable for various platforms can be determined.

Runtime detector: A runtime detector determines the dimensions in runtime behaviour of source code. For instance, this detector can determine which code is executed how many times when used by different users. This detector is mainly useful in evaluating analysis related to temperature development and /or energy consumption. For instance, the result of this detector combined with those of temperature detector may determine which fragments are particularly responsible for development of heat. Such as through the query given below: Which fragments are executed very often and have an increased change in temperature. This approach would be applied analogous to entities like energy consumption. Among other things, a vehicle may be introduced as an example of energy consumption. Thereby the frequency of code fragment executed on microchip is measured during driving by test personnel. Sub-dimensions may be type of driver, for instance “sports driver” and/or “normal driver”. These measurements can be used together with the power consumption detector. Thus, a particularly high power consuming source code, similar to the earlier query may be determined for this case also. In this context, the programs developed in accordance with “AUTOSAR” standard (see http://www.autosar.org/) may also be examined on energy consumption. Similarly, the hyper adapter can be used for other fields, for instance in aircrafts, ships or missiles.

Developer Interaction Detector: This detector records the interactions of the developer and allocates appropriate SDF, for example, how often a particular file has been viewed, or at which points the breakpoints were set.

Detectors in the field of Internet, intranet and/or the Desktop Search: Specialized detectors are provided for these fields. The detectors from code search and other detectors introduced herein can also be used on the basis of varied contents. The reason for this is that several documents may also be present in the Internet source code. If the hyper adapter is used as a search engine, it is particularly recommended that users of the search engine themselves create the detectors.

Detector for Micro-formats: This detector is used to identify microformats (see “Wikipedia Article Microformats” http://de.wikipedia.org/wiki/Mikroformate) and their content.

Detector for logical structures: Logical structures can be disclosed by this detector, captions for instance. These could be identified by the font size. Another example is identifying addresses.

Detector for structures: This detector may created from “big shapes” based on the high profile of content and their importance. Here the importance of structures is intended with big shapes. For instance, this structure could be a social network like MySpace. Thereby the importance of content is known from the profile pages of the members. Thus, a detector can be created for this structure. Furthermore, websites are often realized with the same software. This detector identifies the structure of various implementations and their data model. In this way, it can identify dimensions. Webshops are an example of this. Thus it identifies products and their properties such as price, manufacturer, etc. Same can identified on forums, web blogs, Twitter, Studivz, XING, Wordpress, OScommerce, CIAO and other software platforms used on the Internet.

Comment Detector: Web pages often contain comments from users. This detector can identify comments. In doing so, it may also compute other dimensions such as the number of comments.

Image content detector: This detector identifies content of images. This may done through artificial intelligence, other machine, system and/or computer program product. In the field of Internet, it is recommended to use the fact that users often tag people in images within a community (“tag”). Thus the image is tagged with who shall appear on it. Furthermore, users can often specify tags as description of the image. Thus, for example, the dimensions of tags and the image comments are detected. A particularly preferred version of this detector uses the results of one or several human detectors and in combination with this, decides the content of an image.

Field report detector: This detector enables identification of field reports and associated data. For example, a field report is available for which product. This detector is particularly helpful in combination with a product detector. For instance, the field reports may be assigned to the products in a multidimensional schema through this detector.

News detector: This detector identifies new messages and their content. For instance, article on the N-TV homepage. The preferred dimensions such as the date is identified. This enables searching a news query targeted at specific periods of time with specific content. It is specially recommended to process this detector in models as well as RSS or Atom feeds.

Link Detector: This detector identifies links on a webpage. For instance, it may identify the dimension in which a certain link is located. For example, to another page or an author profile. Thereby it can distinguish how a link has been established. For example, a “normal link” or a “trackback link”. This differentiation is very important, since more and more links will be automatically generated. Modern search engines use only the dimension of a normal link in their ranking, which leads to poor search results due to further development of the Internet. In addition, this detector may even compute other dimensions. For instance, the relationship between links and trackbacks. Or the number of links.

Detector Tags: This detector identifies the dimension of the tags. Tags are not represented differently in the conceptual model of the hyper adapter for specific content. Thus, dimensions may be assigned to tagged content. It is particularly preferred to disclose hierarchies in the tag itself using this detector. The detection of hierarchies may be, for example, as in “Collaborative OLAP with tag clouds”(http://arxiv.org/PS_cache/arxiv/pdf/0710/0710.2156v2.pdf). These hierarchies may assist in automatically creating new multi-dimensional schemes.

Using the Hyper adapter as a search engine for the Internet, intranet, expert search and/or searching other technical devices

The Hyper adapter 300 can be used as a search engine or an extension to a search engine. The dimensions can be identified and multi-dimensional schemes are assigned by it. Furthermore, dimensions which are not explicitly known, can also be detected by detectors. This implies new information for a search engine. Furthermore, with hyper adapter 300, there is an option to create complex queries as with a conventional search engine.

It is particularly preferred that a hyper adapter 300, used as a search engine or its extension have an interface that is compatible with currently used search engines. Here, it should be noted that this interface may assist in translating a conventional search query to a multidimensional query.

It is particular preferred that such an interface is provided that allows answering to queries in standard language. It can be determined from such queries by means of hyper adapter 300, which dimensions, crossover, sub-dimensions and/or schemes shall be determined by the standard language query. For example, this may done on the basis of probabilities, dimension metadata, dimension data 304 and/or data base 305.

It is particularly preferred that while using hyper adapter 300 as search engine, the schemata, dimension data 304 and/or memory device (s) specially optimized for this should be applied. These customized schemata may also be used in other fields, such as source code development while application of hyper adapter 300.

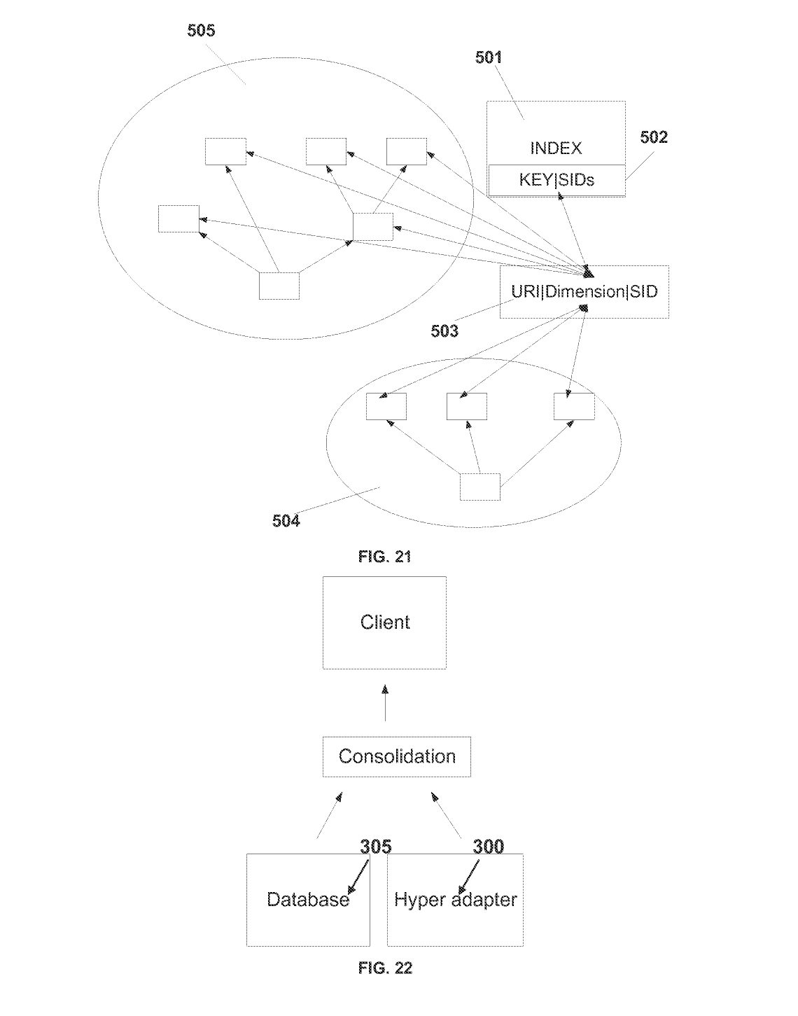

An example of such multi-dimensional schema is illustrated in FIG. 21. Here multidimensional schemas 504, 505 and index information 501, 503 are used to enter details in the dimensions. The substitute keys (SIDS) are used to save disk space and a separate index is not necessary for each dimension. SIDs assigns an identifier 503 along with a unique resource (URI) to a dimension. Thereby, resources may also contain several SIDs to allow a resource to be simultaneously available in several dimensions. Entries in index 502 refers to these SIDs. The SIDs classified into multidimensional schemas.

It is particularly recommended to use known findings, especially from the search engines and database development while structuring an index. Furthermore, a customized Patricia Tree, Tree, HAT Tree or Front Tree (refer “HAS Tree: A Cache-conscious Tree-based Data Structure for Strings”, http://Crpit.com/confpapers/CRPITV62Askitis.pdf) may be used as data structure. If more dimensions are used, for instance, which are not textual, such as images, videos, spatial data, or numbers, then a customized index is used for this. The schemata and the SID system contain special adjustments for such case. Moreover, specialized operations are provided for such cases, for example, a catchment area if geodata is found. In addition to this, it provides specialized operations, such as a proximity search, if found geodata.

Example for a search based on blog schemas: The above explanation is illustrated below on the basis of exemplary query. As mentioned above, a blog usually has a blog comment, assigned to an individual post. The search engine now receives a query with request to determine the blog posts which contain “xxx” in their text and “yyyy” in comments of the post. Thereby, firs of all the SIDs (Extension 1) are determined for text “xxx”. The SIDs (extension2) is determined for text “yyyy” at the same time or later. Alternatively, the SIDs which were not assigned to the corresponding dimension(s) are eliminated from both result (blog post comment or blog post). Then a schema of a blog is consulted. Based on the result, it is determined which blogspots apply to extension 1 and extension 2 (Ext. 3, Ext. 4). Thereby it is determined which blogspots exist in Ext. 3 and Ext. 4 (Ext. 5). In turn the blogspots may be cancelled in actual identifiers based on SIDs of Ext. 5 and the result 301 is returned. It is to be observed that before returning, it is possible that the result 301 may be transformed (see above).

Another use of search engine: Since Intranet and/or Internet are often implemented with same technology, then such a search engine can also be used in the Intranet.

Since nowadays a desktop search engine is not significantly differentiated from an internet search machine, it may also be used on the Desktop. It is preferred that a desktop search engine be combined with a search engine for the Internet. Due to this, a desktop search engine can also integrate the information from the Internet search engine into the query.

It is particularly preferred that a desktop search engine has specific detectors which are useful for this type of search. For instance, detectors that provide information about the file system of the computer such as the path of an object and/or detectors, which determine the contents of documents.

Likewise and/or in same way, this search engine realizes the above concepts of Desktop search and/or Internet search for mobile phones, PDAs, portable computers or other devices like computers and/or systems.

Expert Search: It is particularly preferred that this each engine be also used as an expert search engine. An expert search engine is a search engine for a specific field of knowledge, such as for travel, production material, exchange information, medical knowledge and methods of treatments, legal expertise or judgment, patent research, teaching materials search, image search, video search, music search, regional search, books or article search, online dating on the basis of interests, people search, source code search, blog search, auction search, car or motorcycle search engine, bicycle search engine and other applications. Furthermore, this search engine may also be used as meta search engine, in which the results from other search engines are determined as various dimensions.

Optimization: In case of search engine, it is particularly preferred other schema and/or operations optimized for this be supported.

Removing the search of a website: In an extended model, the search engine may also be used to outsource the search or search function or search system to a website. To this end, information from website operator may be stored in such a search engine, for instance the schema of page can be viewed. How the dimensions may be identified on the website is also stored. Alternatively, it can also be specified how schema is assigned to identified dimensions. In this context, the hyper adapter 300 may also have detectors, which enable direct access to the database of a website in order to save time while identifying dimensions.

Ranking: It is possible to implement complex ranking operations in this search engine through multi-dimensional schema. In doing so, the Ranking results of other search engine or known algorithms are also used. If ranking results are used by other search engines, they may also be determined as dimensions of different schema. This search engine may also receive information with a query 302 as to which ranking operations shall be used with the results. Most preferably, the search engine operations and/or ranking algorithms based on the user-generated contents make it possible to achieve better assessments than the currently used search engines. For instance, the number of comments may play a role in the evaluation of a website. Or it may be referred to who wrote an article and/or has commented. Furthermore, it is also possible to consider time factors while computing a series by means of the multi-dimensional schema. Through time factor in ranking, it may be accounted that unlike before, the new page may not contain so many comments. Or that too many pages may not be referred on the new page, unlike the existing page.

Dimension map of a website: The information may be stored on webpage with a particularly preferred model. For instance, this may contain data for detectors, how to identify dimensions on a webpage and/or how schema is viewed, which corresponds to the multidimensional structure of the website. It may also contain information on allocation of dimensions to schema. Furthermore, it is possible that pre-defined queries specified for a webpage or different internet websites may also be present in this information. This information may also be used by a Crawler, for instance.

Domain knowledge cubes: It is also possible that user of a search engine may himself create schema and/or allocate dimensions to it. Thus, for instance, a user is an expert in a specific domain and therefore identifies the multi-dimensional structures that are found there and creates multidimensional schema based on the hyper adapter 300. In doing so, it is also possible to store the queries defined by users. This could be used to develop new search engines by the users.

Operations that can be used for the Internet: It is particularly preferred that a hyper adapter search engine 300 provides one or several operations which is useful for a search. Thereby, the operations for a catchment search may also be present. Such operations may also be implemented in such a way that external services may be used. It is particularly preferred that other transformation operations are provided. For instance, such operations assist in preparing the result. Such as with image search. Often people are tagged in images. Who is tagged where in an image may be known from detectors and schema (example: through coordinates). While searching by image of a person, it is possible to cut the area in which the person is not viewed through transformation and deliver only that part of image in which the person is seen to result 301.

Advertising: The extension of hyper adapter search engine 300 enable saving advertisements with allocations of dimensions and schema in hyper adapter 300. This allows integrating an advertisement in a result 301. Another option is to classify advertisements on the basis of multidimensional schema. Thus advertisement may be found on the basis of queries. Hereby, it would also be possible to link queries of multidimensional schemes, in which advertisement is classified with dimensions, schema elements and/or queries 302.

Typewriter: The writing procedure may also be executed on such a hyper adapter search engine 300 based on an access 302. It is particularly recommended that the hyper adapter search engine 300 provides a REST interface for this which receives access documents. It is then decided through REST operations, whether they deal with reading, writing, delete, and/or modification processes. For instance, a dimension may be specified through multidimensional expressions which shall be written and addressed with REST operation PUT. It is to be noted that it is difficult to directly realize the write operation on the Internet and with such application, the Hyper adapter 300 particularly features other specialized means which allows such operations.

### Application: YourWeb

Basic Concept: The fundamental idea is to use the hyper adapter 300 in such a way that user can be tagged on the Internet Dimensions. Furthermore, the Hyper adapter 300 shall enable modification of content and/or addition of dimensions. For instance, the user may add one or several links to a website by hyper adapter 300, which means the website receives new links to other resources through the user. Or he can select a section of text and add a comment to this. As soon as the user revisits the page, he views the webpage with modified and enhanced content. The dimension of the user is used so that the Hyper adapter 300 operates dimension-oriented. The user receives the model of his internet. The Internet is thus a type of editable knowledge base similar to Wikipedia, in which he can perform modifications. The addresses may be selected, for instance. This may assign address to a dimension or even the dimension of country from where the address is derived. Or people may be tagged in images.

So far, it is possible to tag people in images within given communities. The information on images or even other content may be added anywhere by a hyper adapter 300. Another crucial differential factor for previously existing approaches is that the multidimensional operations of hyper adapter 300 may be used on the basis of generated information (for example: dimension sentinel). For instance, the hyper adapter search engine 300 mentioned earlier may be used. This fundamental concept is illustrated in FIG. 22. In doing so, a fusion is formed from the means and/or data of the Hyper Adapter 300 together with the data base 305, with which the client may work.

Dimension selections: the function to select dimensions in hyper adapter 300 may be realized by a human detector. Such a detector may include one or more components, which shall be executed on a client and collaborates with other components of the hyper adapter 300. These parts allow marking different dimensions on the client. Such selection of dimension may be done via tags/keywords. For instance, the user receives the option to enter dimension according to the part of document selected. Another option was to select the people or objects on images. Selecting people or objects on images and distribution via different systems may be done by already popular methods.

Multi-dimensional schema: The dimension identified due dimension selections can be classified under multidimensional schema in hyper adapter 300. It is possible that the user may specify, to which schema the identified dimension belongs. An alternative to this is to use other means provided by the hyper adapter 300, in combination or as an alternative for assigning schema to identified dimensions.

Selected dimensions: information on selected dimensions can be used for multi-dimensional queries 302. For instance, the search engine illustrated in the above application of “Use as search engine for the Internet, Intranet, expert search, or searching on other technical devices”. Thus, it is possible that the user selects dimensions and these may be specially handled while using the results of search engine with dimensions, selected by him. With manually selected dimensions, it is possible to determine how many people can select a dimension. The percentage of affiliation can be computed by the number of people who are considered as affiliated to a fragment of dimension. Yet more factors can be incorporated in this percentage of affiliation. For instance, how often a person who selects a dimension coincides with others. Thus, the dimensions selected by certain people can be incorporated into the calculation. The computed number of affiliations can also be used as a fuzzy specification.

Adding and/or modifying data in dimensions: Writing and/or modify data in dimensions can be done via a dimension writing function of the Hyper adapter 300. For instance, the user can add additional text. This implies that he writes in the dimension of webpage at a specific location.

Adding dimensions: It is possible to add dimensions to a document by means of hyper adapter 300. For instance, the dimension of a comment may be added. Or a user can store an existing text with a link to another website. It should be noted here that even other user who writes in the dimension, shall be considered as a dimension. This implies that, the dimension of website is written with the dimension of user. The same could be executed with other dimensions. For instance, the dimension of date may use a writing procedure.

Memory Usage: Ideally in hyper adapter 300, the existing memory and/or associated functions may be used for writing in dimensions. This can be used so that a user may modify data on a webpage and/or add dimensions. The owner of document in the database can retrieve this information and decide whether they should be borrowed. In addition, the information from this memory and/or dimension data 304 can be used in queries.

Enhancing data: The Hyper adapter 300 can also be used to enhance and/or modify the data from a database 305 by the client on the basis of dimension data 304 and/or data in memory. For instance, the addresses that are not initially characterized by a Micro format, but identified by detectors, may be annotated by appropriate enhancement processes in the client in that format. Or hyperlinks added by a user can be included. Another example is of the comments added by users, available to the clients of the user during a revisit to the webpage. The user determines what may be modified. With operations such as writing in dimensions, the user may determine who has access this information. Thereby the user may also provide his data to other users. One such function can be realized through the security system of the Hyper adapter 300.

Technique: The following technologies can be used as a technique for implementing this version of the hyper adapter 300: Java, Javascript, Javascript embedded through link to a URL, Flash,. Net, Silverlight, normal plugin, for example in C++, and/or from other known sources. Here they may also be used in combination.

Applicability in other fields of application: The example presented here may also be applied to other fields in which the hyper adapter 300 is used.

### Using the Hyper Adapter for Grass Root Tagging Sorting/Routing

Another field of using the hyper adapter 300 is combining the mass intelligence. For instance, the information such as news messages (news) can be “‘routed” to the interested users.

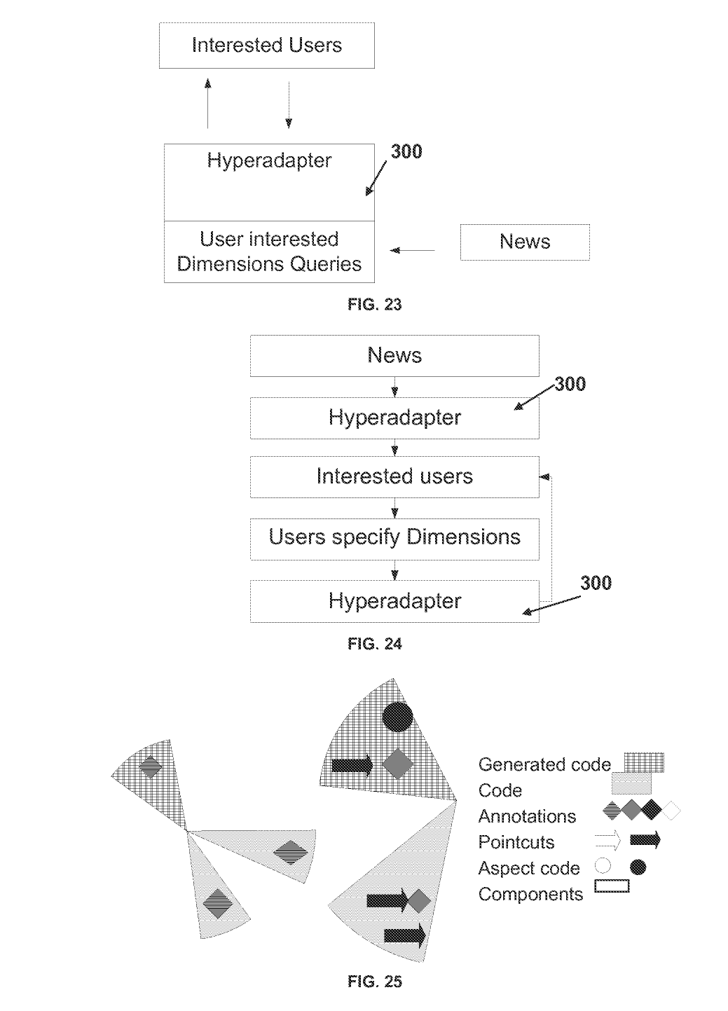

FIG. 23 illustrates an example on this. Users have stored one or more queries 302 in the Hyper adapter 300 regarding in which dimension or dimensions they are interested. The Hyper adapter 300 sends a news message to itself and/or detects it, for example by means of crawler. In doing so, the Hyper adapter 300 may discover yet more dimensions of the message and/or may only classify it as “News message”.

Based on the stored query, it is determined which user is interested in the news message. The message is delivered to these users. Here it may be delivering Push Messages or those requested (Pull) by the user, for instance on the mobile and/or computer of the user. Popular means such as E-mail, SMS or other means described here (for instance: Output channels) are used. Here exists a possibility that with query 302, the user can provide on which output channel he wished to receive the result 301 of his query. Thereby the user can read the news report and assign dimensions to it. This allocation may be reported back to the hyper adapter 300. Due to the new dimensions it is possible that new users may also receive the news report. This in turn may lead to discovering new dimensions such that news report is classified bit by bit and distributed.

FIG. 24 illustrates the appropriate procedure for this. An example is depicted on how detectors (for example: human detectors) may contribute towards classification using this method and how different output channels can be used.

Another option resulting from this method is that a generic appraisal can be generated on the basis of how many people select a dimension. This can be used so that the user can specify in his storied query how many users have identified a dimensions or how high must be the fuzzy specification of a dimension, for instance, the news report must be assigned 80% of dimension 1 before it is delivered or a news report must be assigned by 250 persons to dimension 1 before it is delivered. It is also possible to frame complex conditions through other means of hyper adapter 300.

The detectors or inference rules may also be used in this context. For instance, the detectors may discover new dimensions on the basis of identified dimensions. Or the inference rules exist as detector, if enough users view a news report a dimension as belonging to other dimensions as well.

In this application, it is possible to use other features of the hyper adapter 300. For example, users may modify and or add a comment to the news report. As a result, the queries 302 stored in hyper adapter 300, which would receive modified news reports from a certain user and thereby the modified news report is routed further.

In this context, it is also possible to identify the probability value of dimension affiliation by people on the basis of identified dimensions, such as if something is in dimension 3, then 80% of it is also is Dimension 4. This could be used to improve detectors and/or for training.

Use this method to create multidimensional schemas: This method can also be used to identify sub-dimensions. For instance, the user receives news report for specific dimensions. Based on this, new dimensions are added to news report. The new user receives news report on the basis of these dimensions and in turn adds new dimensions to it.

This could be used to consider new dimensions discovered by users as sub-dimensions to their query. Thus, multi-dimensional schema is generated. Furthermore, this data can be analyzed which considered yet other factors. Then schema can be generated on the basis of these analyses.

Actions based on queries: Other actions can be triggered in hyper adapter 300 on the basis of stored queries 302, for instance, executing external programs. A query stored with action can reveal if the “Terrorism” Dimension was assigned to a news report, a program or system was requested which sells all the shares.

Applicability to other fields of application: The example presented here can also be transferred and extended to other fields as News. For instance, also to newly created web pages, images, videos, source code and/or any other information that can be processed by computer. An extension would be to modify the queries of user, depending on which dimensions were selected/identified by him and how he evaluates the information. For instance, user videos may be assigned by their viewing dimensions. After a video has been fully viewed by a user or is interrupted, then a new video is provided to him based on the dimensions he specified while viewing, his personal preferences, his history, the data of other users and /or on the basis of whether the video was fully viewed. For instance, if the user has interrupted the video, then it can be assumed that various dimensions do no interest him anymore and a new video is randomly selected, preferably combined with the personal preferences and/or data of other users. If this video is fully viewed, then a video with similar dimensions is determined. Thus, a kind of interactive television program can be created by the Hyper adapter 300, whose contents can be accurately specified and viewed in the content visible only to the user.

### Using the Hyper Adapter for Source Code Development

It is particularly preferred that the hyper adapter 300 be used for software development. It is apparent that can be used for all programming languages, for example Java, AspectJ, JRuby, Groovy, Visual Basic, C#, ABAP, C++, Python, PHP, Javascript, etc. The hyper adapter 300 can also be basically used in software development with domain-specific languages. The Hyper adapter 300 may be in software development for various fields, for instance, in software development for mobile phones and/or other portable microprocessor-controlled devices such as Notebook. It is particularly useful for measuring the energy consumption and heat development (see above). This investigation of energy consumption can be further used in automation technology. For instance, here it can be determined how much energy is consumed by a controller while executed frequently performed actions. The automobile industry is another field of application for the Hyper adapter 300. For instance, currently cars have microprocessors that control various functions. The basic conditions generated by software while execution in a car can be measured by detectors specially optimized for it. Thus, it would be possible to search the software in Hyper adapter 300 under completely new aspect. The software development of business applications is another example, for which the Hyper adapter 300 can be used. Through hyper adapter 300, it can be checked whether all functions accessible from outside are secured. For instance, the queries that may executed by a Hyper Adapter.

The skills and queries resulting from the functions of hyper adapter 300 with respect to documents and/or SDF are explained below. It is particularly preferred that the Hyper Adapter feature optimizations to allow more efficient processing of queries than exhibited in the following simplified explanations.

Computing a modularity index: A modularity index can be computed by the measured number of dimensions of a document and/or a SDF and the ratio to the total, such as the dimensions in a Dice. For instance, the entire software system can be Dice. It is also possible to measure the modularity of a software system. For example, the modularity of all classes and interfaces can be calculated. This index of all classes could be added and divided by the number of classes and interfaces. Thus this mean value indicates how modular a software system in section is.

How high is the quality of the classes that access are the camera of mobile phone? The detectors can reveal the SDF, which access camera for example, while using library. In addition to this, all classes can also be determined. Now a set union from the classes and accesses can be formed. The quality can be known via metrics and assigned SDF. Thus, all metrics for the corresponding SDF may be computed and an average be formed.

Which SDF, refereed by several others have errors? The dimension, how frequently SDF is referred can be determined by a metric. When the frequency corresponds to “many” can be determined through Fuzzy Logic. The faulty SDF can be determined by test results and a set union can be formed from these two results.

Set unions of search results: This is simple because in Hyper 300 different searches are linked to their results via set operations.

Which fragments are most responsible for development of temperature with average users? The SDF for temperature development, which cause particularly high changes on the temperature can be determined by the detector. The number of hits and a sequence of requested SDF can be determined by the runtime detector. By computing the number of hits*change in temperature, an estimate value for accountability of temperature development can be obtained. This may be used as sequence for development of temperature. With Fuzzy Logic, it can be determined from when the value is “highly accountable”. The same procedure would apply for a machine to calculate the development of temperature.

Energy consumption: The examples described earlier can be analogously used if temperature is replaces by current temperature and/or energy consumption. It should be noted here that yet more factors can be added through multidimensionality for such calculations. For example, the processors usually differ with energy consumption. This should be taken into consideration while calculating.

Does a program use a computer network? It can be determined through detectors for network libraries whether certain functions which activate access are requested.

Which author wrote the source code that is used by most of the other components? All SDF derived from various authors can be determined by Author Detector. The components can be identified on the basis of components detector. Thus, the code of each author is checked on the request of various components. This can be done through run time and/or known by detectors and/or metrics. A ranking of authors is produced on the basis of number and the one with the highest rank would be the result 301.

How has a metric developed against another over a certain period? Since the metrics may be linked with version dimension through hyper adapter 300, it is easy to execute such analysis.

Which other source code fragments are indirectly affected by errors (requesting the faulty source code fragments)? The faulty SDF can be identified through test results. These dimensions can be used as feed for further analysis, which identify requested SDF.

Identifying the indirectly affected source code of an aspect, if the test fails. The defective aspects can be identified through tests. The SDF affected by Advices can be identified through Aspect Detector.

What part of a program is accessible via a web server? These dimensions can be identified on the basis of library, Framework and/ or components detectors.

What part of a program is accessible via a web server and written by author XY? Like before, a set union is formed with a certain author but on the basis of result set.

Which part of a program uses obsolete libraries? The obsolete libraries can be identified based on this and the initiator can be determined.

How much code of a program depends on library XY? This can be calculated by first determining the number of source code lines which use the parts of the library. The entire program can now apply these two specifications based on the metric of source code lines. It is to be noted that further information if required for such computations to incorporate a significant value.

Which SDF belong to a component? The associated SDF can be determined through components detectors.

A class named xx, which occurs in a function called YYY: This can be determined from the dimension of classes named xx with the dimension of the functions, that the name YYY is removed.

Set unions of function content: All the conceivable complex set unions can be formed by multi-dimensional operations and/or by Fuzzy Logic.

Blog of an author whose location is situated within a radius of 100 Km from Stuttgart: All authors of blogs can e determined on the basis of blog schemas. Which author lives less than 100 Km from the city of Stuttgart can be determined from “Location” dimension. The blogs can also be determined from these authors.

Product dealer who sells Product XY within 10 Km radius of Stuttgart, which is only 10% more expensive than the cheapest web offer: The first part is determined as before and delivers Ext. 1. The most favourable price of the product is determined on the basis of query, to which 10% added (Ext. 2). The result set Ext.1 may be cut with the dealers who sell this product at less or expensive than Ext. 2 on the basis of a Schema.

Images on which the person XXX and person YYY can be viewed: On the basis of detectors and/or tags, all images of person XXX can be determined. This result set is cut with the result set of images, on which Person YYY is identified.

This allows can application of queries like: all pages linked by 2 different websites” and all blog posts marked by Tag 1 and Tag 2,”.

Person Tim Frey, whose neighbour is Person xy: Determines the addresses of all persons named Tim Frey. Based on the result set, all neighbours of all Tim Freys bear the names xy. By an association of both results, all Tim Freys are identified with Neighbours xy.

All videos of Author XY which contain the comment XXXXX: Determines all the videos of author XY. Checks the comments of all the videos in result set for XXXXX.

Data Mining: All relationships described in the schema and/or identified by the detectors can be searched by Data Mining on the basis of multi-dimensional schema. For instance: task-associated elements of various tasks and/or aspects and/or the number of bugs in a system.

### Example of Using a Hyper Adapter in an IDE for Software Development

Each of the operations of Hyper adapter 300 are illustrated below based on the examples of software system explained above. Thereby often the term “consider” is used. In this context, consider has the same meaning as “chosen” or “selected”. The expression “consider” was selected in relation to the prototype presented later the result 301 was filtered in it.

Slice: The Slice operation allows considering a software system by only one point of view. Only the other artefacts which are directly linked to this dimension are considered. This is illustrated in FIG. 25. The first (left in FIG. 25) section of a software system shows a slice for a specific annotation. The downsized code view shall display that only the code is viewed with this annotation. The second (right) section was filtered on a particular aspect. Only the source code and source code on which the Pointcuts of the aspect apply, is displayed. Since Pointcuts can also be defined through annotations, the used annotation is also available.

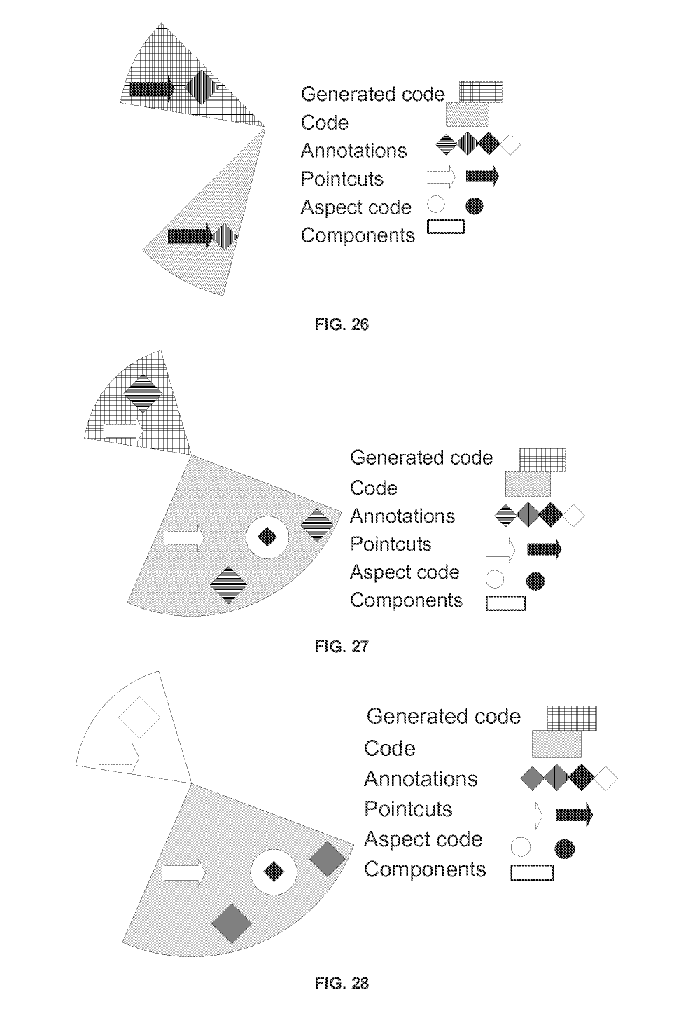

Slice is linked to another slice through a hyper and: The linking of two Slices through an AND is illustrated in FIG. 26. AND is a logical AND operator. Thus, artefacts which belong to two different dimensions are determined. A hyper and can thus be used to combine slices. This helps in accurate specification a Slice. The source code which is in two different dimensions is considered. In this example, the source code contain a Pointcut and a special annotation.

Dice: Dice is the combination of several slices. This means that the software system can be viewed from various perspectives at the same time. Such a Dice of the system is illustrated in FIG. 27. Only the code applied with aspect (shown in FIG. 27 by the circle with rhombus) and annotation (rhombus) is viewed.

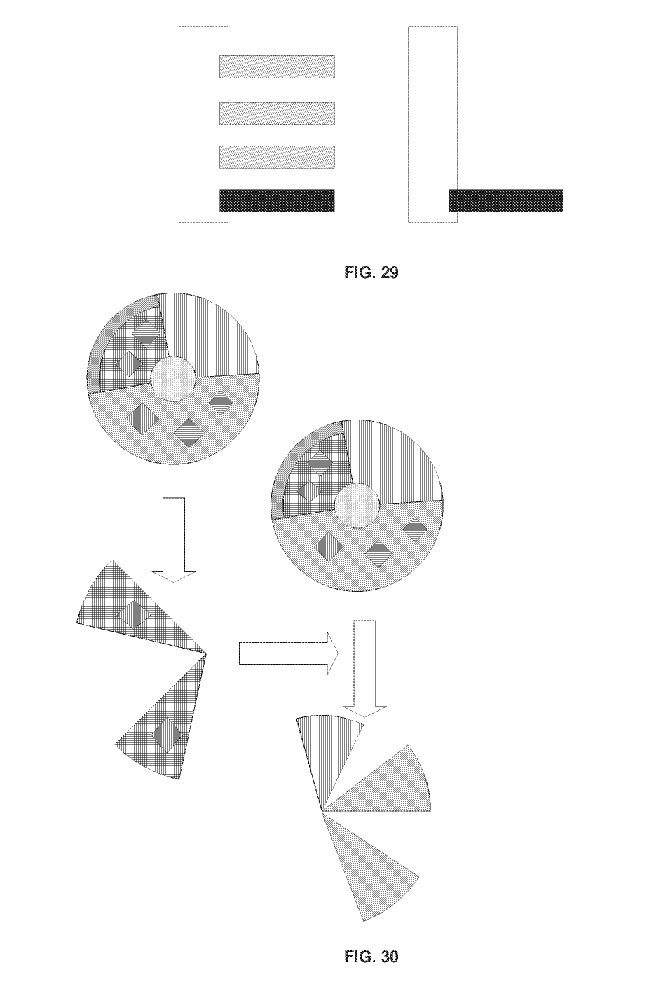

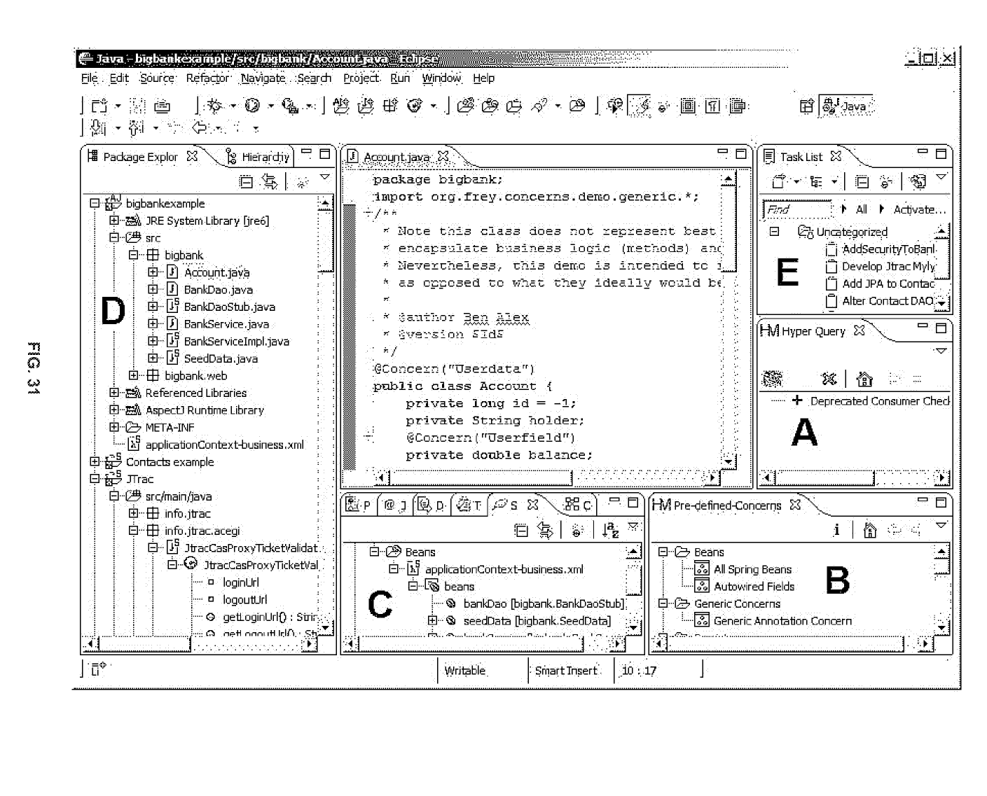

Hypercut: A Hypercut is an operation to intentionally exclude a dimension. For instance, a complete system and can be viewed and only the “Persistence” dimension is excluded. FIG. 28 illustrates such section, on which Dice was presented earlier (refer FIG. 27). The dimension of generated code is excluded (see the white portion the upper left of FIG. 28). Nothing else used I it is viewed. A Hyper cut can also be used to allow better clarity if a Dice is too large.

Yet more operations can be created through Hyper cut: The following example is related to a system with a Service Layer. An abstract diagram is shown in FIG. 29. This Service Layer is represented by the two vertical surfaces and the methods which make it available through the light and dark horizontal areas. The dark plotted methods are unsecured; those sketched in light are secured. On left is the system without Hyper cut, with hyper cut is illustrated on the right.

Now it must be determined, which methods are available in the Service Layer. A Hyper Slice is formed for this purpose. Then it shall be analyzed which methods are not secured. All secured methods can be determined through a Hyper cut. In this way, the insecure methods can immediately be found.

Recursive operations: An example of “recursive query” is using one or several result sets of an operation for another operation. Thereby this result set assists as a dimension. For instance, the user of result set can be determined. An example for better understanding: All the users of obsolete, with “@Deprecated” identified/annotated elements can be determined. Thus primarily all outdated elements are determined. In doing so, the final result set of each artefact is that which uses elements identified as obsolete. This is graphically illustrated in FIG. 30. A Hyper cascade is a synonym for a recursive operation that is used in the Hyper adapter 300.

Use on models and their hierarchies: So far, only cases with source code were displayed. However, the hyper adapter 300 can also be applied to models and/or DSLs. Even if the model accesses other model. For example: The Spring framework may be specified by a DSL Spring beans. Here it is specified which Java Classes are available as Bean. Spring Webflow defines the data flow. Thereby it is specified, which functions can be requested from a Spring Bean. For example:
Model A is definition of a set of Spring Beans: A1, A2, A3. Whereby, the associated classes are A1 (C1), A2 (C2), A3 (C3). Each class has the function F. Model B is definition of a flow, which accesses Function F of A2. A is primarily treated as source code. Thereby, the corresponding Bean (A2) may be identified. The corresponding classes can be identified after this procedure.

### Prototypical Implementation

A preliminary model is described below in which a hyper adapter 300 is used in a graphical development environment (IDE). This example is implemented in the Eclipse IDE. It can also be implemented in this or other extensive implementations, for example even in other IDEs like Visual Studio, Netbeans or other IDEs. Only a few detectors are used due to prototypical implementation and a few selected from the earlier described functions are shown. Furthermore, only a multidimensional schema exist which was implemented as imperative construct in the application source code. The presentation of result 301 is supported by filter. The selected dimensions are named as “Concerns” in the prototype.

The prototype consists of two new Views for the Eclipse IDE. See a screen shot in FIG. 31 (“Hyper Modelling Plugin Views”). This provides a view (refer section “A” in FIG. 31) of query designer. This represents a conversion of access document creator, with which access document 302 can be generated. This prototype only supports access to the data queries. Therefore, in further process only the query document 302 is alluded and does not refers access document 302 any longer. All elements determined by the hyper adapter 300 should be moved in this View (A) by drag-and-drop (DND). This can be done after creating a query 302 (see Flash icon in “A” section of FIG. 31). As a result, the hyper adapter 300 internally computes the result set.

After the execution, it is possible to filter the Package Explorer according to the result. The View “A” allows this to activate a filter for the result set of a query 302 (coloured icon in FIG. 31). Since the prototype does not have any more illustrations of result 301, the filtered elements are to be considered on the basis of result in the figures explained below.

The second View “B” (see FIG. 31) is used to provide dimensions. These are divided into categories. If a category is moved, then all the dimensions contained in it are to be added to query 302. This category can thus be considered as top dimension for different sub-dimensions. The other Views “C”, “D” and “E” assist in adding further dimensions to the query 302. Various elements of these Views may be added to query 302 by drag-and-drop.

View “C” depicts Spring Explorer that displays the Spring Beans. Spring Beans are individual Java Classes that follow a component model. Detailed information can be found in “Spring Framework Documentation” (http://www.springsource.org/documentation). View “D” illustrates a view in which various types of Java elements such as, packages, classes and/or aspects are displayed. View “E” displays the task content of a Mylyn Plugin. Mylyn makes it possible to define tasks and determines an interest assessment for the elements.

All individual dimensions that were added to query 302 can be transformed (Hyper cut) to a negated operation by a double click. In doing so, the corresponding Slice is excluded (see above). The elements in Hypercut Mode are identified by a Minus in the graphical interface. The prototype supports dimensions from different areas that may be tracked and selected with a query 302: Different annotations, Spring Beans, naming conventions, Aspects, Java elements, Task content and Compiler specifications, Use of framework classes. The prototype allows detailed specification of individual dimensions by other parameters. For example, the parameter of an annotation. The reason behind this is that often Slices are determined on the basis of detailed information.

Internal functionality: The internal functionality of the prototype is that it does not has any dimension data but directly executed detectors on the data base 305 carries to identify dimensions. The access evaluator executes the detectors required in the query and calculates the result from it.

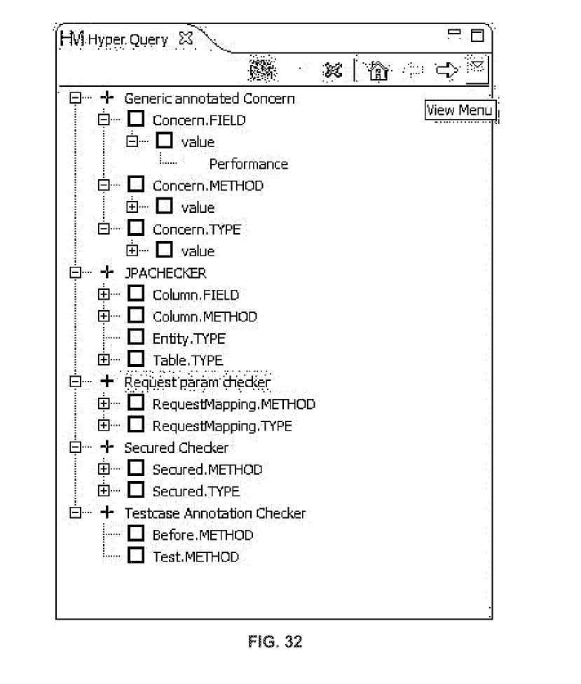

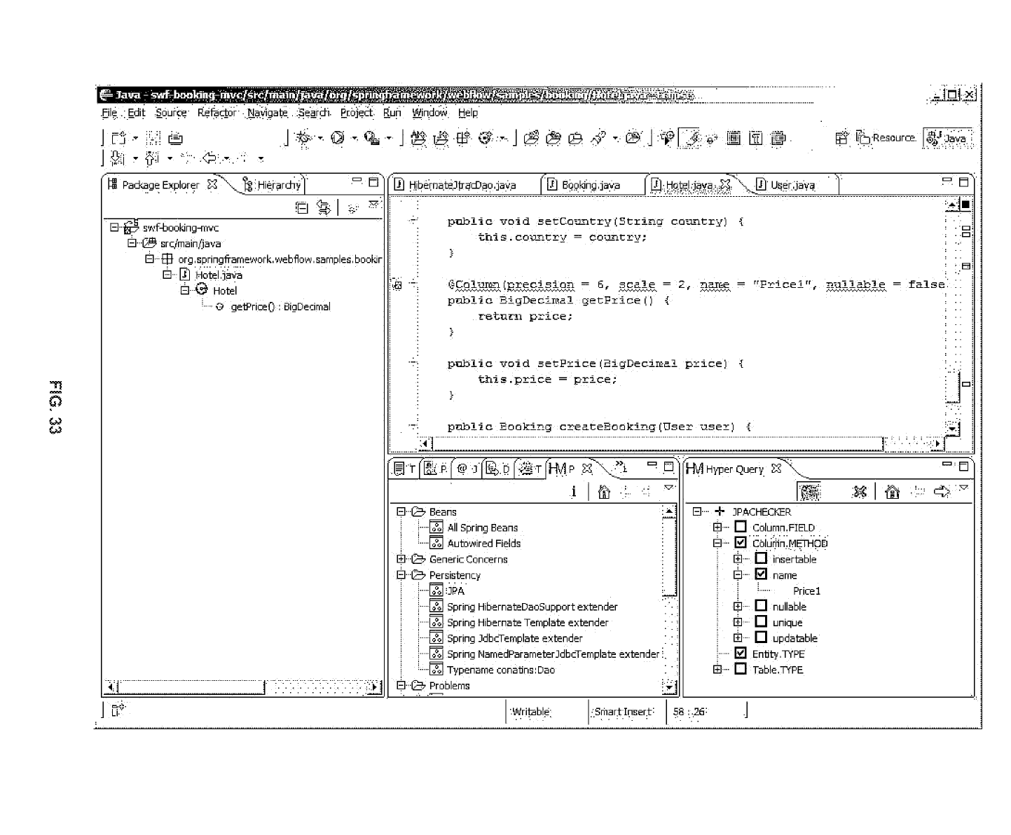

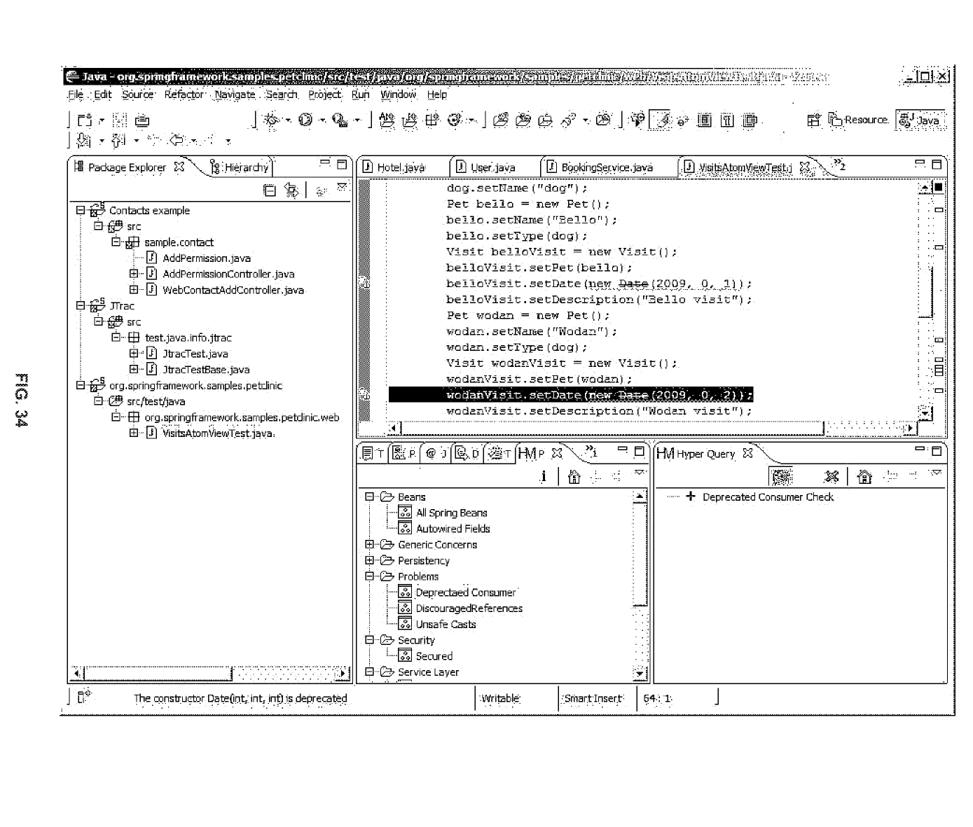

Demo projects in Screenshots: The demo projects are shown in the screenshots illustrated in FIG. 31-43. In order to understand this better, the demo project is described next: This project is an example of Spring Security. Here individual methods are secured by “@Secured” Annotation of Spring Security. The interface to Web is created in application so that the corresponding classes may implement Controller Interface of the Spring Framework. The Database serves as a Dummy Object in the application. The beans of this project can be conducted in XML files through a Bean configuration.

Contacts example: This project is another example of Spring Security. Here also the Beans are defined and used in an XML configuration file. The database can be accessed in this project via the derivation of Spring Frameworks from JdbcDaoSupport class. The interface to Web is also executed as before, by implementing the Controller Interfaces from Spring Framework.

JTrac: JTrac is a transformation of the famous Trac Issue Tracking System using the Spring Frameworks. The project is secured by Spring Security. The database access is programmed via Hibernate under HibernateDaoSupports of the Spring Framework. The persistent objects are mapped via a Hibernate Mapping File and not via JPA annotations.

Petclinic: The Petclinic is a famous example of the Spring project Framework. A series of different persistence technologies are used under Spring Templates. The ORM mapping is performed by a Mapping File. In this example, the individual beans are linked via the Spring Autowiring Mechanism. The interface to Web is conducted via a @Controller Annnotation and with @RequestMapping Annotations.

swf-booking-mvc: swf-booking-mvc is an example of the Spring Webflow project. The Controller is identified by annotations. The Persistence is implemented by JPA.

Spacewar Example: The Spacewar example is a game that is programmed in Aspect/J. The coordination of individual components is guaranteed by aspects.

Supported annotations: The annotations are divided in the prototype for a better selection in groups. The reason behind this is that various annotations together belong to a larger dimension. This is named as group in further procedure. The individual annotations associated to a group represent sub-dimensions. The annotations are linked with an AND in the group. This means that all annotations in a group must exist in order to identify a Slice. For example, the dimension of JPA supports several sub-dimensions such as @Table or @Entity.

Individual annotations may be activated and deactivated within a group by a checkbox. Likewise, a checkbox determines which parameters of an annotation shall be active. This can be seen in the example under Table 1 given below:

| Group | Description |
|---|---|
| JPA Annotations | The dimensions of Persistent objects is selected by |
| | this group |
| Secured | This group represents secured elements with @Secured |
| Request param | This group represents the dimensions made available |
| checker | via a source code function or classes on URL |
| Test | This group represents the dimension of test cases, |
| | marked with annotations |
| Autowired Fields | This group represents the dimension of field which |
| | is automatically linked. |

An example of a query 302 is illustrated in FIG. 33 (“Hyper query with JPA annotations”). The query 302 is executed in accordance with fragments which are identified by JPA Annotations. Thereby, the class must be an entity and a column of the entity must be named “Price!”

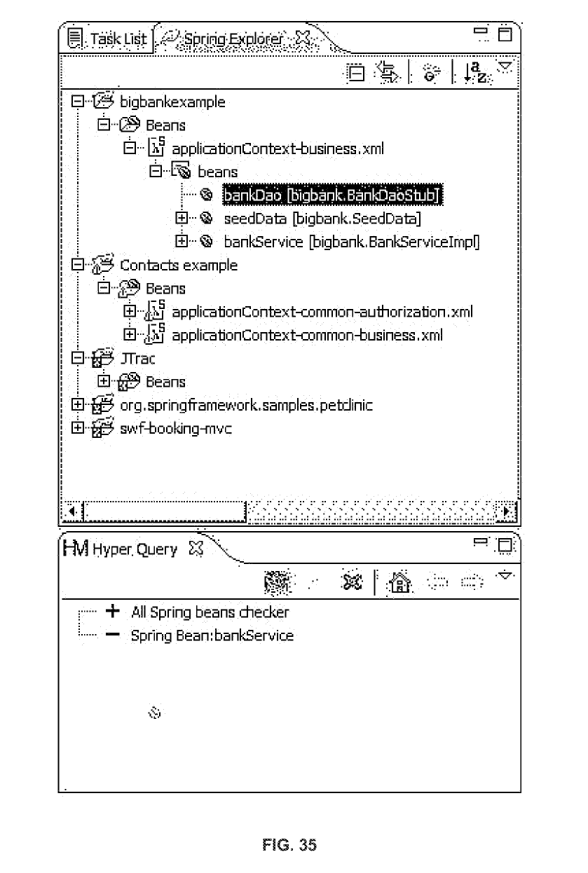

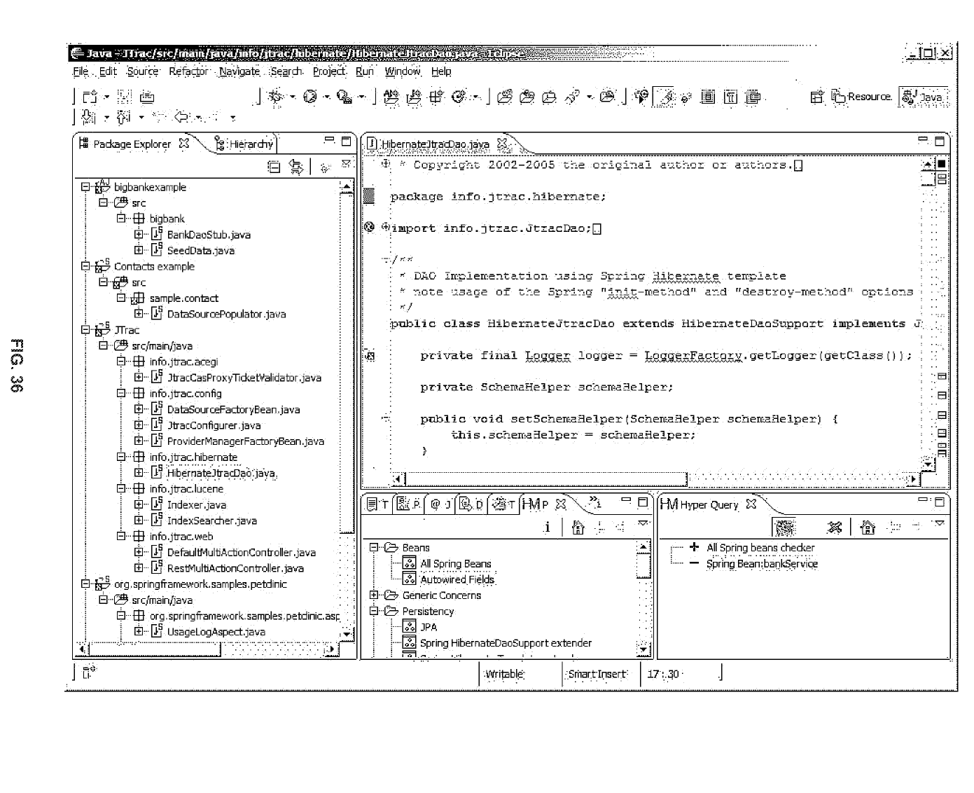

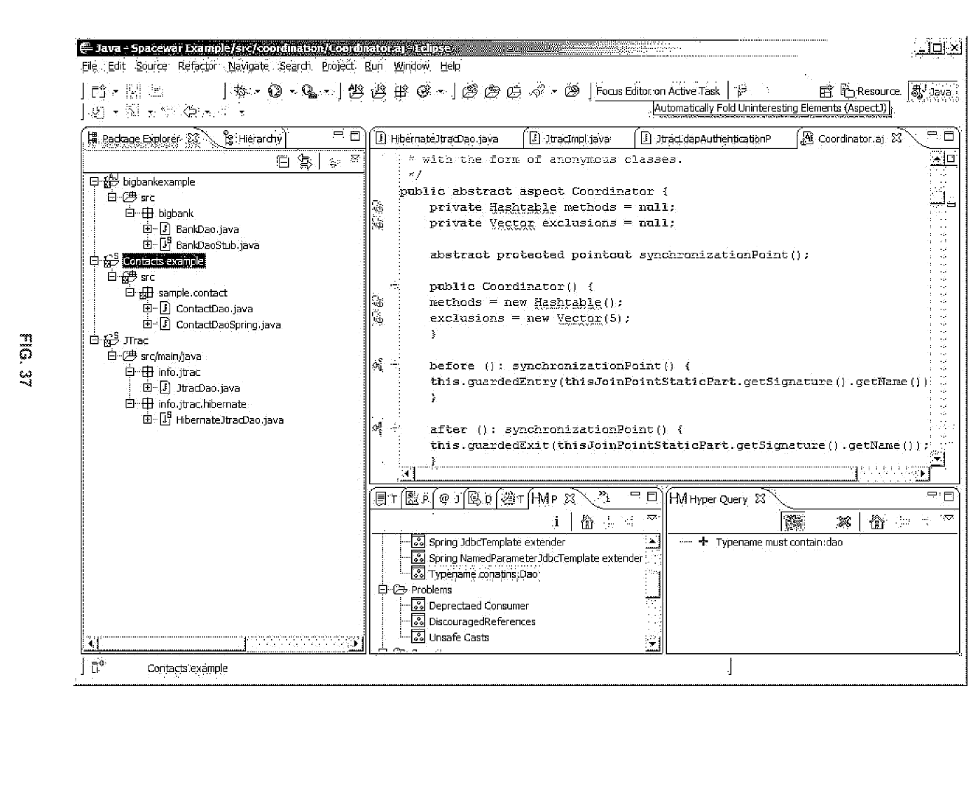

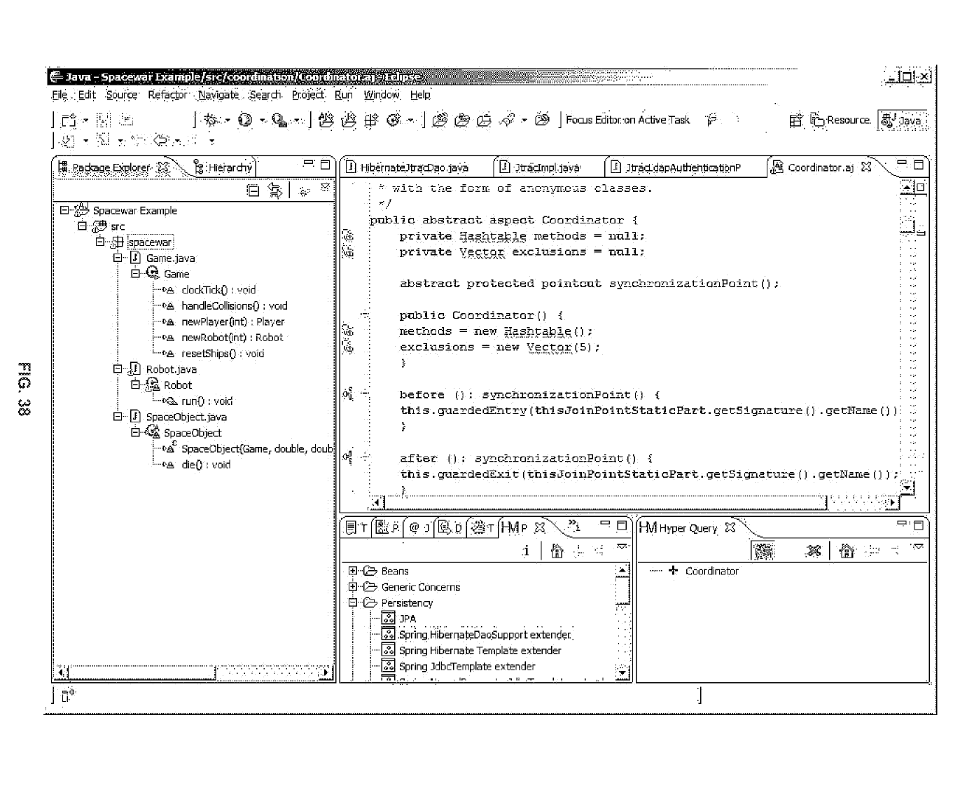

Beans: The Java Elements determined as Spring Beans are supported by Beans. Since these Bean scan be defined in various ways, several options are supported. One is, there is a dimension that is related to all Beans defined by an XML configuration. This dimension is included in the predefined dimensions. Another dimension makes it possible to add individual Beans from the Spring Explorer to current query by drag-and-drop (see FIG. 35—“Annotations in Hyperquery View”).

A query of all Spring Beans is executed in FIG. 36 (“A Hyperquery to Spring Beans”). A special Bean is identified by the Spring Explorer as Hypercut. This excluded bean is the bankService bean.

Naming conventions: The names “dao and “service” is supported for naming conventions in the prototype. If these are used in a query 302, it checks whether the class or interface name contains “dao” or “Service”. For instance, the result 301 of such a query 302 is illustrated in FIG. 37 (“Naming convention support as types with DAO”).

Aspects: Aspects can be directly added from different views of a query by drag-and drop. From the Package Explorer, for instance. The Pointcuts are determined while executing a query and these are added to the result. A query 302 on affected elements of the Coordinator Aspect is illustrated in FIG. 38 (“Affected Elements of Coordinator Aspect in Spacewar example”).

Compiler issues: The speicifcation of unsafe typecasts and users of outdated artefacts are supported by compiler issues 301. FIG. 41 (“Unsafe Casts”) illustrates a result set with active Filter. Only Java files containing unsafe type casts are shown in the Package Explorer. For instance, a Java file is opened in which unsafe type casts are executed (refer selected source code part in FIG. 41).

FIG. 34 (“Hyperquery for deprecated Consumers”) shows a query 302 for elements used as outdated elements. For instance, a file of result set 301 is opened and you can see that in this case, the “Date” Class is outdated.

Tasks: Local tasks can be added to a Hyper Query by drap-and-drop. The Classes, Java Files, Methods and Fields included in the context of task is supported while computing the result 301 and undertakes an interest evaluation via display threshold of Mylyn. A query 301, which also contains a Task can be combined with other dimensions. The combination of task is also interesting. Thus, the content of a Task can be removed by a Hypercut of another Task.

For instance, a task contains the Revision of DAOs in Contacts example (change contact dao). The corresponding Entities also belong to the context of this task. Another task includes the review of Entities (change contact entities). Now these tasks are combined.

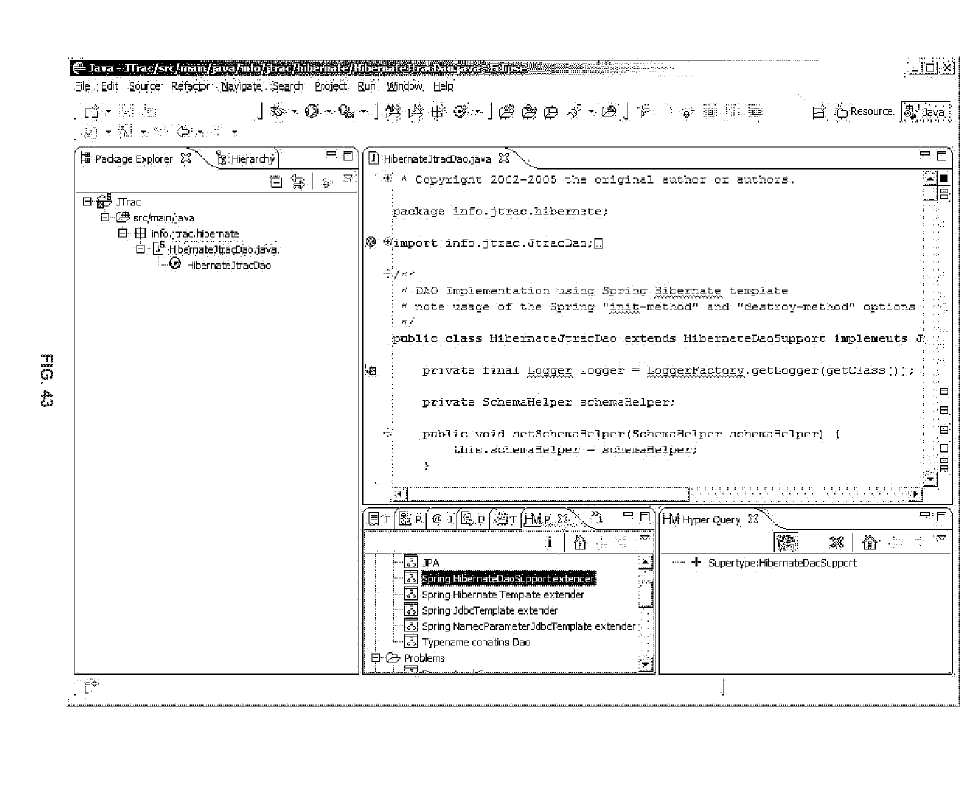

The content of “change contact entities” may be removed by a Hypercut. This gives rise to a result set of all elements that only belong to processing the task “change contact dao” and not to the task “change contact entities. The result set is illustrated in FIG. 42 (“Hyper query with two different tasks”).

Use of Framework Classes: The use of Framework Classes or Interfaces may be determined by predefined Concerns. Each of the supported classes and interfaces are indicated in the table given below (“Predefined Framework Classes and Interfaces”). All classes are derived from the Spring Framework:

| Class or Interface Name | Type |
|---|---|
| HibernateDaoSupport | Class |
| HibernateTemplate | Class |
| JdbcTemplate | Class |
| NamedParameterJdbcTemplate | Class |
| Controller Interface | |

FIG. 43 (“Hyperquery using Framework Information”) illustrates a result set of sample project for the classes derived from HibernateDaosupport of the Spring Framework.

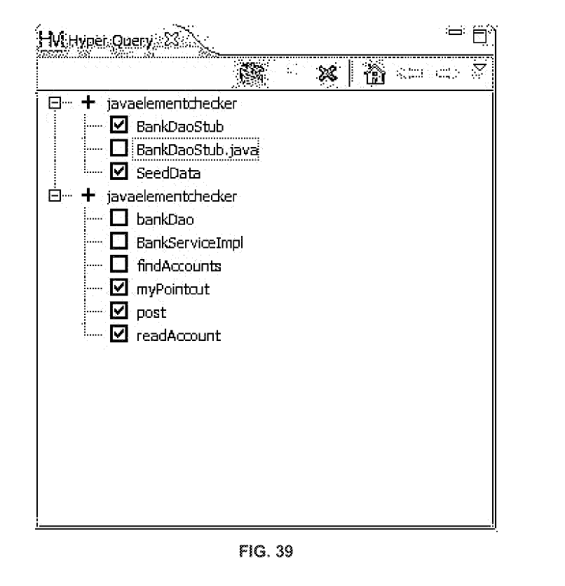

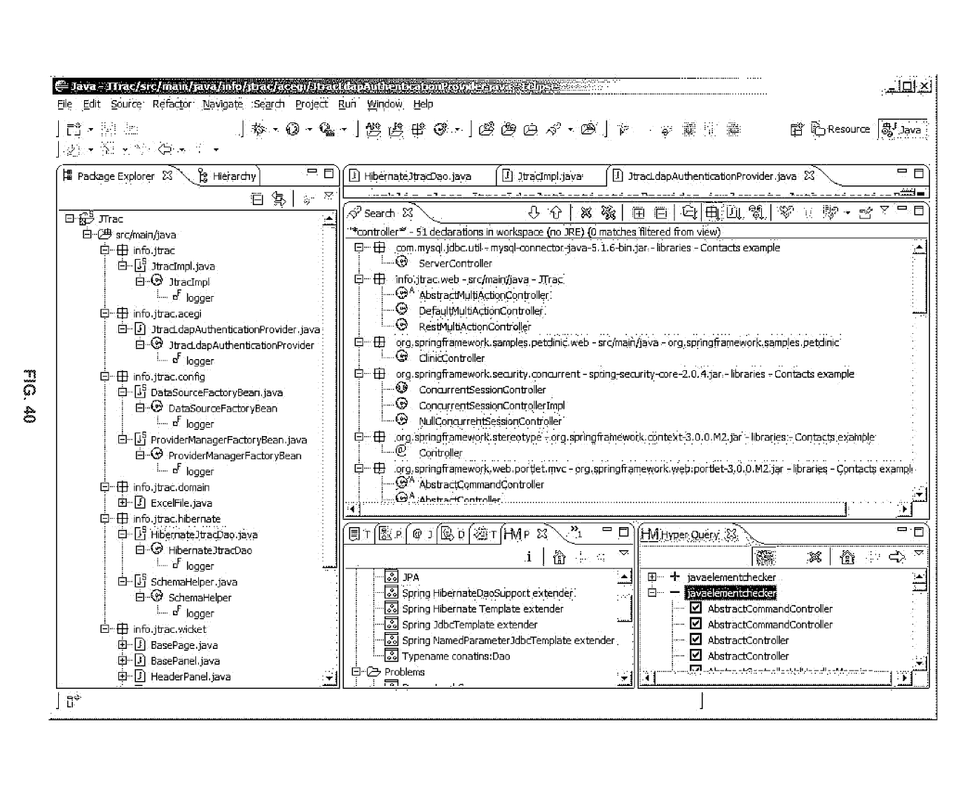

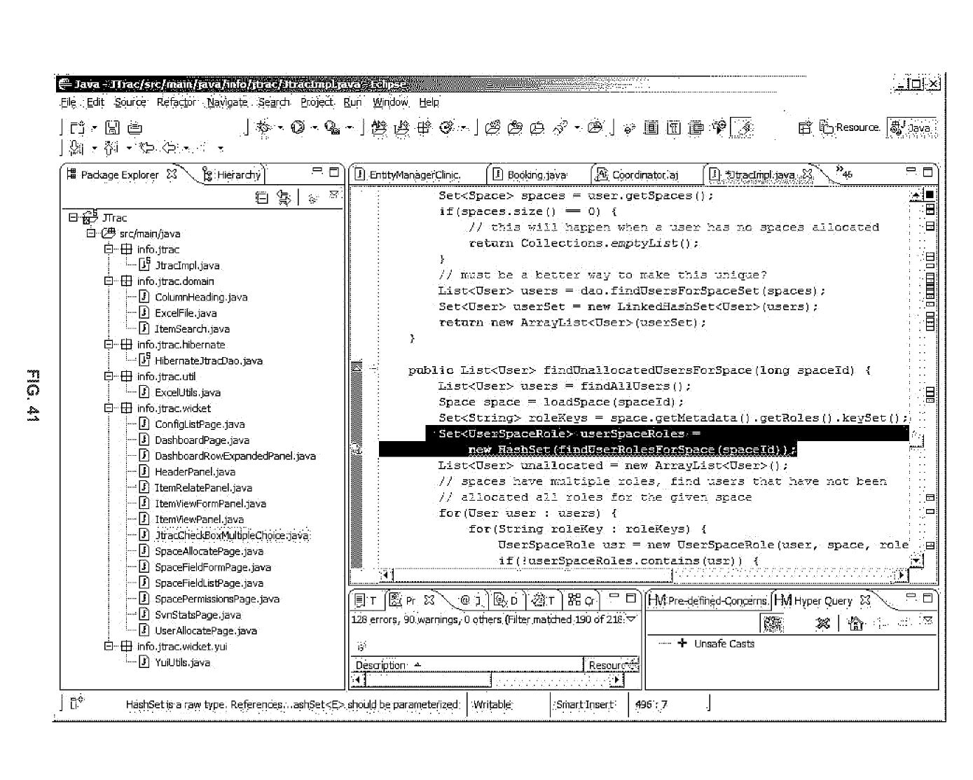

Java elements: All Java elements can be added to a query 302 via drag-and-drop. For instance, from search results or the Outline View. A header element is created in the Hyperquery while adding. All selected elements that have been moved, belong to this header element. There is an option to deactivate individual elements by removing the check in the checkbox (see FIG. 39—“Java Elements in Hyper query View”). This option to add standard elements and use them as dimensions in a query represents the functionality of an extension. The data used by Hyper adapter 300 while computing the result set 301 is specified in the query 302.

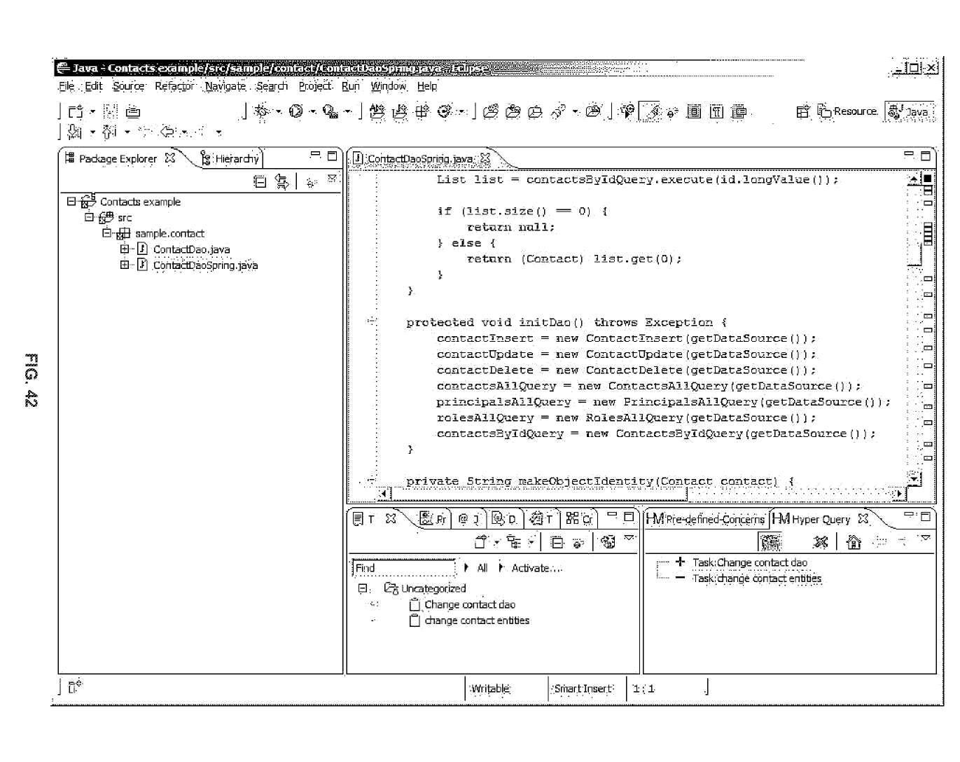

For instance, this may be used to add different search results from a standard search function to a query 302. An example of this is illustrated in FIG. 40 (“Hyperquery with search results”). Here primarily all the projects are searched according to the use of Logger Class. The result is added to query 302. Subsequently, all type declarations that contain the String “Controller” are determined by another search. This result is also added and switched into the Hypercut Mode. Thus result 301 is all elements used by Class Logger and do not contain Controller in their name.

Another important application of Java elements in a query is after its execution. Often the elements not required by the user also appear as result 301. Then he can simply drag them into query view and switch their display to Hypercut Mode and exclude them with next query 302.

### Other Applications of Hyper Adapter

Semantic Web Document converter: The Hyper adapter 300 can be used as a Semantic Web Document Converter. The documents from the database 305 can be converted to Semantic Web Documents through dimension information.

Dimension Explorer: A Dimension Explorer can be developed on the basis of Hyper adapter 300. This enables graphical “zooming” through dimensional structures and/or navigation.

Multidimensional Operations on Task content: The multidimensional operations can also be executed on task content based on the hyper adapter 300. It is thereby possible to execute set operations on elements associated with tasks. For instance, nowadays the content of tasks can be viewed simultaneously with Mylyn. However it is not possible to perform set operations. Example: Task 1 and Task 2 without elements that are present in Task 3 is not possible. If the Hyper Adapter 300 is used, it would be possible to apply all possible operations on tasks. The Fuzzy operations may also be applies since the task model uses an interest evaluation of elements which can also determined as fuzzy dimension.

Generating data: The Hyper adapter 300 may be used to generate dimension data and provide this to other machines or computer program products. For instance, the files can be generated by it for Concernmapper.

Improvement and extension of tools for analysis of error class: Substantially complex allocations can be executed by metrics for error classes on the basis of hyper adapter 300. In addition to this, such error classes can also be used as additional dimension in an analysis. It is also possible that the Hyper adapter 300 may contain a rule base which enable determining error classes for SDF on the basis of query 302.

3D Browser: The Hyper adapter 300 can also be used to create and/or filter 3D and/or higher dimensional illustration of Source code. For instance, figures from “Java 3d Browser Homepage” (http://1s10-www.cs.uni-dortmund.de/index.php?id=105) is which 3D dimensions may incorporate new dimensions. For example, special fragments in 3D figure are painted red if their temperatures are particularly high.

Filtering the user interface: It is particularly preferred that a hyper adapter 300 be also used to filter the contents of a user interface. An example of this was given in the above prototype. However this filtration can be used in other areas, such as a Browser. All fragments are filtered, which do not belong to a specific dimension. It is to be noted that so far there is no technology which allows filtering the user interface on the basis of Olap operation results. It can be done with the hyper adapter 300.

Data Mining: The Hyper adapter 300 may also be used to execute Data Mining on the basis of complex associations. For instance, on the basis of task, temperature, errors and/or the authors of fragments. It should be noted that currently Data Mining applies only to certain areas of software. The multidimensional concept enables determining relations larger than before, particularly through the schemas.

Aspect Mining: Often Aspect Mining Tools are used to identify aspects. If Aspect Mining is combined with the hyper adapter 300, then the quality of Aspect Miner can be improved.

1. A hyper adapter to access documents or parts of documents stored in a document database, wherein the Hyper adapter has:
a. an access interpreter designed to process at least one access document received by the Hyper adapter, whereby the access document specifies one or more classes of documents or parts of documents;
b. wherein, the Hyper adapter is designed to assign one or more classes to the documents or parts of documents stored in the document database on the basis of classification means specified in the access document.

2. The hyper adapter of claim 1, designed to save the classification means specified in the access document and use at least one of two received access documents while processing.

3. The hyper adapter of claim 1, having classification means including at least one schema, an assignment rule or at least one mapping.

4. The hyper adapter of claim 1 wherein the access interpreter has a multitude of predefined operations to access documents or parts of documents stored in the document database and wherein at least one access document refers to a predefined operations.

5. The hyper adapter of claim 1 including classification means designed to assign a document or a part of a document to one or several classes.

6. The hyper adapter of claim 1 including at least one access document specifying a query for at least one class of documents or parts of documents and wherein the Hyper adapter is designed to generate at least one result which includes at least one requested class of documents or parts of documents.

7. The hyper adapter of claim 1 including a query which contains at least one sample document and wherein the Hyper adapter is designed to generate at least one result including at least one class of documents or parts of documents assigned to the sample document.

8. The hyper adapter of claim 1 including an access document which specifies a written request that additional information have one or several documents or parts of documents in the document database and the Hyper adapter is designed to save the additional information into an internal memory of the hyper adapter.

9. The hyper adapter of claim 8 designed to generate at least one result by processing at least one of the two queries, wherein the result indicates the requested class of documents or parts of documents from the document database and the additional information from the internal memory of the hyper adapter.

10. The hyper adapter of claim 1 including at least one detector which is designed to analyze the document database and generate one or more classification means from it.

11. The hyper adapter of claim 10 including sourcecode from the documents stored in document database and wherein at least one detector is designed to classify source code in classes which specify energy consumption of one or more machines to execute instructions of source code.

12. A method of accessing documents or parts of documents stored in a document database comprising:
a. Processing at least one access document, wherein the access document specifies one or more classes of documents or parts of documents; and
b. assigning documents or parts of documents stored in document database to one or several classes on the basis of classification means specified in the access document.

13. The method of claim 12, further including storing the classification means stored in the access document and using the stored classification means while processing at least one of two access document.

14. The method of claim 12 further including analyzing the document database by at least one detector and generating one or more classification means by at least one detector.

15. A computer program including instructions for execution of a method according to claim 12.
